(19) United States
(12) Patent Application Publication
(10) Pub. No.: US 2025/0123469 A1
(43) Pub. Date: Apr. 17, 2025

(54) OPTICAL SYSTEM AND IMAGING DEVICE

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Rui ZHU, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/991,076

(22) Filed: Dec. 20, 2024

Related U.S. Application Data
(63) Continuation of application No. PCT/CN2023/097326, filed on May 31, 2023.

(30) Foreign Application Priority Data
Jun. 24, 2022 (CN) 202210726532.8
Jun. 24, 2022 (CN) 202221596000.9

(51) Int. Cl. G02B 13/00; C03C 15/00; G02B 1/11; G02B 3/00

(52) U.S. Cl. CPC G02B 13/0055; C03C 15/00; G02B 1/11; G02B 3/00; G02B 13/0045; G02B 2003/0093; G02B 2207/101

(57) ABSTRACT

An optical system and an imaging device are provided, and the optical system includes seven optical elements In order from an object side to an image side, the seven optical elements include: a first lens, a second lens, a third lens, a fourth lens, a fifth lens, a sixth lens and a seventh lens; each of seven optical elements includes an object-side surface facing towards the object plane and an image-side surface facing towards the image plane; at least one optical element of the seven optical elements is a metalens, and other optical element are aspheric optical lenses; and from the image side to the object side, both the first aspheric optical lens and the second aspheric optical lens include at least one aspheric surface, and the aspheric surface includes one point of inflection.

### CROSS-REFERENCE TO RELATED APPLICATION

This application is a continuation of International Patent Application of PCT application serial No. PCT/CN2023/097326, filed on May 31, 2023, which claims the benefit of priority from China Application No. 202210726532.8 and No. 202221596000.9, both filed on Jun. 24, 2022. The entirety of each of the above-mentioned patent applications is hereby incorporated by reference herein and made a part of this specification.

### TECHNICAL FIELD

The present disclosure relates to a field of optical image, in particular to an optical system and an imaging device.

### BACKGROUND

With the growth of the requirements of filming for users, more and more imaging devices has been set in electronic devices.

With the growth of the imaging quality for imaging device, the optical system in the imaging device cannot satisfy the requirements of larger aperture slots and smaller total track length (TTL) in the prior art.

Therefore, there is an urgent need for an optical system can satisfy the requirements of larger aperture slot and smaller total track length to achieve the electronic miniaturization and lightweight.

### SUMMARY

In order to solve the above technical problem that the miniaturization of the projection system is limited by the number of lenses and the volume of the lens, an optical system and an imaging device are provided according to the present application.

In the first aspect, an optical system is provided, the optical system including seven optical elements, wherein in order from an object side to an image side, the seven optical elements comprise: a first lens, a second lens, a third lens, a fourth lens, a fifth lens, a sixth lens and a seventh lens;
each of seven optical elements comprises an object-side surface facing towards the object plane and an image-side surface facing towards the image plane;
at least one optical element of the seven optical elements is a metalens, and other optical element are aspheric optical lenses;
from the image side to the object side, there is at least one aspheric surface in the first aspheric optical lens and the second aspheric optical lens, and the aspheric surface has one point of inflection;
each of seven optical elements comprises an object-side surface facing towards the object side and an image-side surface facing towards the image side;
the optical system satisfies the formulas as follows:

$$\frac{f}{EPD} \leq 2. ;$$

$$0.05 mm \leq {d}_{ML} \leq 2 mm ;$$

$$\vert {f}_{ML} \vert / f \geq 45 ;$$

f is a focal length of the optical system; EPD is an entrance pupil diameter of the optical system; d_{ML} is a thickness of the metalens; f_{ML} is a focal length of the metalens.

In one embodiment, the second lens is the metalens, and the other optical elements are aspheric optical lenses; and the first lens has a positive focal power;
the object-side surface of the first lens is a convex surface; the object-side of the third lens comprises a positive curvature radius; the fifth lens has a positive focal power the sixth lens comprises a positive curvature radius.

In one embodiment, the first lens satisfies the following condition:

$$0.4 \leq \frac{{R}_{10}}{{f}_{1}} \leq 0.54$$

wherein R₁ₒ is a curvature radius of the object-side surface of the first lens; f₁ is a focal length of the first lens of a central wavelength at a working waveband.

In one embodiment, the optical system satisfies the following condition:

$$( {V}_{1} + {V}_{4} ) / 2 - {V}_{3} > 20$$

wherein, V₁ is an Abbe number of the first lens; V₃ is an Abbe number of the third lens; V₄ is an Abbe number of the fourth lens.

In one embodiment, the optical system satisfies the following condition:

$$1.5 < TTL / ImgH < 1.8$$

wherein TTL is total track length of the optical system; ImgH is a maximum imaging height of the optical system.

In one embodiment, the optical system satisfies the following condition:

$$\vert {R}_{4 o} \vert > {R}_{4 i} ;$$

wherein R₄ₒ is a curvature radius of the object-side surface of the fourth lens; R₄ᵢ is a curvature radius of the image-side surface of the fourth lens.

In one embodiment, a curvature radius of the image-side surface of the seventh lens is greater than 0.

In one embodiment, the first lens satisfies the following condition:

$$0.71 \leq {f}_{1} / f \leq 0.98 ;$$

wherein f₁ is a focal length of the first lens of a central wavelength at a working waveband, f is a focal length of the optical system.

In one embodiment, the metalens comprises a substrate and a nanostructured layer; and the nanostructured layer is set on at least one side of the substrate;
and the number of the nanostructured layer is greater than or equal to 1;
each layer of the nanostructured layers comprises a plurality of nanostructures, and the plurality of nanostructures are arranged in a period;
the plurality of nanostructures in any two adjacent nanostructured layers are coaxial.

In one embodiment, the period of the nanostructures in any nanostructured layers is greater than or equal to 0.3λ_{c}, and is less than or equal to 2λ_{c};
wherein, λ_{c} is a central wavelength of the second lens at the working waveband.

In one embodiment, a height of the nanostructures in any nanostructured layer is greater than or equal to 0.3λ_{c}, and is less than or equal to 5λ_{c};
wherein, λ_{c} is a central wavelength of the second lens at the working waveband.

In one embodiment, the plurality of nanostructures are polarization-independent structures.

In one embodiment, the polarization-independent structures comprise cylinder structures, hollow structures, cylindrical structures, round-hole structures, hollow-round-hole structures, square column structures, square hole structures, hollow square column structures and hollow square hole structures.

In one embodiment, the second lens further comprises an antireflection film;
the antireflection film is set on one side of the substrate away from the nanostructured layer.

In one embodiment, a wide spectrum phase of a unit cell in the nanostructured layer satisfies:

$$- \frac{69 rad}{μm} \leq \frac{d φ ( r = {r}_{0} , λ )}{d λ} \leq - 5 rad / μm ;$$

wherein, r is a radial coordinates of the metalens; r₀ is a distance between any position on the metalens and the center of the metalens; λ is a working wavelength of the metalens.

In one embodiment, the metalens includes at least two nanostructured layers; the nanostructures in any adjacent nanostructured layer are non-coaxial along the direction parallel with the substrate.

In the second aspect, a manufacturing method for a metalens is provided, wherein the method is used to manufacture the metalens of the optical system, and the manufacturing method includes:
S1. setting a structural material layer on the substrate;
S2. coating photo-resist on the structural material layer, and exposing the structural material layer and obtaining a reference structure;
S3. according to the reference structure, etching the structural material layer into the nanostructures arranged in period, so as to form the nanostructured layer;
S4. filling a filler material between the nanostructures;
S5. polishing a surface of the filler material, so as to make the surface of the filler material align with the surface of the nanostructures.

In one embodiment, the manufacturing method further comprises:
S6. repeating S1 to S5, until completing all the nanostructured layers.

In the third aspect, an imaging device is provided, wherein the imaging device comprises the optical system claimed as claim 1 and an image sensor; the image sensor is set on the image plane of the optical system.

In one embodiment, the electronic device include the imaging device.

The optical system includes seven optical elements of at least one metalens and several aspheric optical lenses provided by the present application, and the optical system satisfies the requirements that F number is less than 2 and TTL is less than 6 mm, which improves the miniaturization and lightweight of the optical system.

The manufacturing method provided by the present embodiment, the structure of the metalens including at least one nanostructured layer is realized by the manufacturing method, which improves the aspect ratio of nanostructures and increases the freedom degree of the design of the metalens.

Other features and advantages of the present application will become apparent by the detailed description below, or will be acquired in part by the practice of the present application.

It should be understood that the above description is general, and the detailed description described below is exemplary only, and will not limit this application.

### BRIEF DESCRIPTION OF THE DRAWINGS

In order to explain embodiments of the present disclosure or the prior art more clearly, drawings used in the description of the embodiments, or the prior art will be briefly explained below. Obviously, the following drawings are merely for exemplary and explanatory purposes. It is understood by those skilled in the art that without paying any creative efforts, other drawings are available based on the following drawings.

FIG. 1 shows an optional structural schematic diagram of the optical system provided by the embodiment of the present application.

FIG. 2 shows another optional structural schematic diagram of the optical system provided by the embodiment of the present application.

FIG. 3 shows another optional structural schematic diagram of the optical system provided by the embodiment of the present application.

FIG. 4 shows another optional structural schematic diagram of the optical system provided by the embodiment of the present application.

FIG. 5 shows another optional structural schematic diagram of the optical system provided by the embodiment of the present application.

FIG. 6 shows another optional structural schematic diagram of the optical system provided by the embodiment of the present application.

FIG. 7 shows another optional structural schematic diagram of the optical system provided by the embodiment of the present application.

FIG. 8 shows another optional structural schematic diagram of the optical system provided by the embodiment of the present application.

FIG. 9 shows another optional structural schematic diagram of the optical system provided by the embodiment of the present application.

FIG. 10 shows another optional structural schematic diagram of the optical system provided by the embodiment of the present application.

FIG. 11 shows another optional structural schematic diagram of the optical system provided by the embodiment of the present application.

FIG. 12 shows another optional structural schematic diagram of the optical system provided by the embodiment of the present application.

FIG. 13 shows another optional structural schematic diagram of the optical system provided by the embodiment of the present application.

FIG. 14 shows another optional structural schematic diagram of the optical system provided by the embodiment of the present application.

FIG. 15 shows another optional structural schematic diagram of the optical system provided by the embodiment of the present application.

FIG. 16 shows another optional structural schematic diagram of the optical system provided by the embodiment of the present application.

FIG. 17 shows another optional structural schematic diagram of the optical system provided by the embodiment of the present application.

FIG. 18 shows another optional structural schematic diagram of the optical system provided by the embodiment of the present application.

FIG. 19 shows another optional structural schematic diagram of the optical system provided by the embodiment of the present application.

FIG. 20 shows another optional structural schematic diagram of the optical system provided by the embodiment of the present application.

FIG. 21 shows another optional structural schematic diagram of the optical system provided by the embodiment of the present application.

FIG. 22 shows another optional structural schematic diagram of the optical system provided by the embodiment of the present application.

FIG. 23 shows another optional structural schematic diagram of the optical system provided by the embodiment of the present application.

FIG. 24 shows another optional structural schematic diagram of the optical system provided by the embodiment of the present application.

FIG. 25 shows an optional structural diagram of the metalens provided by the embodiment of the present application.

FIG. 26 shows an optional structural diagram of the nanostructure of metalens provided by the embodiment of the present application.

FIG. 27 shows another optional structural diagram of the nanostructure of metalens provided by the embodiment of the present application.

FIG. 28 shows another optional structural diagram of the nanostructure of metalens provided by the embodiment of the present application.

FIG. 29 shows another optional structural diagram of the nanostructure of metalens provided by the embodiment of the present application.

FIG. 30 shows another optional structural diagram of the nanostructure of metalens provided by the embodiment of the present application.

FIG. 31 shows another optional structural diagram of the nanostructure of metalens provided by the embodiment of the present application.

FIG. 32 shows another optional structural diagram of the nanostructure of metalens provided by the embodiment of the present application.

FIG. 33 shows another optional structural diagram of the nanostructure of metalens provided by the embodiment of the present application.

FIG. 34 shows another optional structural diagram of the metalens provided by the embodiment of the present application.

FIG. 35 shows another optional structural diagram of the nanostructures in adjacent nanostructured layer provided by the embodiment of the present application.

FIG. 36 shows another optional structural diagram of the metalens provided by the embodiment of the present application.

FIG. 37 shows an optional phase diagram of the metalens provided by the embodiment of the present application.

FIG. 38 shows an optional transmittance diagram of the metalens provided by the embodiment of the present application.

FIG. 39 shows another optional phase diagram of the metalens provided by the embodiment of the present application.

FIG. 40 shows another optional transmittance diagram of the metalens provided by the embodiment of the present application.

FIG. 41 shows an optional flow chart of the manufacturing method of metalens provided in the embodiment of the present application.

FIG. 42 shows another optional flow chart of the manufacturing method of metalens provided in the embodiment of the present application.

FIG. 43 shows another optional flow chart of the manufacturing method of metalens provided in the embodiment of the present application.

FIG. 44 shows a schematic diagram of phase modulation at different wavelengths in the optical system shown in FIG. 1.

FIG. 45 shows an astigmatism diagram of the optical system shown in FIG. 1.

FIG. 46 shows a distortion diagram of the optical system shown in FIG. 1.

FIG. 47 shows the matching degree of the wide spectrum in the optical system shown in FIG. 1.

FIG. 48 shows a schematic diagram of phase modulation at different wavelengths in the optical system shown in FIG. 2.

FIG. 49 shows an astigmatism diagram of the optical system shown in FIG. 2.

FIG. 50 shows a distortion diagram of the optical system shown in FIG. 2.

FIG. 51 shows the matching degree of the wide spectrum in the optical system shown in FIG. 2.

FIG. 52 shows a schematic diagram of phase modulation at different wavelengths in the optical system shown in FIG. 3.

FIG. 53 shows an astigmatism diagram of the optical system shown in FIG. 3.

FIG. 54 shows a distortion diagram of the optical system shown in FIG. 3.

FIG. 55 shows the matching degree of the wide spectrum in the optical system shown in FIG. 3.

FIG. 56 shows a schematic diagram of phase modulation at different wavelengths in the optical system shown in FIG. 4.

FIG. 57 shows an astigmatism diagram of the optical system shown in FIG. 4.

FIG. 58 shows a distortion diagram of the optical system shown in FIG. 4.

FIG. 59 shows the matching degree of the wide spectrum in the optical system shown in FIG. 4.

FIG. 60 shows a schematic diagram of phase modulation at different wavelengths in the optical system shown in FIG. 5.

FIG. 61 shows an astigmatism diagram of the optical system shown in FIG. 5.

FIG. 62 shows a distortion diagram of the optical system shown in FIG. 5.

FIG. 63 shows the matching degree of the wide spectrum in the optical system shown in FIG. 5.

FIG. 64 shows a schematic diagram of phase modulation at different wavelengths in the optical system shown in FIG. 6.

FIG. 65 shows an astigmatism diagram of the optical system shown in FIG. 6.

FIG. 66 shows a distortion diagram of the optical system shown in FIG. 6.

FIG. 67 shows the matching degree of the wide spectrum in the optical system shown in FIG. 6.

FIG. 68 shows a schematic diagram of phase modulation at different wavelengths in the optical system shown in FIG. 7.

FIG. 69 shows an astigmatism diagram of the optical system shown in FIG. 7.

FIG. 70 shows a distortion diagram of the optical system shown in FIG. 7.

FIG. 71 shows the matching degree of the wide spectrum in the optical system shown in FIG. 7.

FIG. 72 shows a schematic diagram of phase modulation at different wavelengths in the optical system shown in FIG. 8.

FIG. 73 shows an astigmatism diagram of the optical system shown in FIG. 8.

FIG. 74 shows a distortion diagram of the optical system shown in FIG. 8.

FIG. 75 shows the matching degree of the wide spectrum in the optical system shown in FIG. 8.

FIG. 76 shows a schematic diagram of phase modulation at different wavelengths in the optical system shown in FIG. 9.

FIG. 77 shows an astigmatism diagram of the optical system shown in FIG. 9.

FIG. 78 shows a distortion diagram of the optical system shown in FIG. 9.

FIG. 79 shows the matching degree of the wide spectrum in the optical system shown in FIG. 9.

FIG. 80 shows a schematic diagram of phase modulation at different wavelengths in the optical system shown in FIG. 10.

FIG. 81 shows an astigmatism diagram of the optical system shown in FIG. 10.

FIG. 82 shows a distortion diagram of the optical system shown in FIG. 10.

FIG. 83 shows the matching degree of the wide spectrum in the optical system shown in FIG. 10.

FIG. 84 shows a schematic diagram of phase modulation at different wavelengths in the optical system shown in FIG. 11.

FIG. 85 shows an astigmatism diagram of the optical system shown in FIG. 11.

FIG. 86 shows a distortion diagram of the optical system shown in FIG. 11.

FIG. 87 shows the matching degree of the wide spectrum in the optical system shown in FIG. 11.

FIG. 88 shows a schematic diagram of phase modulation at different wavelengths in the optical system shown in FIG. 12.

FIG. 89 shows an astigmatism diagram of the optical system shown in FIG. 12.

FIG. 90 shows a distortion diagram of the optical system shown in FIG. 12.

FIG. 91 shows the matching degree of the wide spectrum in the optical system shown in FIG. 12.

FIG. 92 shows a schematic diagram of phase modulation at different wavelengths in the optical system shown in FIG. 13.

FIG. 93 shows an astigmatism diagram of the optical system shown in FIG. 13.

FIG. 94 shows a distortion diagram of the optical system shown in FIG. 13.

FIG. 95 shows the matching degree of the wide spectrum in the optical system shown in FIG. 13.

FIG. 96 shows a schematic diagram of phase modulation at different wavelengths in the optical system shown in FIG. 14.

FIG. 97 shows an astigmatism diagram of the optical system shown in FIG. 14.

FIG. 98 shows a distortion diagram of the optical system shown in FIG. 14.

FIG. 99 shows the matching degree of the wide spectrum in the optical system shown in FIG. 14.

FIG. 100 shows a schematic diagram of phase modulation at different wavelengths in the optical system shown in FIG. 15.

FIG. 101 shows an astigmatism diagram of the optical system shown in FIG. 15.

FIG. 102 shows a distortion diagram of the optical system shown in FIG. 15.

FIG. 103 shows the matching degree of the wide spectrum in the optical system shown in FIG. 15.

FIG. 104 shows a schematic diagram of phase modulation at different wavelengths in the optical system shown in FIG. 16.

FIG. 105 shows an astigmatism diagram of the optical system shown in FIG. 16.

FIG. 106 shows a distortion diagram of the optical system shown in FIG. 16.

FIG. 107 shows the matching degree of the wide spectrum in the optical system shown in FIG. 16.

FIG. 108 shows a schematic diagram of phase modulation at different wavelengths in the optical system shown in FIG. 17.

FIG. 109 shows an astigmatism diagram of the optical system shown in FIG. 17.

FIG. 110 shows a distortion diagram of the optical system shown in FIG. 17.

FIG. 111 shows the matching degree of the wide spectrum in the optical system shown in FIG. 17.

FIG. 112 shows a schematic diagram of phase modulation at different wavelengths in the optical system shown in FIG. 18.

FIG. 113 shows an astigmatism diagram of the optical system shown in FIG. 18.

FIG. 114 shows a distortion diagram of the optical system shown in FIG. 18.

FIG. 115 shows the matching degree of the wide spectrum in the optical system shown in FIG. 18.

FIG. 116 shows a schematic diagram of phase modulation at different wavelengths in the optical system shown in FIG. 19.

FIG. 117 shows an astigmatism diagram of the optical system shown in FIG. 19.

FIG. 118 shows a distortion diagram of the optical system shown in FIG. 19.

FIG. 119 shows the matching degree of the wide spectrum in the optical system shown in FIG. 19.

FIG. 120 shows a schematic diagram of phase modulation at different wavelengths in the optical system shown in FIG. 20.

FIG. 121 shows an astigmatism diagram of the optical system shown in FIG. 20.

FIG. 122 shows a distortion diagram of the optical system shown in FIG. 20.

FIG. 123 shows the matching degree of the wide spectrum in the optical system shown in FIG. 20.

FIG. 124 shows a schematic diagram of phase modulation at different wavelengths in the optical system shown in FIG. 21.

FIG. 125 shows an astigmatism diagram of the optical system shown in FIG. 21.

FIG. 126 shows a distortion diagram of the optical system shown in FIG. 21.

FIG. 127 shows the matching degree of the wide spectrum in the optical system shown in FIG. 21.

FIG. 128 shows a schematic diagram of phase modulation at different wavelengths in the optical system shown in FIG. 22.

FIG. 129 shows an astigmatism diagram of the optical system shown in FIG. 22.

FIG. 130 shows a distortion diagram of the optical system shown in FIG. 22.

FIG. 131 shows the matching degree of the wide spectrum in the optical system shown in FIG. 22.

FIG. 132 shows a schematic diagram of phase modulation at different wavelengths in the optical system shown in FIG. 23.

FIG. 133 shows an astigmatism diagram of the optical system shown in FIG. 23.

FIG. 134 shows a distortion diagram of the optical system shown in FIG. 23.

FIG. 135 shows the matching degree of the wide spectrum in the optical system shown in FIG. 23.

FIG. 136 shows a schematic diagram of phase modulation at different wavelengths in the optical system shown in FIG. 24.

FIG. 137 shows an astigmatism diagram of the optical system shown in FIG. 24.

FIG. 138 shows a distortion diagram of the optical system shown in FIG. 24.

FIG. 139 shows the matching degree of the wide spectrum in the optical system shown in FIG. 24.

### DETAILED DESCRIPTION OF DISCLOSURE EMBODIMENTS

The application is more comprehensively described below with reference to the drawings, and the embodiments are shown in the drawings. However, the present application may be implemented in many different ways and should not be construed as limited to the embodiment described herein. Instead, these embodiments are provided such that the application will be exhaustive and complete, and will fully communicate the scope of the application to those skilled in the art. The same attached drawing marks throughout indicate the same components. Furthermore, in the drawings, the thickness, ratio and size of the components are enlarged to clearly illustrate.

The term used herein is used only for the purpose of describing the specific embodiment and is not intended to be a limitation. The “one”, “a single”, “the”, “this”, “one” and “at least” used in this application do not represent a limitation on quantity, but are intended to include both singular and plural. For example, “one part” has the same meaning as “at least one part” unless the context clearly indicates otherwise. “At least one” should not be interpreted as limiting to the quantity “one”. “Or” means “and/or”. The term “and/or” includes any and all combinations of one or more of the associated listed items.

Unless otherwise limited, all terms used herein, including technical and scientific terms, have the same meaning as commonly understood by those skilled in the field. The terms defined in a jointly used dictionary shall be construed to have the same meaning as those defined in the relevant technical context, and are not interpreted in an idealized or too formal meaning, unless clearly defined in the specification.

The meaning of “include” or “comprise” specifies the nature, quantity, steps, operation, parts, parts, or combinations thereof, but does not exclude other nature, quantity, steps, operation, parts, parts, or a combination of them.

This application describes the implementation with reference to the section diagram as an idealized embodiment. Thus, relative to illustrated shape changes as a result of, for example, manufacturing technique and/or tolerance. Therefore, the embodiments described herein should not be interpreted to be limited to specific shapes of the region as shown herein, but should include deviations from shapes due to fabrication. For example, regions shown or described as flat may typically have coarse and/or non-linear characteristics. Also, the sharp angles shown can be rounded. Thus, the regions shown in the figure are schematic in nature and their shapes are not intended to show the precise shape of the area and are not intended to limit the scope of the claim.

One embodiment according to the present application will be described with reference to the accompanying drawings below.

In the proceeding of miniaturization of optical system, it is difficult for the optical system including traditional plastic lens to make breakthroughs in thickness and large curvature radius due to the limitation of injection molding technology. Thus, the thickness, intervals between the lenses, and TTL for the optical system with seven lenses is difficult to break through. On the other hand, there are only about ten optional materials for plastic lenses, which limits the freedom of the aberration correction of the optical system. At present, although the hybrid lens of glass resin solves the problems such as chromatic aberration to a certain extent, the injection molding process still greatly hinders the miniaturization and lightweight of the optical system. Today, the optical system requires an enormous effort even for every 1 millimeter of total system length reduction. Because the pixels of optical system in imaging device such as CCD (Charge Coupled Device) and CMOS (Complementary Metal Oxide Semiconductor) are increasingly higher, and the pixel size of optical system in imaging device such as CCD (Charge Coupled Device) and CMOS (Complementary Metal Oxide Semiconductor) is increasingly larger, the more difficult the matching optical system to meet the requirements of large aperture and small TTL.

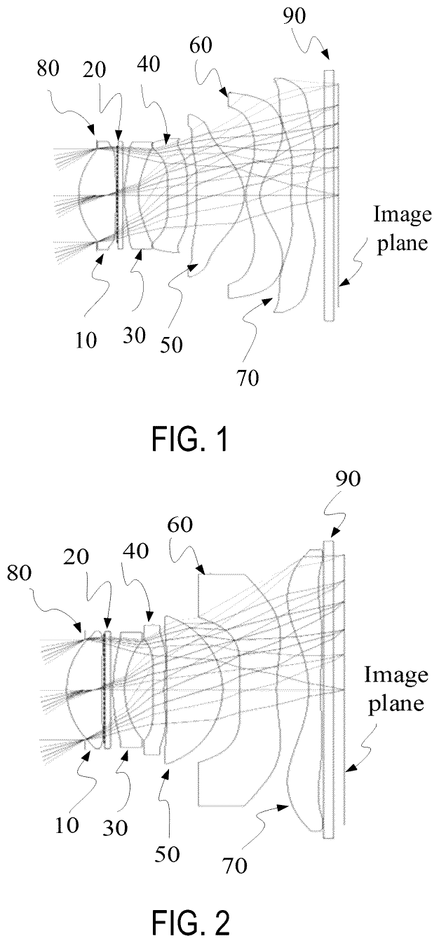

In the first aspect, an optical system is provided in the present application, as shown from FIG. 1 to FIG. 24, the optical system includes seven optical elements, wherein in order from an object side to an image side, the seven optical elements include: a first lens, a second lens, a third lens, a fourth lens, a fifth lens, a sixth lens and a seventh lens; each of seven optical elements includes an object-side surface facing towards the object plane and an image-side surface facing towards the image plane; at least one optical element of the seven optical elements is a metalens, and other optical element are aspheric optical lenses; from the image side to the object side, there is at least one aspheric surface in the first aspheric optical lens and the second aspheric optical lens, and the aspheric surface includes one point of inflection; each of seven optical elements includes an object-side surface facing towards the object side and an image-side surface facing towards the image side; the optical system satisfies the formulas as follows:

$$\frac{f}{EPD} \leq 2. ; \qquad ( 1 - 1 )$$

$$0.05 mm \leq {d}_{ML} \leq 2 mm ; \qquad ( 1 - 2 )$$

$$\vert {f}_{ML} \vert / f \geq 45 ; \qquad ( 1 - 3 )$$

f is a focal length of the optical system; EPD is an entrance pupil diameter of the optical system; d_{ML} is a thickness of the metalens; f_{ML} is a focal length of the metalens.

The present application provides an optical system, the optical system with the seven optical elements can satisfy a larger aperture slot (that is, a smaller F number) and smaller TTL at the same time. And a ratio of an absolute value of the focal length of the metalens to an absolute value of the focal length of the optical system is less than or equal to 45, which is beneficial to enhance the aberration correction ability of the optical system and improves the design freedom of the optical system. The aspheric surface has a point of inflection, which is beneficial to reduce the effective radius of the first aspheric refractive lens and the second aspheric refractive lens from the image side to the object side, thus reducing the volume of the optical system, so as to make the optical system apply to the compact imaging device.

The above settings can enhance the ability of imaging to make the optical system to cooperate with the pixel size, resolution, or incident angle of the chief ray with the sensor, and the optical system has enough design freedom in the specifications of the lens surface, so as to achieve design specifications requirements successfully, such as controlling lens size. It should be noted that only a part of optional structure of the optical system are shown from FIG. 1 to FIG. 24. FIG. 1-FIG. 24 only show the arrangement of each lens in the optical system, and the schematic intervals between each lens aren't the actual distances between each lens.

Further, in the optical system of the present application, the second lens 20 is the metalens, and other lenses of the optical system are aspheric refractive lens. And the first lens 10 has a positive focal power, and an object side of the first lens 10 is a convex surface; a curvature radius of the object-side of the third lens 30 is positive; the fifth lens 50 has positive focal power; a curvature radius of the object-side of the sixth lens 60 is positive. The focal power of the fourth lens 40 and the seventh lens 70 may be selected according the design requirements of the optical system.

According to the embodiment of the present application, the fifth lens 40 satisfies the conditions as follows:

$$\vert {R}_{4 o} \vert > {R}_{4 i} ; \qquad ( 2 )$$

Wherein R_{4O} is a curvature radius of the object-side surface of the fourth lens 40; R₄ᵢ is a curvature radius of the image-side surface of the fourth lens 40. Rₙₒ and Rₙᵢ are used to represent the curvature radius of object-side surface and each image-side surface of each lens. And n is an arrangement of the lenses in order from the object-side to the image side, o represents the object side and i represents the image side.

According to the embodiment of the present application, optionally, the curvature radius of the image-side surface of the seventh lens 70 is greater than 0.

According to the embodiment of the present application, optionally, the first lens 10 further satisfies the condition (3):

$$0.4 \leq \frac{{R}_{10}}{{f}_{1}} \leq 0.54 ; \qquad ( 3 )$$

wherein R₁ₒ is the current radius of the object-side surface of the first lens 10; f₁ is a focal length of the central wavelength at the working waveband. The condition (3) is beneficial to ensure the optical system have enough positive reflective power, thus it is beneficial to further compress the total track length of the optical system.

In an optional embodiment, the optical system further satisfies condition (4) provided by the present embodiment:

$$( {V}_{1} + {V}_{4} ) / 2 - {V}_{3} > 20 ; \qquad ( 4 )$$

Wherein V₁ is an Abbe number of the first lens; V₃ is an Abbe number of the third lens; V₄ is an Abbe number of the fourth lens.

In an optional embodiment, the optical system further satisfies condition (5) provided by the present embodiment:

$$1.5 < TTL / ImgH < 1.8 ; \qquad ( 5 )$$

wherein TTL is a distance between the object-side of the first lens and a image plane of the optical system; ImgH is a maximum height of the optical system. The maximum imaging height refers to half of the diagonal length of the effective sensing area of the electronic image sensor. In this way, it is beneficial to balance the miniaturization of the optical system and the matching degree between the optical system and the image sensor, so as to reduce the production difficulty.

Preferably, the first lens 10 further satisfies:

$$0.71 \leq {f}_{1} / f \leq 0.98 ; \qquad ( 6 )$$

wherein f₁ is a focal length of the first lens at a central wavelength of a working waveband, f is a focal length of the optical system.

It should be understood that the optical system provided by the embodiment of the present application, the aspheric refractive lens may be made of an optical glass, such as crown brand glass, flint glass, quartz glass; the aspheric refractive lens may be made of various kinds of optical plastics, such as APL5514, OKP4HT. Preferably, the aspheric refractive lens may use optical plastic to achieve low cost and mass production through the injection molding process.

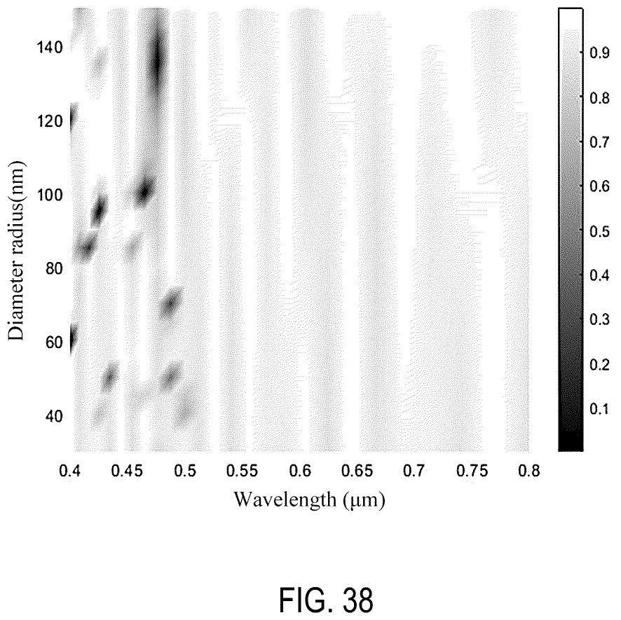

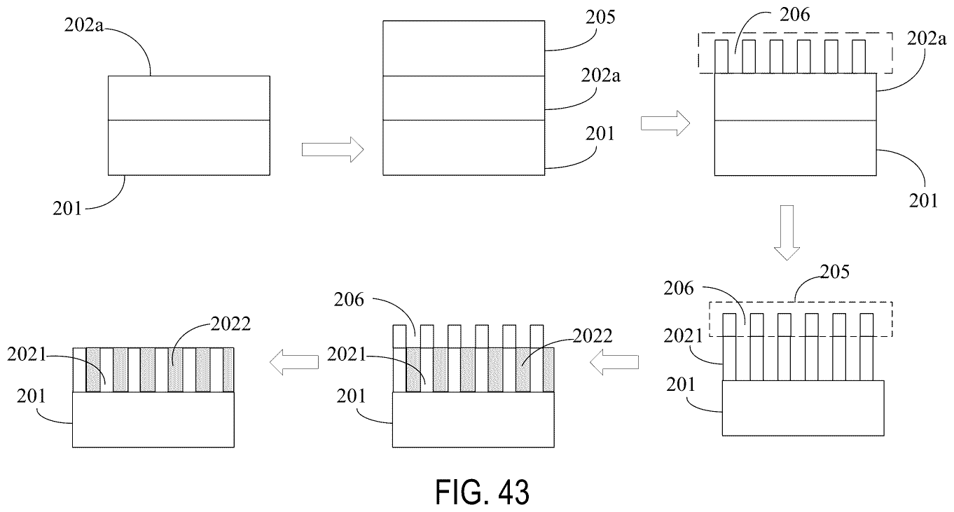

Next, the metalens (that is, the second lens 20) provided in this application embodiment is described in FIGS. 25 to 43.

Specifically, the metalens is a kind of the metasurface, and the metasurface modulates the phase, amplitude and polarization of the incident lights by the sub-wavelength nanostructures arranged on the metasurface.

FIG. 25 shows an optional structural diagram of the metalens provided by the present application. As shown in FIG. 25, in the present application, the metalens includes a substrate 201 and a nanostructured layer 202; and the nanostructured layer 202 is set on at least one side of the substrate; and the number of the nanostructured layer is greater than or equal to 1; each layer of the nanostructured layers includes a plurality of nanostructures 2021, and the plurality of nanostructures 2021 are arranged in a period.

According to the embodiment of the present application, optionally, the period of the nanostructures in any nanostructured layers is greater than or equal to 0.3λ_{c}, and is less than or equal to 2λ_{c}; and λ_{c} is a central wavelength of the second lens at the working waveband.

According to the embodiment of the present application, optionally, a height of the nanostructures in any nanostructured layer is greater than or equal to 0.3λ_{c}, and is less than or equal to 5λ_{c}; and λ_{c} is a central wavelength of the second lens at the working waveband.

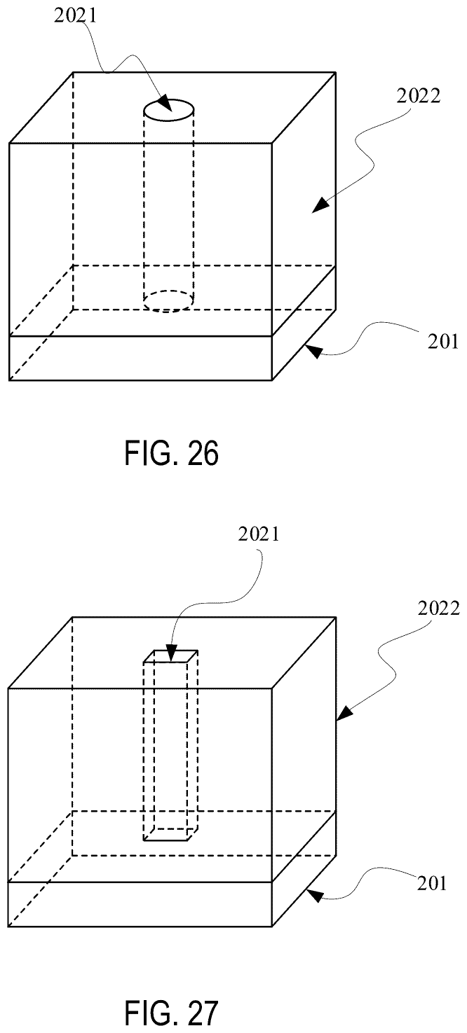

FIGS. 26 and 27 show a perspective view of the nanostructure 2021 in any layer of the nanostructured layer 202 in the second lens 20. Optionally, FIG. 26 is a cylindrical structure. Optionally, the nanostructure 2021 in FIG. 27 is a positive square cylindrical structure. Optionally, as shown in FIGS. 25 and 27, the metalens also includes a filler material 2022, and the filler material 2022 filled between nanostructures 2021 and the filler material 2022 is less than 0.01. Optionally, the filler material 2022 includes air or other transparent or translucent materials at the working waveband. According to the embodiment of the present application, the absolute value of the difference between the refractive index of the material 2022 and the refractive index of the nanostructure 2021 should be greater than or equal to 0.5. When the metalens provided by the embodiment of the present application has at least two layers of the nanostructured layer 202, the filler material 2022 in the nanostructured layer 202 farthest from the substrate 201 may be air.

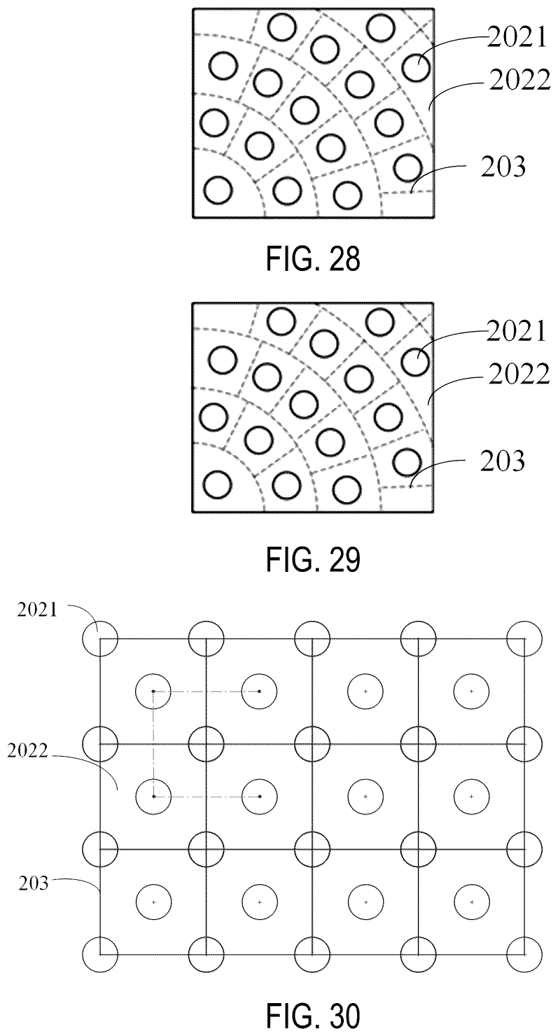

In some optional embodiments of the present application, as shown in FIGS. 28 to 30, any layer of the nanostructured layer 202 includes an array arrangement of the nanostructured layer 203. The unit cell 203 is a dense packing pattern provided with the nanostructure 2021. In the embodiment of the present application, a dense packing pattern refers to one or more figures that can fill the entire plane without gaps or overlaps.

As shown in FIG. 28, according to the embodiment provided by the present application, the unit cells may be arranged in a regular square array. And those skilled in the field should understand that the unit cell 203 may be arranged in other shapes, and all the modifications are covered within the scope of this application. It is understandable that in some optional embodiments, the period of the unit cells 203 is greater than or equal to 0.3λ_{c}, and is less than or equal to 2λ_{c}; and λ_{c} is a central wavelength of the second lens at the working waveband.

Optionally, the wide-spectrum phase of unit cell 203 and the working waveband of the metalens also satisfy:

$$- \frac{69 rad}{μm} \leq \frac{d φ ( r = {r}_{0} , λ )}{d λ} \leq - 5 rad / μm .$$

r is a radial coordinates of the metalens; r₀ is a distance between any position on the metalens and the center of the metalens; λ is a working wavelength of the metalens.

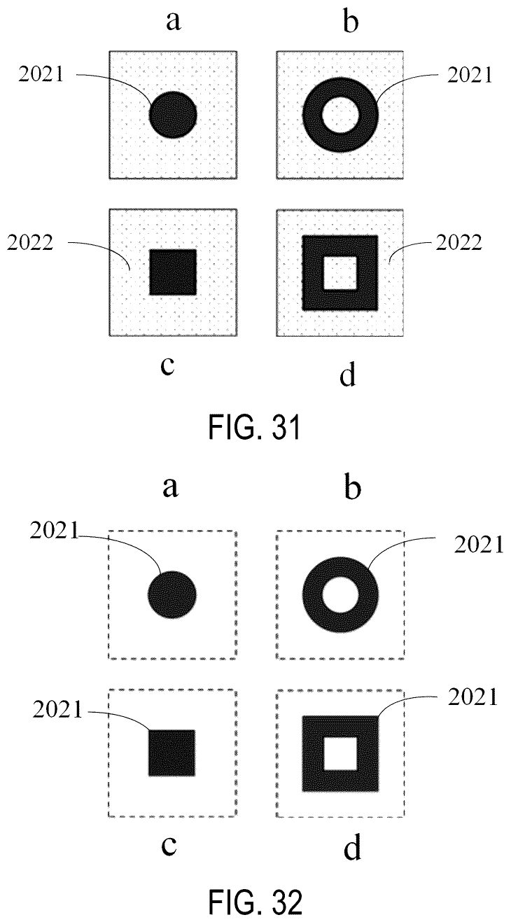

In one embodiment, the nanostructures 2021 provided by the present embodiment may be polarization-independent structures, and the polarization-independent structures apply a propagation phase to the incident lights. The embodiments as shown in FIGS. 31-32, the polarization-independent structures include cylinder structures, hollow structures, cylindrical structures, round-hole structures, hollow-round-hole structures, square column structures, square hole structures, hollow square column structures and hollow square hole structures.

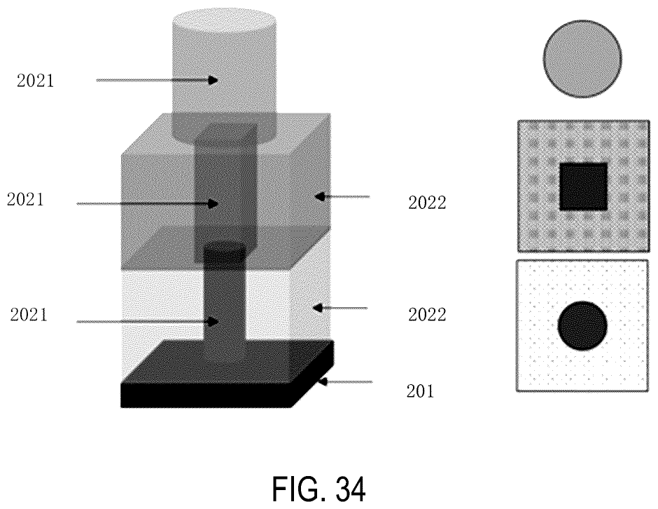

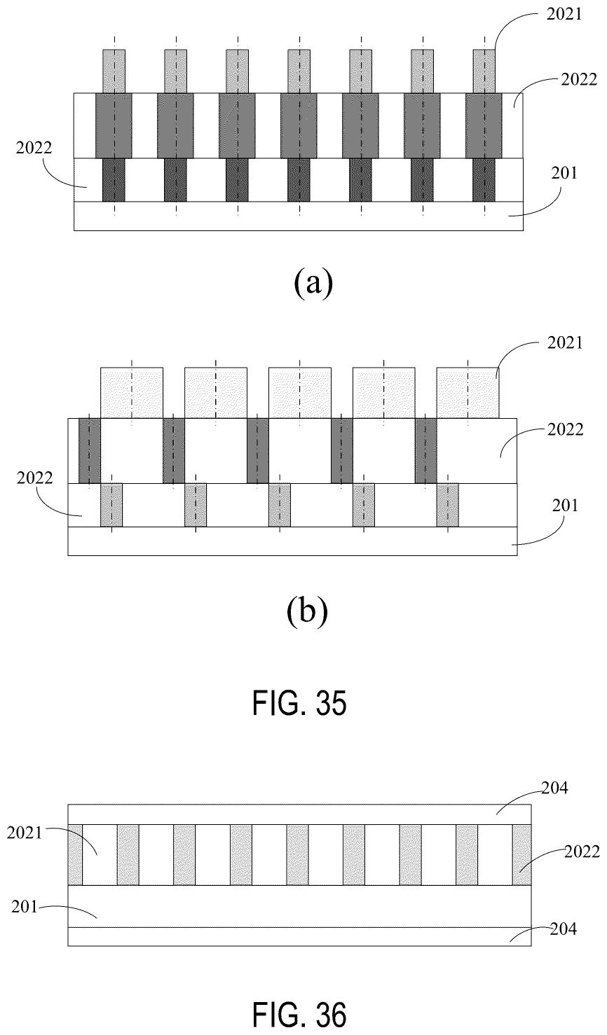

Preferably, as shown in FIG. 34, the present application provides a second lens 20 including at least two nanostructured layers 202. Optionally, as shown in (a) of FIG. 35, the plurality of nanostructures in any two adjacent nanostructured layers are in a coaxial arrangement. And the coaxial arrangement refers to the period of the nanostructures in the adjacent nanostructured layer are the same; or the axis of the nanostructure 2021 at the same position in the two adjacent nanostructured layers coincides. Optionally, as shown in (b) of FIG. 35, the metalens includes at least two nanostructured layers; the nanostructures in any adjacent nanostructured layer are non-coaxial along the direction parallel with the substrate. This arrangement is beneficial to break through the manufacturing limitation on the aspect ratio of the nanostructures in the metalens, so as to achieve higher design freedom. FIG. 34 shows a perspective view of an optional three-layer nanostructured layer. According to the embodiment of the present application, the shape, size, or material of the nanostructures 2021 in the adjacent nanostructured layer 202 may be the same or different.

In one embodiment, “a” to “d” in FIG. 31 show the shape of the nanostructures 2021 including a cylinder, a hollow cylinder, a square column, and a hollow square column, and the filler material 2021 is filled around the nanostructures 2022. In FIG. 31, the nanostructure 2021 is disposed at the center of the unit cell of the regular square 203. In an optional embodiment of the present application, “a” to “d” in FIG. 32 show the shape of the nanostructures 2021 including a cylinder, a hollow cylinder, a square column and a hollow square column, and there is no filler material 2022 filled around the nanostructures 2021. In FIG. 32, the nanostructures 2021 are disposed at the center of unit cell 203 of the regular square.

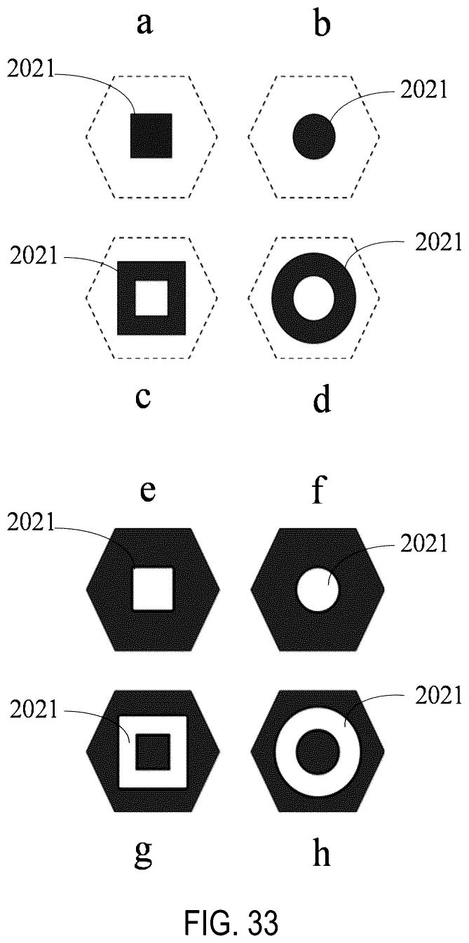

According to the embodiment of the present application, in FIG. 33, “a” to “d” shows the shape of the nanostructure 2021 including a square column, a cylinder, a hollow square column and a hollow cylinder respectively, and there is no filler material 2022 filled between the nanostructure 2021. As shown from “a” to “d” of FIG. 33, the nanostructure 2021 is disposed at the center of the unit cell 203 of the regular hexagonal shape. Optionally, “e” in FIG. 33 to “h” in FIG. 33 show the nanostructures 2021 as negative nanostructures, such as a square hole, circular, square, and circular columns. From “e” to “h” in FIG. 33, the nanostructure 2021 is a negative structure disposed at the center of the unit cell 203 of a positive hexagonal.

In one optional embodiment, as shown in FIG. 36, the metalens further includes an antireflection film 204. The antireflection film 204 is set on one side of the substrate away from the nanostructured layer; or the antireflection film 204 is set on a side of at least one nanostructured layer near the air. The antireflection film 204 is used to increase the transmittance of the incident lights and reduce the reflection of the incident lights.

According to the embodiment of the present application, the extinction coefficient of the substrate 201 is less than 0.01. For example, the substrate 201 may be made of molten quartz, quartz glass, crown glass, flint glass, sapphire, crystalline silicon, amorphous silicon or hydrogenated amorphous silicon. In one embodiment, when the working waveband of the metalens is a visible waveband, the substrate 201 may be made of molten quartz, quartz glass, crown glass, flint glass, sapphire or alkaline glass. In an optional embodiment, the material of the nanostructures 2021 is different from the material of the substrate 201. Optionally, the filler material 2022 is the same as the material of the substrate 201. Optionally, the filler material 2022 is different from the material of the substrate 201.

It should be understood that in some optional embodiments of the present application, the filler material 2022 is of the same material as the nanostructure 2021. In some optional embodiments of the present application, the filler material 2022 is different from the material of the nanostructure 2021. In one embodiment, the filler material 2022 is made of a high transmittance material with an extinction coefficient less than 0.01 at the working waveband. In one embodiment, the filler material 2022 may be made of molten quartz, quartz glass, crown glass, flint glass, sapphire, crystalline silicon, amorphous silicon, or hydrogenated amorphous silicon.

Optionally, the effective refractive index range of the metalens provided by the present application embodiment is less than 2. The effective refractive index range is the maximum refractive index of the metalens minus its minimum refractive index. According to the embodiment of the present application, the phase of the metalens provided by the embodiment of the present application also meets formula (7):

$$φ ( r , λ ) = \frac{2 π}{λ} {\sum }_{i = 1}^{N} {a}_{i} {r}^{2 i} + {φ}_{0} ( λ ) ; \qquad ( 7 - 1 )$$

$$φ ( r , λ ) = \frac{2 π}{λ} {\sum }_{i = 1}^{N} ( {a}_{i} {r}^{2 i} + \frac{{b}_{i}}{{r}^{2 i}} ) + {φ}_{0} ( λ ) ; \qquad ( 7 - 2 )$$

$$φ ( r , λ ) = \frac{2 π}{λ} {\sum }_{i = 1}^{N} \frac{{a}_{i}}{{r}^{2 i}} + {φ}_{0} ( λ ) ; \qquad ( 7 - 3 )$$

$$φ ( r , λ ) = \frac{2 π}{λ} {\sum }_{i = 1}^{N} {a}_{i} \vert {r}^{i} \vert + {φ}_{0} ( λ ) ; \qquad ( 7 - 4 )$$

$$φ ( r , λ ) = \frac{2 π}{λ} {\sum }_{i = 1}^{N} ( {a}_{i} \vert {r}^{i} \vert + \frac{{b}_{i}}{\vert {r}^{i} \vert} ) + {φ}_{0} ( λ ) ; \qquad ( 7 - 5 )$$

$$φ ( x , y , λ ) = \frac{2 π}{λ} {\sum }_{j = 1}^{N} {\sum }_{i = 1}^{j} ( {a}_{i j} {x}^{i} {y}^{j - i} + {b}_{i j} {x}^{j - i} {y}^{i} ) + {φ}_{0} ( λ ) ; \qquad ( 7 - 6 )$$

$$φ ( x , y , λ ) = \frac{2 π}{λ} ( {f}_{M L} - \sqrt{{f}_{ML}^{2} + {r}^{2}} ) + {φ}_{0} ( λ ) ; \qquad ( 7 - 7 )$$

$$φ ( x , y , λ ) = \frac{2 π}{λ} ( \sqrt{{f}_{ML}^{2} + {r}^{2}} - {f}_{M L} ) + {φ}_{0} ( λ ) ; \qquad ( 7 - 8 )$$

r is a distance between any center of nanostructure and the center of the metalens; λ is a working wavelength of the metalens; φ₀(λ) is any phase corresponding to the working wavelength; (x, y) is the coordinates of the metalens (in some cases, it can be regarded as the coordinates of the surface of the substrate 201); f_{ML} is a focal length of the second lens 20; aᵢ and bᵢ are real coefficients. It should be noted that the phase of the metalens can be expressed in high-degree polynomials, and high-degree polynomials include both odd and even polynomials. In order not to break the rotational symmetry of the phase of metalens, in general, the phase of the even-degree polynomials is only optimized, which greatly reduces the design degree of freedom of the metalens. From the formulas (7-1) to (7-8), formulas (7-4)-(7-6) are capable of satisfying the optimization of the phase of the odd-degree polynomial without breaking its rotational symmetry, and greatly increase the optimization degree of freedom of the metalens.

Optionally, the real phase of the metalens provided by the present application can match with the ideal theoretical phase, that is, the matching degree of the wide spectrum of the metalens satisfies the formula (8) as follows:

$$η = \frac{1}{{λ}_{max} - {λ}_{min}} {\int }_{{λ}_{min}}^{{λ}_{max}} \vert exp [ i ( {φ}_{t h e} ( λ ) - {φ}_{real} ( λ ) ) ] \vert d λ ; \qquad ( 8 )$$

λₘₐₓ is the longest wavelength at the working waveband and λₘᵢₙ is the shortest wavelength at the working waveband. For example, λₘₐₓ=700 nm, λₘᵢₙ=400 nm. φₜₕₑ is the target theoretical phase and φᵣₑₐₗ is the real phase in the database.

Furthermore, the aspheric surfaces of the aspheric refractive lenses satisfy:

$$z = \frac{{cr}^{2}}{1 + \sqrt{1 - ( 1 + k ) {c}^{2} {r}^{2}}} + A {r}^{4} + B {r}^{6} + C {r}^{8} + D {r}^{10} + {Er}^{12} + F {r}^{14} + G {r}^{16} + H {r}^{18} + {Jr}^{20} ; \qquad ( 9 )$$

In formula (9), z represents the surface vector parallel to z axis, and z axis is an optical axis of the optical system; c is the central curvature radius of the aspheric surface; k is a constant of center of quadric surface; A˜J are higher order coefficients.

In some optional embodiments, as shown in FIG. 1 to FIG. 24, the optical system includes an aperture slot 80. The aperture slot 80 may be set on the object side or image side of any aspheric refractive lens or metalens. The aperture slot 80 is beneficial to compress the radius of the lens located at the downstream of the optical path, which can improve the miniaturization of the optical system.

According to the embodiment of the present application, as shown in FIG. 1 to FIG. 24, the optical system in the present application may further include an infrared filter 90. The infrared filter 90 is set between the seventh lens 70 and the image plane of the optical system. When the working waveband is a visible waveband, the infrared filter 90 is beneficial to filter the lights at the infrared waveband to improve the imaging quality, which also can avoid the image sensor being damaged by burning.

### Embodiment 1

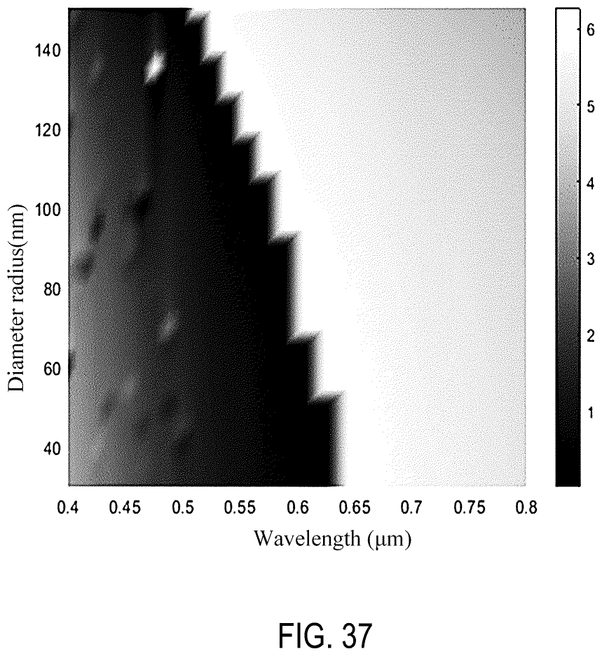

In one embodiment, the present embodiment provides a metalens. The metalens includes a substrate 201 and two nanostructured layers 202 setting on the substrate 201. From the direction away from the substrate 201, the two nanostructured layers 202 are first nanostructured layer and the second nanostructured layer. The specific parameter item are as shown in Table 1. FIG. 37 shows the phase diagram of the embodiment provided by the present application, and the horizontal coordinate of FIG. 37 is the wavelength of the incident lights, and the vertical coordinate is the radius of the nanostructures 2021.

In embodiment 1, the wide-spectrum phase of any unit cell 203 and the working waveband of the metalens also satisfy:

$$- \frac{68.8 rad}{μm} \leq \frac{d φ ( r = {r}_{0} , λ )}{d λ} \leq - 5 \text{.98} rad / μm ;$$

r is a radial coordinates of the metalens; r₀ is a distance between any position on the metalens and the center of the metalens; λ is a wavelength of the metalens.

TABLE 1

| Items | | Parameter item | |
|---|---|---|---|
| Working wavelength | | Visible light | |
| Material of substrate | | Quartz glass | |
| Period of regular hexagonal | | 400 | nm |
| The first | Type of nanostructure | Cylinder | |
| nanostructured layer | Material of nanostructure | Silicon nitride | |
| | Filler material | Silicon dioxide (SiO₂) | |
| | Height | 700 | nm |
| | Diameter of nanostructure | 70 | nm |
| The second | Type of nanostructure | Cylinder | |
| nanostructured layer | Material of nanostructure | Air | |
| | Filler material | Silicon dioxide (SiO₂) | |
| | Height | 700 | nm |
| | Diameter of nanostructure | 60~340 | nm |

### Embodiment 2

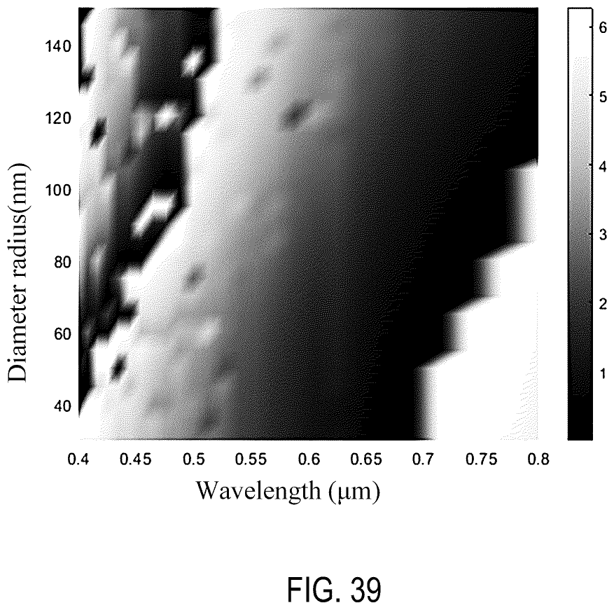

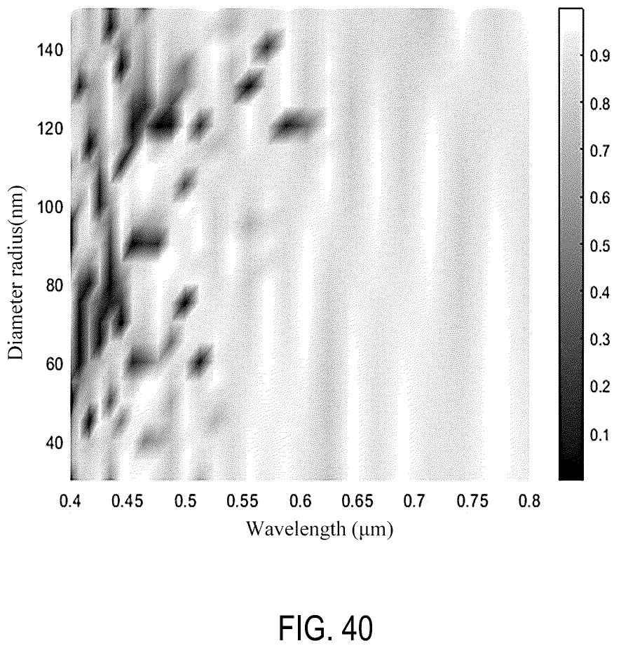

In one embodiment, the present embodiment provides a metalens. The metalens includes a substrate 201 and two nanostructured layers 202 setting on the substrate 201. From the direction away from the substrate 201, the two nanostructured layers 202 are the first nanostructured layer and the second nanostructured layer. The specific parameter item are shown in Table 2. FIG. 39 shows the phase diagram of the embodiment provided by the present application, and the horizontal coordinate of FIG. 39 is the wavelength of the incident lights, and the vertical coordinate is the radius of the nanostructures 2021. FIG. 40 shows a transmittance diagram of the metalens provided by embodiment 2, and the horizontal coordinate of FIG. 40 is a wavelength of incident lights, and the vertical coordinate is a radius of nanostructures 2021.

In embodiment 1, the wide-spectrum phase of any unit cell 203 and the working waveband of the metalens also satisfy:

$$- \frac{58.4 rad}{μm} \leq \frac{d φ ( r = {r}_{0} , λ )}{d λ} \leq - 8.3 rad / μm .$$

r is a radial coordinates of the metalens; r₀ is a distance between any position on the metalens and the center of the metalens; λ is a wavelength of the metalens.

TABLE 2

| Items | | Parameter item | |
|---|---|---|---|
| Working wavelength | | Visible light | |
| Material of substrate | | Quartz glass | |
| Period of regular hexagonal | | 400 | nm |
| The first | Type of nanostructure | Hollow circular cylinder | |
| nanostructured layer | Material of nanostructure | Silicon nitride | |
| | Filler material | Silicon dioxide (SiO₂) | |
| | Height | 700 | nm |
| | Inner diameter | 70 | nm |
| | Outer diameter | 220 | nm |
| The second | Type of nanostructure | Cylinder | |
| nanostructured layer | Material of nanostructure | Titanium dioxide | |
| | Filler material | Silicon dioxide (SiO₂) | |
| | Height | 700 | nm |
| | Diameter of nanostructure | 60~340 | nm |

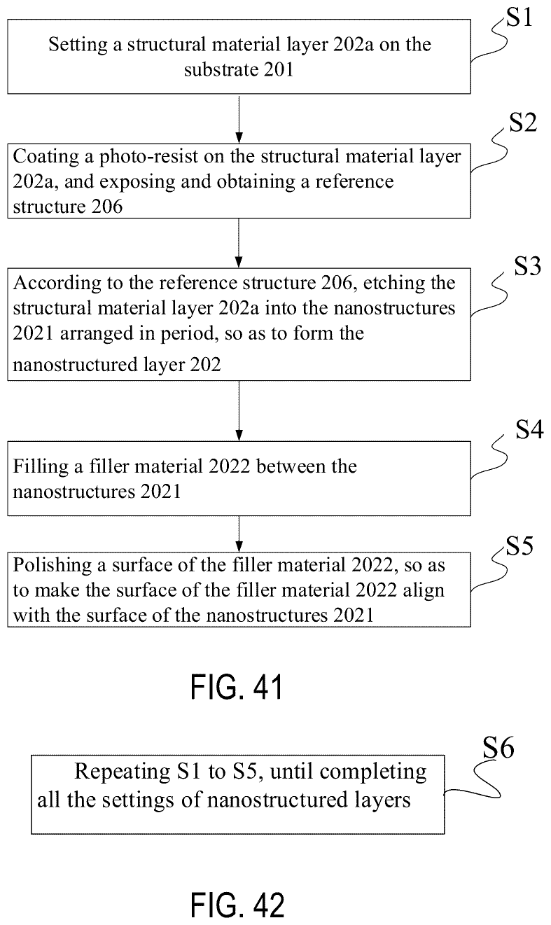

In the second aspect, the manufacturing method for the metalens is provided, and the manufacturing method is applied to the second metalens 20 in any embodiment provided by the present application. As shown in FIGS. 41 to 43, the manufacturing method comprises S1-S5:
S1. setting a structural material layer 202a on the substrate 201;
S2. coating a photo-resist on the structural material layer 202a, and exposing the structural material layer and obtaining a reference structure 206 (the structural material layer is used to be manufactured into nanostructures);
S3. according to the reference structure 206 etching the structural material layer 202a into the nanostructures 2021 arranged in a period, so as to form the nanostructured layer 202;
S4. filling a filler material 2022 between the nanostructures 2021;
S5. polishing a surface of the filler material 2022, so as to make the surface of the filler material 2022 align with the surface of the nanostructures 2021.

Optionally, as shown in FIG. 42, the manufacturing method further includes:
S6. repeating S1 to S5, until completing all the settings of nanostructured layers.

### Embodiment 3

In one embodiment, embodiment 3 provides an optical system, and the optical system is shown in FIG. 1. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 3-1. The curvature, thickness, refractive index, and other parameter item of each lens in the optical system are shown in Table 3-2. The aspherical coefficients of each surface of each lens in the optical system are shown in Table 3-3-1 and Table 3-3-2, and the aspheric coefficients are shown in formula (9).

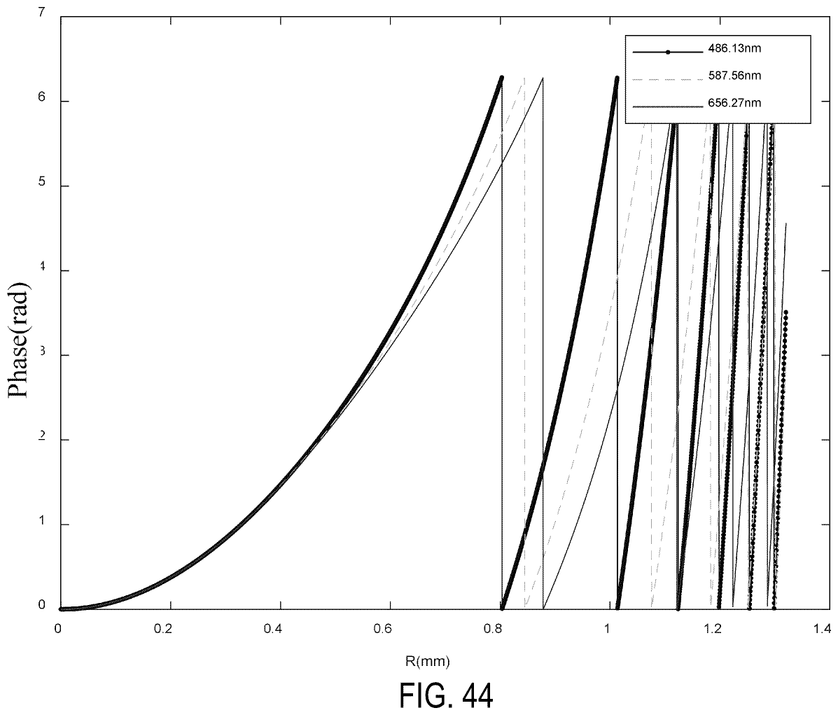

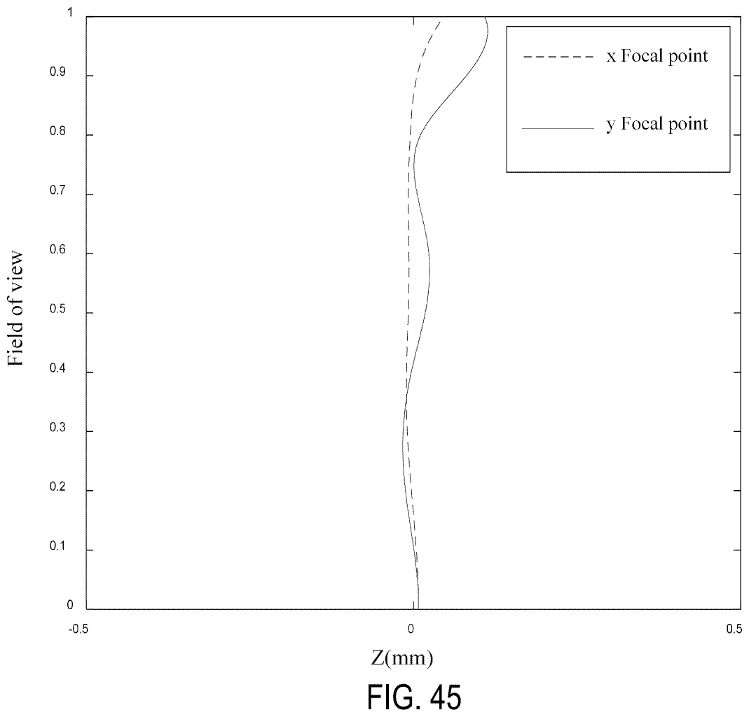

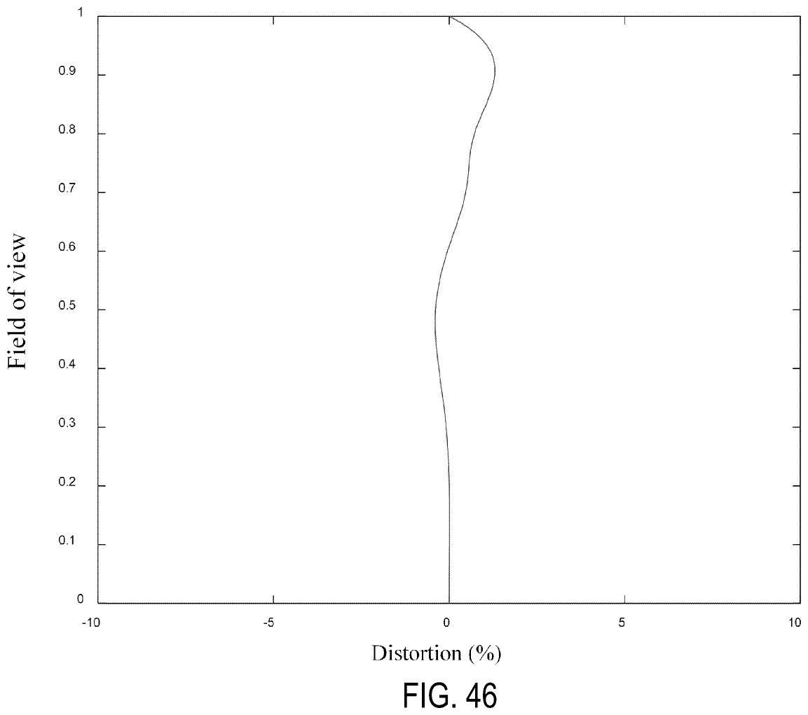

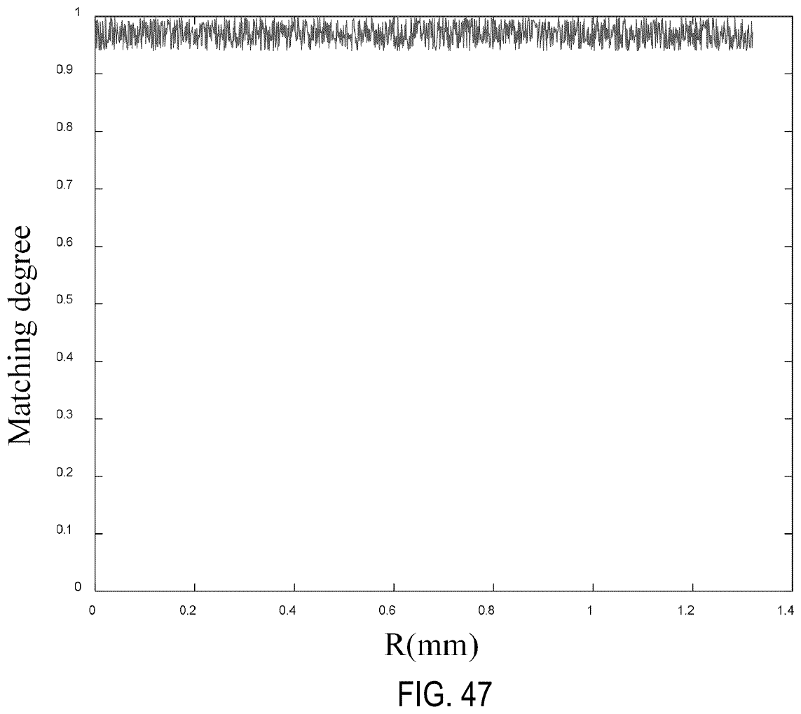

FIG. 44 shows a phase modulation diagram of the metalens in the optical system provided by embodiment 3 at the wavelengths of 486.13 nm, 587.56 nm, and 656.27 nm. It can been in FIG. 44 that the phases cover 0-2π of the metalens at different wavelengths. FIG. 45 shows an astigmatism diagram of the optical system. According to FIG. 45, the astigmatism of the optical system at the different fields of view from 0 to 1 is less than 0.5 mm. FIG. 46 shows a distortion diagram of the optical system. According to FIG. 46, the distortion of the optical system at the different fields of view from 0 to 1 is less than 5%. FIG. 47 shows the matching degree of the wide spectrum of the metalens in the optical system in embodiment 3. According to FIG. 47, the real phase of embodiment 3 and the theoretical phase is greater than 90%. The optical system in embodiment 3 has a high MTF and has good control of astigmatism and distortion, therefore the optical system has good imaging quality.

TABLE 3-1

| Parameter item | Parameter value |
|---|---|
| Working wavelength(WL) | VIS(400-700 nm) |
| Effective focal length(EFL) | 4.1 mm |
| Field of view(2ω) | 74° |
| F number | 1.6 |
| Image height(ImgH) | 3.09 mm |
| Total track length(TTL) | 5.4 mm |

TABLE 3-2

| Numbered | | Radius | Thickness | |
|---|---|---|---|---|
| surface | Surface type | (mm) | (mm) | Material |
| STO | Spherical surface | Infinite | −0.39 | |
| L₁ₒ | Aspheric surface | 2.1748 | 0.7963 | 545000 · 559000 |
| L₁ᵢ | Aspheric surface | 892.0709 | 0.0375 | |
| L₂ₒ | Structural surface (metalens) | Infinite | 0.1 | 458000 · 676000 |
| L₂ᵢ | Spherical surface | Infinite | 0.0372 | |
| L₃ₒ | Aspheric surface | 3.6271 | 0.3 | 661000 · 203000 |
| L₃ᵢ | Aspheric surface | 2.189 | 0.6264 | |
| L₄ₒ | Aspheric surface | 156.1618 | 0.4061 | 661000 · 203000 |
| L₄ᵢ | Aspheric surface | 9.4362 | 0.2128 | |
| L₅ₒ | Aspheric surface | 482.703 | 1.0022 | 544000 · 559000 |
| L₅ᵢ | Aspheric surface | −1.469 | 0.0436 | |
| L₆ₒ | Aspheric surface | 1.7205 | 0.3029 | 544000 · 559000 |
| L₆ᵢ | Aspheric surface | 1.066 | 0.6624 | |
| L₇ₒ | Aspheric surface | 6.238 | 0.3198 | 544000 · 559000 |
| L₇ᵢ | Aspheric surface | 1.9309 | 0.3965 | |
| IR filterₒ | Spherical surface | Infinite | 0.2 | 517000 · 642000 |
| IR filterᵢ | Spherical surface | Infinite | 0.1074 | |
| Image plane | Spherical surface | Infinite | 0 | |

TABLE 3-3-1

| Numbered surface | L₁ₒ | L₁ᵢ | L₃ₒ | L₃ᵢ | L₄ₒ | L₄ᵢ |
|---|---|---|---|---|---|---|
| K | −0.73596 | 435965.1 | 0.035354 | −1.05314 | −34242.6 | 17.52245 |
| A | −0.00406 | −0.05578 | −0.12276 | −0.09809 | −0.12928 | −0.13602 |
| B | 0.039546 | 0.126059 | 0.164098 | 0.128766 | 0.056962 | 0.028631 |
| C | −0.05123 | −0.13341 | −0.13387 | −0.12873 | −0.06871 | 0.005743 |
| D | 0.032138 | 0.060188 | 0.031657 | 0.070294 | 0.04001 | −0.01231 |
| E | −0.00856 | −0.01109 | 0.009813 | −0.02375 | −0.01634 | 0.006407 |
| F | 2.48E−05 | −5.50E−05 | −0.0037 | 0.004793 | 0.004556 | −0.00082 |
| G | −7.37E−06 | −1.09E−06 | 4.04E−06 | 1.50E−05 | −1.89E−05 | 6.89E−06 |

TABLE 3-3-2

| Numbered surface | L₅ₒ | L₅ᵢ | L₆ₒ | L₆ᵢ | L₇ₒ | L₇ᵢ |
|---|---|---|---|---|---|---|
| K | −5445290 | −0.80381 | −0.5623 | −2.69294 | 1.036368 | −2.43256 |
| A | −0.03872 | 0.049486 | −0.18452 | −0.0823 | −0.08073 | −0.10759 |
| B | −0.0432 | −0.02644 | 0.056131 | 0.027011 | 0.017636 | 0.023877 |
| C | 0.059331 | 0.014075 | −0.01149 | −0.00612 | −0.00171 | −0.00251 |
| D | −0.02569 | −0.00235 | 0.000844 | 0.000651 | 8.17E−05 | 0.000133 |
| E | 0.005283 | 0.000279 | 7.77E−05 | −1.35E−05 | −2.23E−06 | −3.18E−06 |
| F | −0.00047 | −7.88E−05 | −1.26E−05 | −1.51E−06 | 1.35E−08 | −3.07E−09 |
| G | 5.22E−06 | 8.57E−06 | −4.43E−08 | −5.02E−09 | 1.69E−09 | −5.09E−10 |

### Embodiment 4

In one embodiment, embodiment 4 provides an optical system, and the optical system is shown in FIG. 2. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 4-1. The curvature, thickness, refractive index, and other parameter item of each lens in the optical system are shown in Table 4-2. The aspherical coefficients of each surface of each lens in the optical system are shown in Table 4-3-1 and Table 4-3-2, and the aspheric coefficients are shown in formula (9).

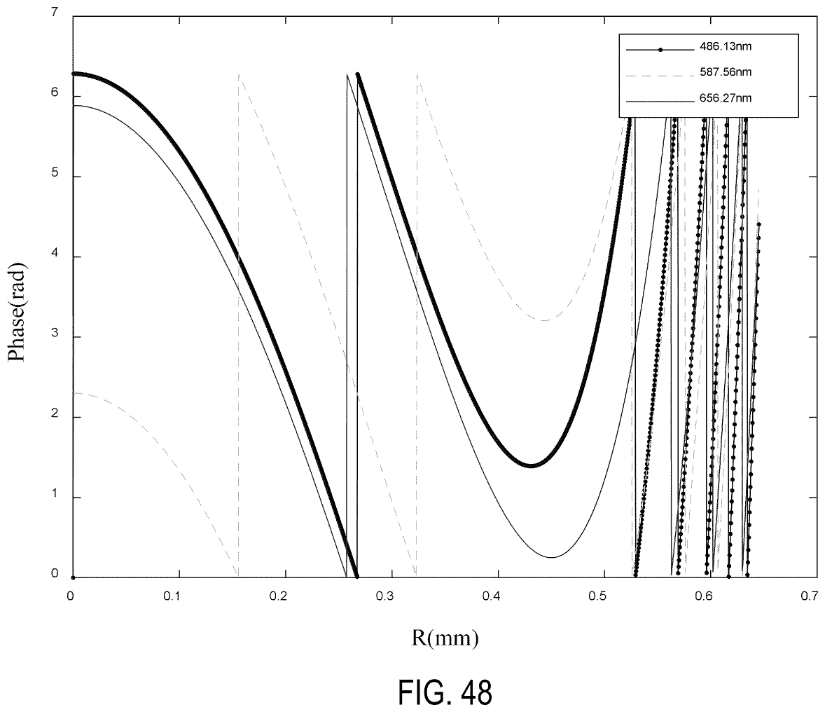

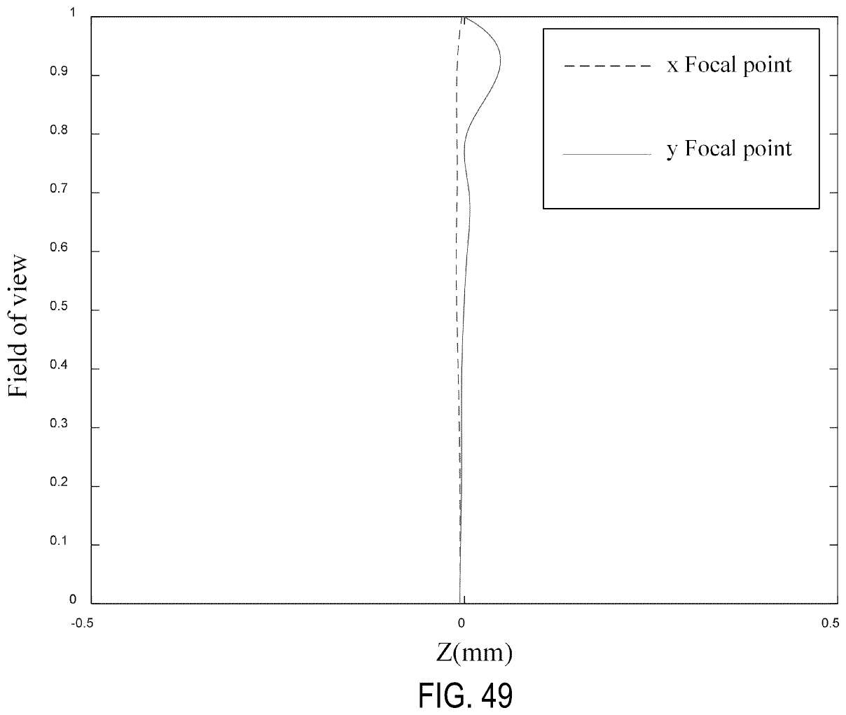

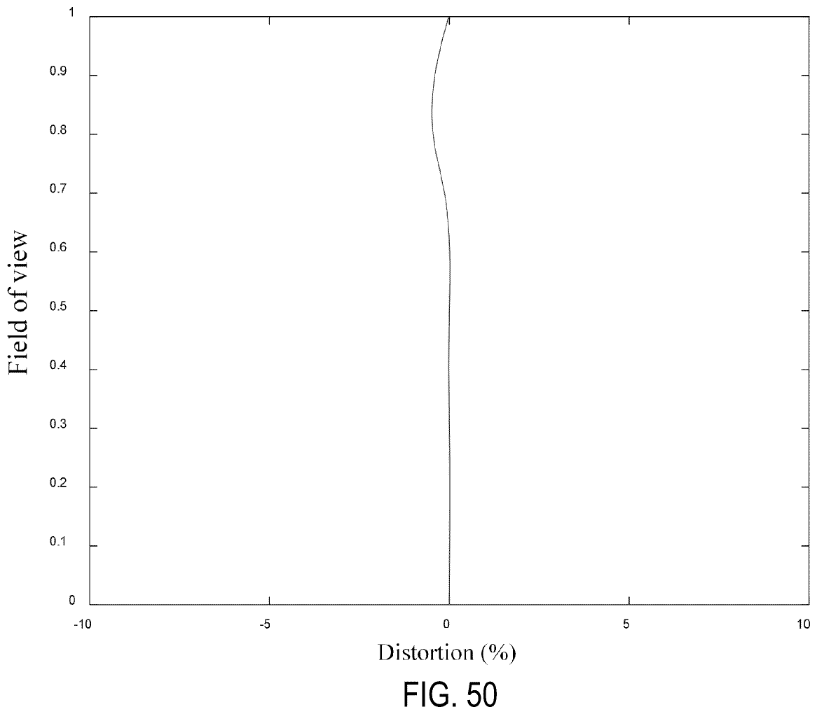

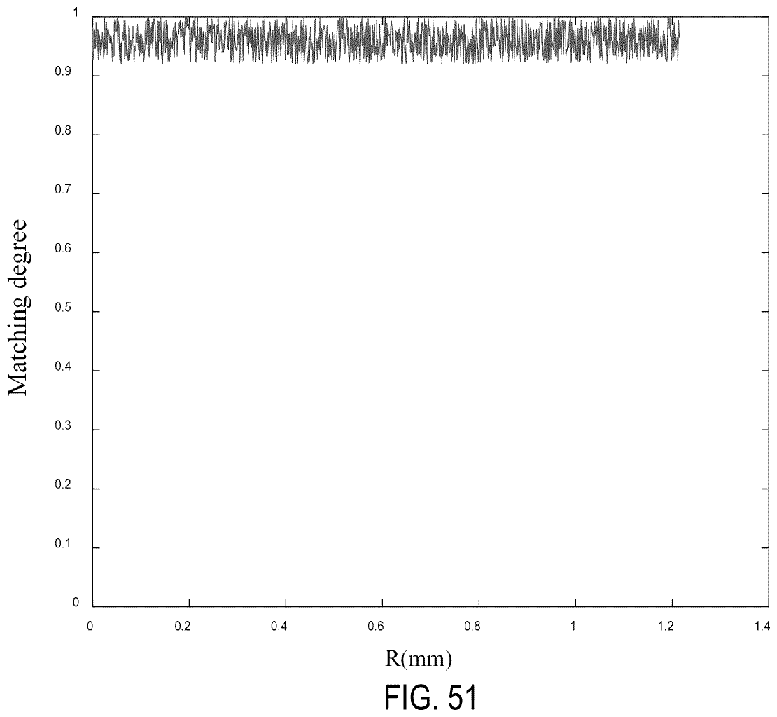

FIG. 48 shows a phase modulation diagram of the metalens in the optical system provided by embodiment 4 at the wavelengths of 486.13 nm, 587.56 nm, and 656.27 nm. It can be seen in FIG. 48 that the phases cover 0-2π of the metalens at different wavelengths. FIG. 49 shows an astigmatism diagram of the optical system. According to FIG. 49, the astigmatism of the optical system is less than 0.5 mm at the different fields of view from 0 to 1. FIG. 50 shows a distortion diagram of the optical system. According to FIG. 50, the distortion of the optical system at different fields of view from 0 to 1 is less than 5%. FIG. 51 shows the matching degree of the wide spectrum of the metalens in the optical system in embodiment 4. According to FIG. 51, the real phase of embodiment 4 and the theoretical phase is greater than 90%. The optical system in embodiment 4 has a high MTF and has good control of astigmatism and distortion, therefore the optical system has good imaging quality.

TABLE 4-1

| Parameter item | Parameter value |
|---|---|
| Working wavelength(WL) | VIS(400-700 nm) |
| Effective focal length(EFL) | 4.1 mm |
| Field of view(2ω) | 74° |
| F number | 1.8 |
| Image height(ImgH) | 3.0896 mm |
| Total track length(TTL) | 5.2 mm |

TABLE 4-2

| Numbered | | Radius | Thickness | |
|---|---|---|---|---|
| surface | Surface type | (mm) | (mm) | Material |
| STO | Spherical surface | Infinite | −0.3413 | |
| L₁ₒ | Aspheric surface | 1.8867 | 0.666717 | 545000.559000 |
| L₁ᵢ | Aspheric surface | −73.914 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 3.988547 | 0.220001 | 636000.239000 |
| L₃ᵢ | Aspheric surface | 2.000725 | 0.521565 | |
| L₄ₒ | Aspheric surface | 6.723371 | 0.22 | 636000.239000 |
| L₄ᵢ | Aspheric surface | 4.218824 | 0.05 | |
| L₅ₒ | Aspheric surface | −326.542 | 1.040512 | 545000.559000 |
| L₅ᵢ | Aspheric surface | −2.03165 | 0.326758 | |
| L₆ₒ | Aspheric surface | 19.16069 | 6.85E−01 | 545000.559000 |
| L₆ᵢ | Aspheric surface | 4.982863 | 0.599391 | |
| L₇ₒ | Aspheric surface | −2.76902 | 0.22 | 545000.559000 |
| L₇ᵢ | Aspheric surface | 8.615226 | 0.050116 | |
| IR filterₒ | Spherical surface | Infinite | 0.2 | 517000.642000 |
| IR filterᵢ | Spherical surface | Infinite | 0.2 | |
| Image plane | Spherical surface | Infinite | 0 | |

TABLE 4-3-1

| Numbered surface | L₁ₒ | L₁ᵢ | L₃ₒ | L₃ᵢ | L₄ₒ | L₄ᵢ |
|---|---|---|---|---|---|---|
| K | −0.02516 | −55354.5 | 3.140364 | 0.280163 | −5.42866 | −1.87419 |
| A | −0.00427 | −0.0031 | −0.06281 | −0.07837 | −0.17081 | −0.14299 |
| B | 0.024045 | 0.047383 | 0.098278 | 0.113758 | 0.052029 | 0.027876 |
| C | −0.04024 | −0.06621 | −0.09663 | −0.09601 | −0.02864 | −0.01162 |
| D | 0.034437 | 0.040583 | 0.03995 | 0.043672 | 0.004019 | 0.006886 |
| E | −0.01202 | −0.00987 | −0.00449 | −0.00865 | −0.001 | −0.00012 |
| F | 7.46E−05 | −0.00106 | −0.00052 | 0.002537 | 0.001214 | 0.000167 |
| G | 0.000249 | 0.000125 | −0.00041 | −0.00043 | −0.000861 | −6.22E−05 |

TABLE 4-3-2

| Numbered surface | L₅ₒ | L₅ᵢ | L₆ₒ | L₆ᵢ | L₇ₒ | L₇ᵢ |
|---|---|---|---|---|---|---|
| K | 48811.77 | 0.084172 | −560.94 | −2.03638 | −0.31662 | −50.2104 |
| A | 0.010704 | −0.0072 | −0.07156 | −0.03276 | 0.021286 | −0.02597 |
| B | −0.04614 | 0.006248 | −0.00139 | −0.00258 | 0.00138 | 0.005212 |
| C | 0.028534 | −0.00094 | −0.00345 | 0.000689 | 1.94E−07 | −0.00048 |
| D | −0.00561 | −0.00112 | −0.00047 | −4.37E−05 | −3.16E−05 | 2.20E−05 |
| E | 0.000417 | 7.79E−05 | −7.27E−05 | 6.54E−06 | 2.39E−06 | 5.73E−07 |
| F | −3.91E−05 | 6.62E−06 | −1.25E−05 | −2.19E−07 | 5.12E−09 | −2.72E−08 |
| G | −6.75E−06 | 8.32E−06 | 1.99E−05 | −4.95E−08 | −7.10E−10 | −5.54E−09 |

### Embodiment 5

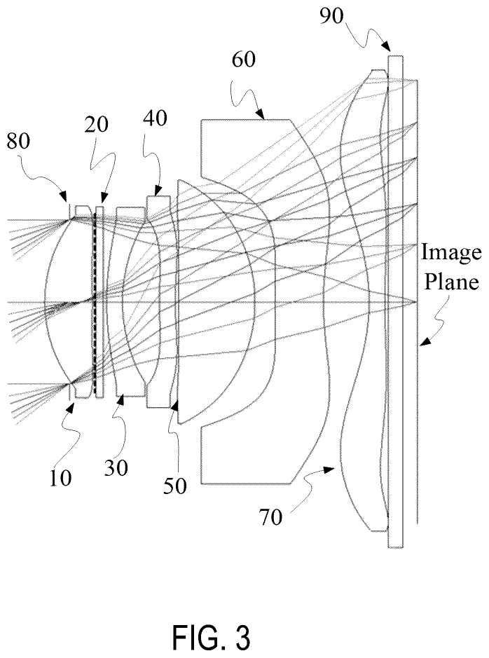

In one embodiment, embodiment 5 provides an optical system, and the optical system is shown in FIG. 3. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 5-1. The curvature, thickness, refractive index, and other parameter item of each lens in the optical system are shown in Table 5-2. The aspherical coefficients of each surface of each lens in the optical system are shown in Table 5-3-1 and Table 5-3-2, and the aspheric coefficients are shown in formula (9).

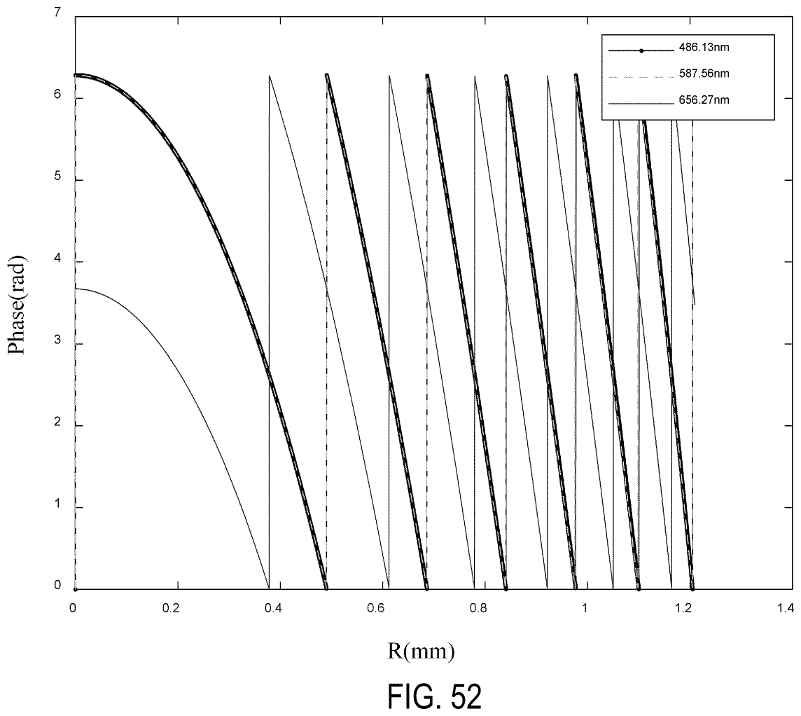

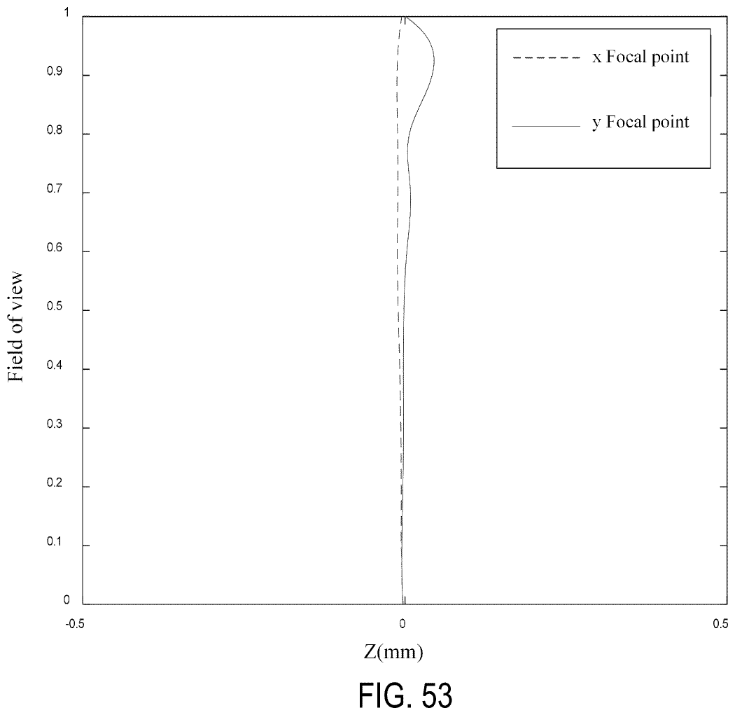

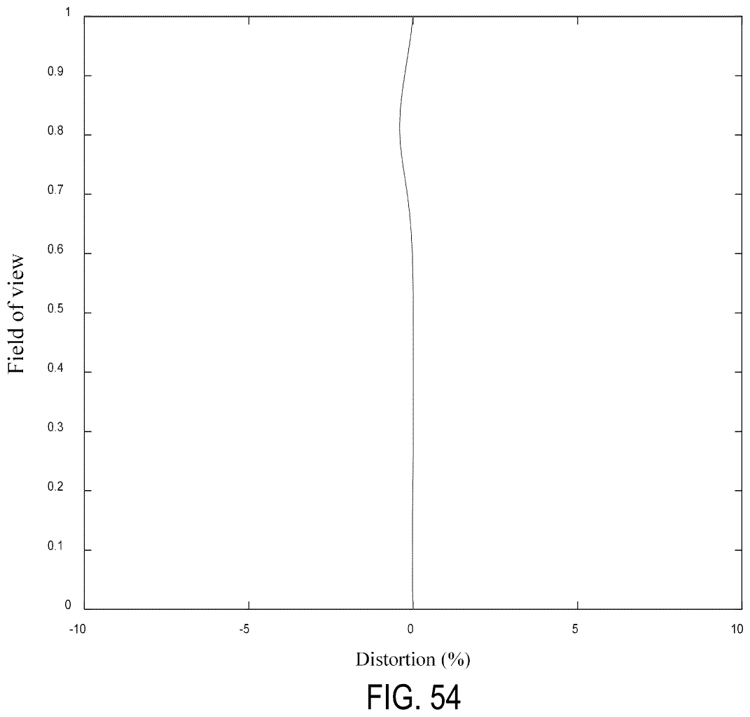

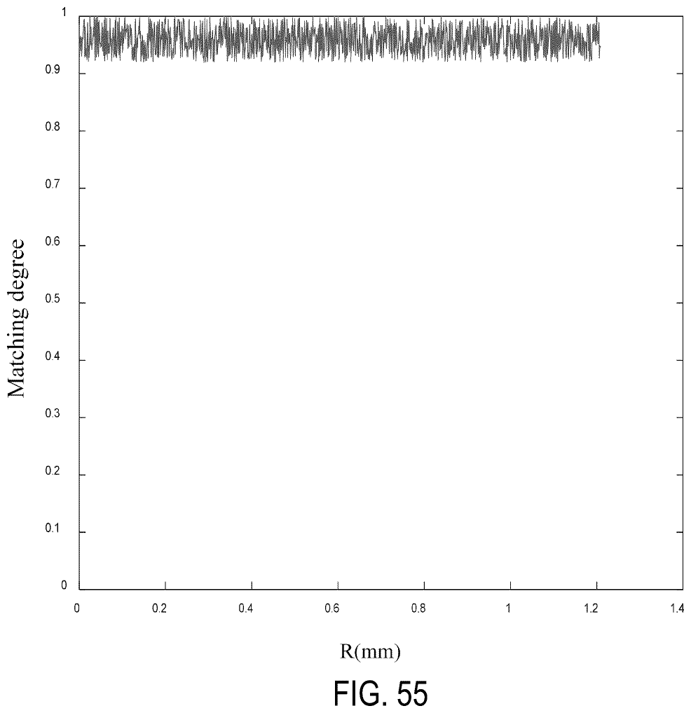

FIG. 52 shows a phase modulation diagram of the metalens in the optical system provided by embodiment 5 at the wavelengths of 486.13 nm, 587.56 nm, and 656.27 nm. It can be seen in FIG. 52 that the phases cover 0-2π of the metalens at different wavelengths. FIG. 53 shows an astigmatism diagram of the optical system. According to FIG. 54, the astigmatism of the optical system at the different fields of view from 0 to 1 is less than 0.5 mm. FIG. 54 shows a distortion diagram of the optical system. According to FIG. 54, the distortion of the optical system at the different fields of view from 0 to 1 is less than 5%. FIG. 55 shows the matching degree of the wide spectrum of the metalens in the optical system in embodiment 5. According to FIG. 55, the real phase of embodiment 5 and the theoretical phase is greater than 90%. The optical system in embodiment 5 has a high MTF and has good control of astigmatism and distortion, therefore the optical system has good imaging quality.

TABLE 5-1

| Parameter item | Parameter value | |
|---|---|---|
| Working wavelength(WL) | VIS(400-700 nm) | |
| Effective focal length(EFL) | 4.1 | mm |
| Field of view(2ω) | 74º | |
| F number | 1.8 | |
| Image height(ImgH) | 3.0896 | mm |
| Total track length(TTL) | 5.2 | mm |

TABLE 5-2

| Numbered | | Radius | Thickness | |
|---|---|---|---|---|
| surface | Surface type | (mm) | (mm) | Material |
| STO | Spherical surface | Infinite | −0.3413 | |
| L₁ₒ | Aspheric surface | 1.895 | 0.66426 | 545000.559000 |
| L₁ᵢ | Aspheric surface | −94.9423 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 3.908717 | 0.22 | 636000.239000 |
| L₃ᵢ | Aspheric surface | 2.014326 | 0.519156 | |
| L₄ₒ | Aspheric surface | 7.277648 | 0.22 | 636000.239000 |
| L₄ᵢ | Aspheric surface | 4.425859 | 0.051196 | |
| L₅ₒ | Aspheric surface | −1428.18 | 1.061101 | 544000.559000 |
| L₅ᵢ | Aspheric surface | −2.05231 | 2.80E−01 | |
| L₆ₒ | Aspheric surface | 1.18E+01 | 6.76E−01 | 544000.559000 |
| L₆ᵢ | Aspheric surface | 4.16E+00 | 0.63863 | |
| L₇ₒ | Aspheric surface | −2.68E+00 | 0.22 | 544000.559000 |
| L₇ᵢ | Aspheric surface | 1.06E+01 | 0.05007 | |
| IR filterₒ | Spherical surface | Infinite | 0.2 | 517000.642000 |
| IR filterᵢ | Spherical surface | Infinite | 0.2 | |
| Image plane | Spherical surface | Infinite | 0 | |

TABLE 5-3-1

| Numbered surface | L₁ₒ | L₁ᵢ | L₃ₒ | L₃ᵢ | L₄ₒ | L₄ᵢ |
|---|---|---|---|---|---|---|
| K | −0.02296 | −116865 | 2.768808 | 0.244399 | −5.44331 | −1.48E+00 |
| A | −0.00463 | −0.00328 | −0.06358 | −7.68E−02 | −1.70E−01 | −1.42E−01 |
| B | 0.024049 | 0.046728 | 9.74E−02 | 1.11E−01 | 5.45E−02 | 2.97E−02 |
| C | −0.04047 | −6.66E−02 | −9.73E−02 | −9.60E−02 | −2.94E−02 | −1.19E−02 |
| D | 0.034353 | 0.040476 | 0.039872 | 0.043151 | 0.003545 | 0.006483 |
| E | −0.01201 | −0.00985 | −0.00433 | −0.00886 | −0.00064 | −3.43E−05 |
| F | 4.89E−05 | −0.00106 | −0.00037 | 0.00238 | 0.000712 | 0.000224 |
| G | 0.000199 | 0.000103 | −0.0003 | −0.00043 | −0.00128 | −1.23E−05 |

TABLE 5-3-2

| Numbered surface | L₅ₒ | L₅ᵢ | L₆ₒ | L₆ᵢ | L₇ₒ | L₇ᵢ |
|---|---|---|---|---|---|---|
| K | −1.2E+12 | 0.119052 | 26.35453 | −2.40097 | 0.35411 | −32.4527 |
| A | 1.42E−02 | −0.00765 | −0.08964 | −0.03804 | 0.022406 | −0.0291 |
| B | −4.79E−02 | 0.006799 | 0.003296 | −0.0018 | 0.001455 | 0.005651 |
| C | 2.83E−02 | −0.00134 | −0.00515 | 0.000731 | 3.31E−06 | −0.00046 |
| D | −0.00533 | −0.00118 | −0.00054 | −4.72E−05 | −3.27E−05 | 1.96E−05 |
| E | 0.000559 | 0.000115 | 2.58E−05 | 5.70E−06 | 2.29E−06 | 2.82E−07 |
| F | −1.94E−05 | 2.86E−05 | 7.21E−06 | −2.30E−07 | 5.04E−09 | −3.20E−08 |
| G | −4.53E−05 | 5.39E−06 | 1.01E−05 | −4.67E−08 | 4.20E−10 | −3.67E−09 |

### Embodiment 6

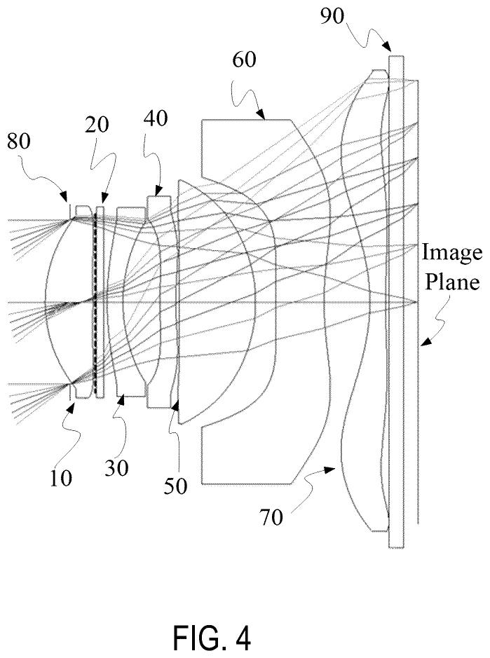

In one embodiment, embodiment 6 provides an optical system, and the optical system is shown in FIG. 4. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 6-1. The curvature, thickness, refractive index, and other parameter item of each lens in the optical system are shown in Table 6-2. The aspherical coefficients of each surface of each lens in the optical system are shown in Table 6-3-1 and Table 6-3-2, and the aspheric coefficients are shown in formula (9).

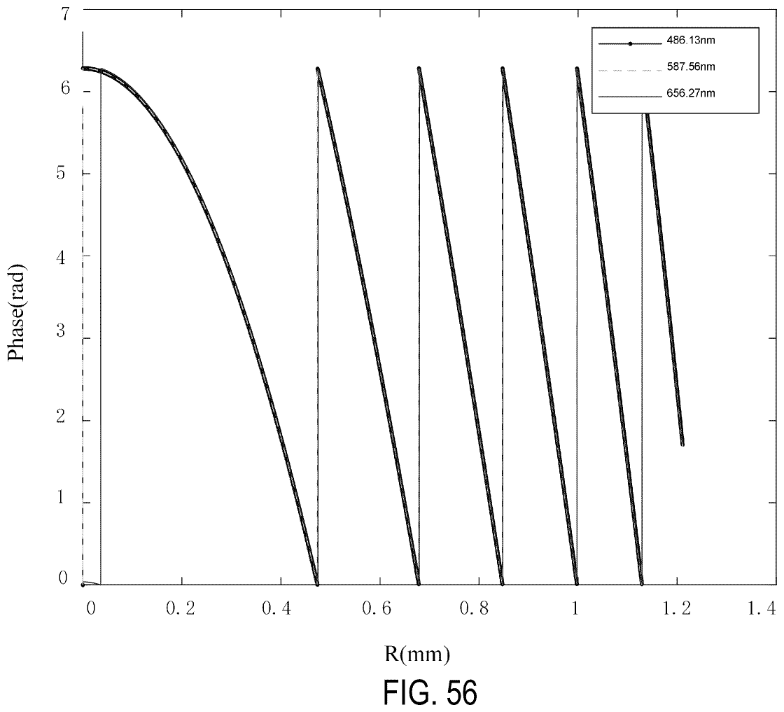

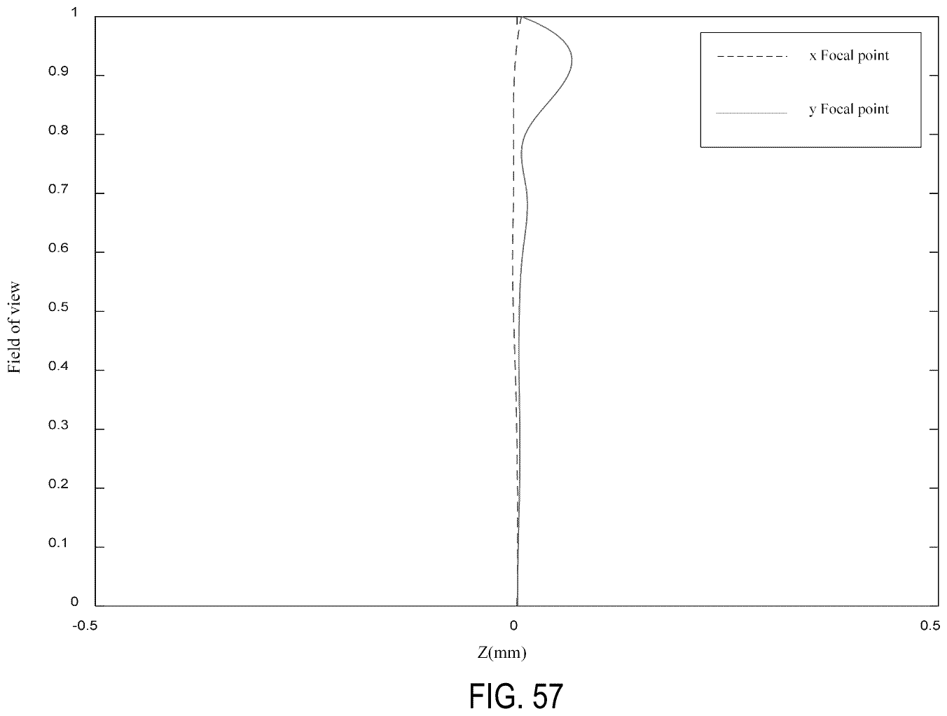

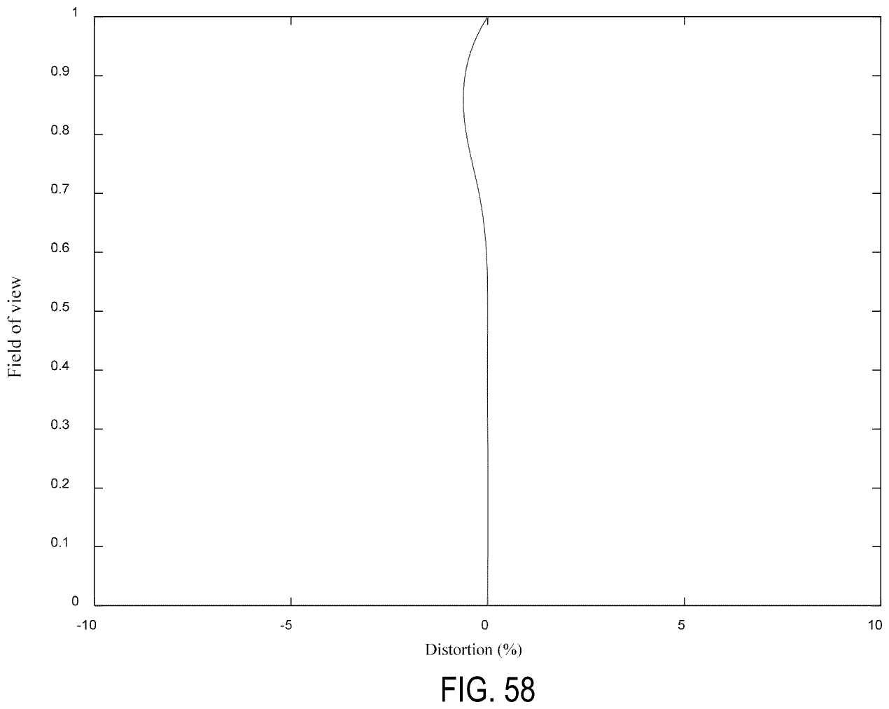

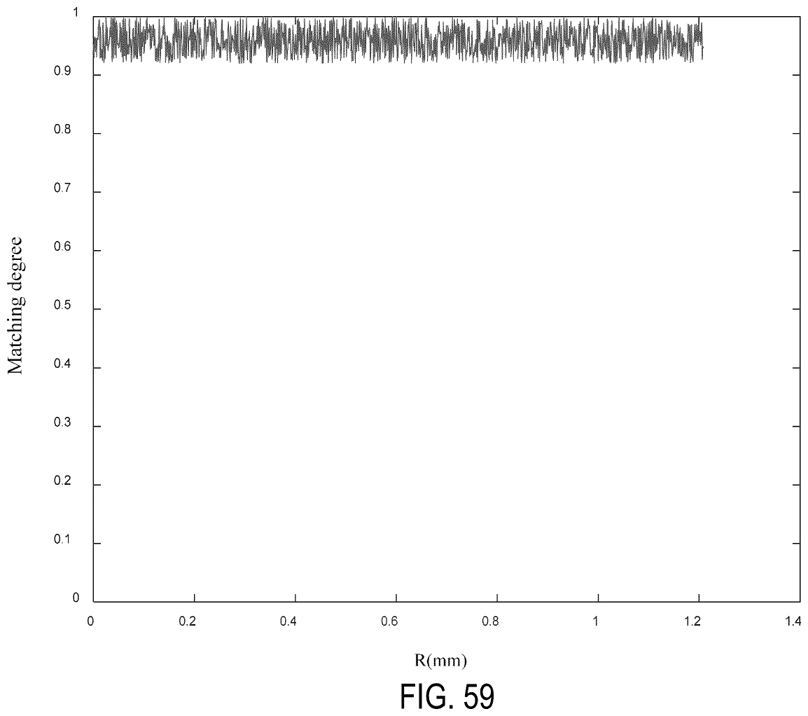

FIG. 56 shows a phase modulation diagram of the metalens in the optical system provided by embodiment 6 at the wavelengths of 486.13 nm, 587.56 nm, and 656.27 nm. It can be seen in FIG. 56 that the phases cover 0-2π of the metalens at different wavelengths. FIG. 56 shows an astigmatism diagram of the optical system. According to FIG. 57, the astigmatism of the optical system at the different fields of view from 0 to 1 is less than 0.5 mm. FIG. 57 shows a distortion diagram of the optical system. According to FIG. 58, the distortion of the optical system at the different fields of view from 0 to 1 is less than 5%. FIG. 59 shows the matching degree of the wide spectrum of the metalens in the optical system in embodiment 6. According to FIG. 59, the real phase of embodiment 6 and the theoretical phase is greater than 90%. The optical system in embodiment 6 has a high MTF and has good control of astigmatism and distortion, therefore the optical system has good imaging quality.

TABLE 6-1

| Parameter item | Parameter value | |
|---|---|---|
| Working wavelength(WL) | VIS(400-700 nm) | |
| Effective focal length(EFL) | 4.1 | mm |
| Field of view(2ω) | 74º | |
| F number | 1.8 | |
| Image height(ImgH) | 3.0896 | mm |
| Total track length(TTL) | 5.2 | mm |

TABLE 6-2

| Numbered | | Radius | Thickness | |
|---|---|---|---|---|
| surface | Surface type | (mm) | (mm) | Material |
| STO | Spherical surface | Infinite | −0.3413 | |
| L₁ₒ | Aspheric surface | 1.8984 | 0.659913 | 545000.559000 |
| L₁ᵢ | Aspheric surface | 1040.99 | 0.050003 | |
| L₂ₒ | Structural surface (metalens) | Infinite | 0.1 | 458000.676000 |
| L₂ᵢ | Spherical surface | Infinite | 0.050003 | |
| L₃ₒ | Aspheric surface | 4.030357 | 0.243076 | 636000.239000 |
| L₃ᵢ | Aspheric surface | 2.074144 | 0.516902 | |
| L₄ₒ | Aspheric surface | 8.165474 | 0.22 | 636000.239000 |
| L₄ᵢ | Aspheric surface | 4.520604 | 0.05015 | |
| L₅ₒ | Aspheric surface | −1384.94 | 1.03E+00 | 544000.559000 |
| L₅ᵢ | Aspheric surface | −2.06E+00 | 3.40E−01 | |
| L₆ₒ | Aspheric surface | 9.81E+00 | 6.51E−01 | 544000.559000 |
| L₆ᵢ | Aspheric surface | 4.272083 | 6.21E−01 | |
| L₇ₒ | Aspheric surface | −2.65024 | 0.220002 | 544000.559000 |
| L₇ᵢ | Aspheric surface | 10.26796 | 5.01E−02 | |
| IR filterₒ | Spherical surface | Infinite | 0.2 | 516000.641000 |
| IR filterᵢ | Spherical surface | Infinite | 2.00E−01 | |
| Image plane | Spherical surface | Infinite | 0 | |

TABLE 6-3-2

| Numbered surface | L₅ₒ | L₅ᵢ | L₆ₒ | L₆ᵢ | L₇ₒ | L₇ᵢ |
|---|---|---|---|---|---|---|
| K | 8.96E+05 | 1.20E−01 | 3.17E+01 | −3.18E+00 | −3.64E−01 | −8.33E+01 |
| A | 0.011435 | −0.01155 | −0.09384 | −0.03859 | 0.022592 | −0.02452 |
| B | −0.04831 | 0.007609 | 0.00527 | −0.00181 | 0.0015 | 0.005162 |
| C | 0.028402 | −0.00099 | −0.00586 | 0.0007 | −2.21E−07 | −0.00047 |
| D | −0.00534 | −0.0012 | −0.00017 | 5.12E−05 | −3.30E−05 | 2.12E−05 |
| E | 0.000554 | 0.000128 | 7.85E−05 | 5.59E−06 | 2.28E−06 | 4.40E−07 |
| F | −6.54E−06 | 3.03E−05 | −2.07E−05 | −1.93E−07 | 7.16E−09 | −2.86E−08 |
| G | −4.69E−05 | −2.23E−06 | −4.03E−06 | −2.85E−08 | 6.93E−10 | −4.74E−09 |

### Embodiment 7

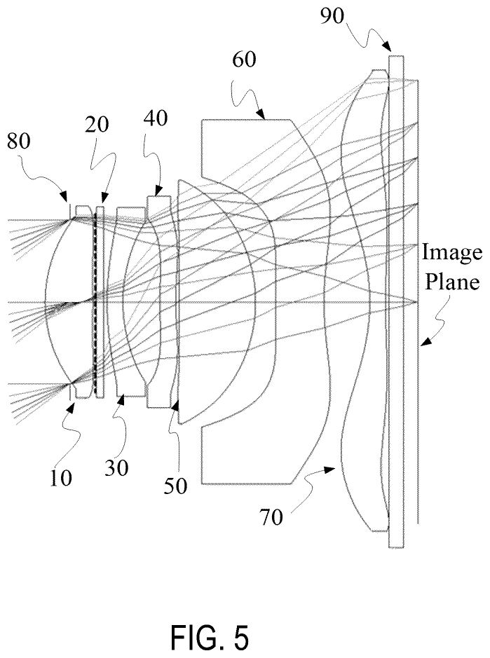

In one embodiment, embodiment 7 provides an optical system, and the optical system is shown in FIG. 5. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 7-1. The curvature, thickness, refractive index, and other parameter item of each lens in the optical system are shown in Table 7-2. The aspherical coefficients of each surface of each lens in the optical system are shown in Table 7-3-1 and Table 7-3-2, and the aspheric coefficients are shown in formula (9).

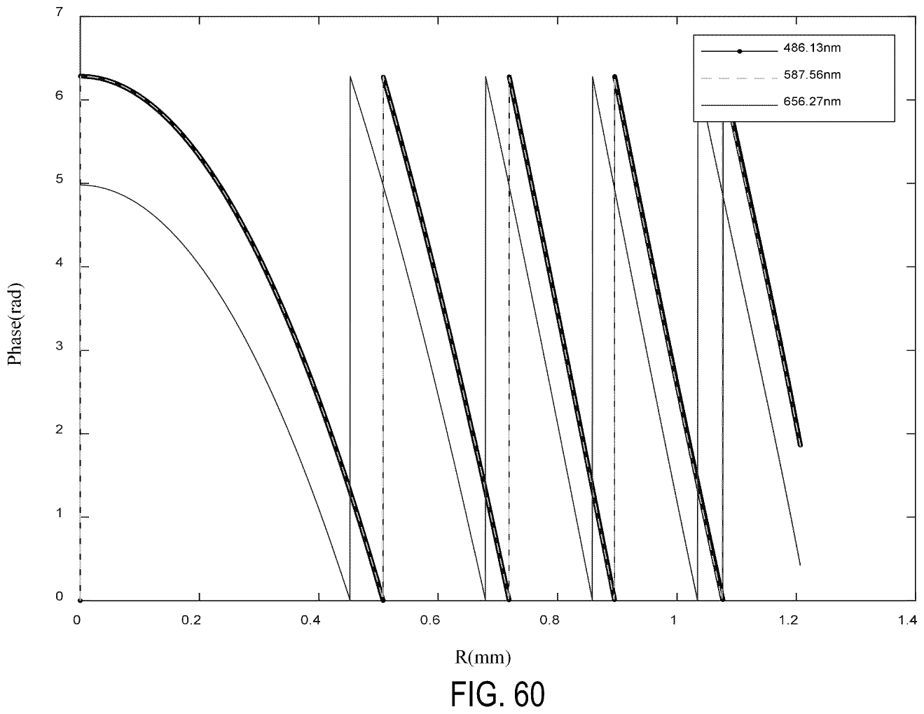

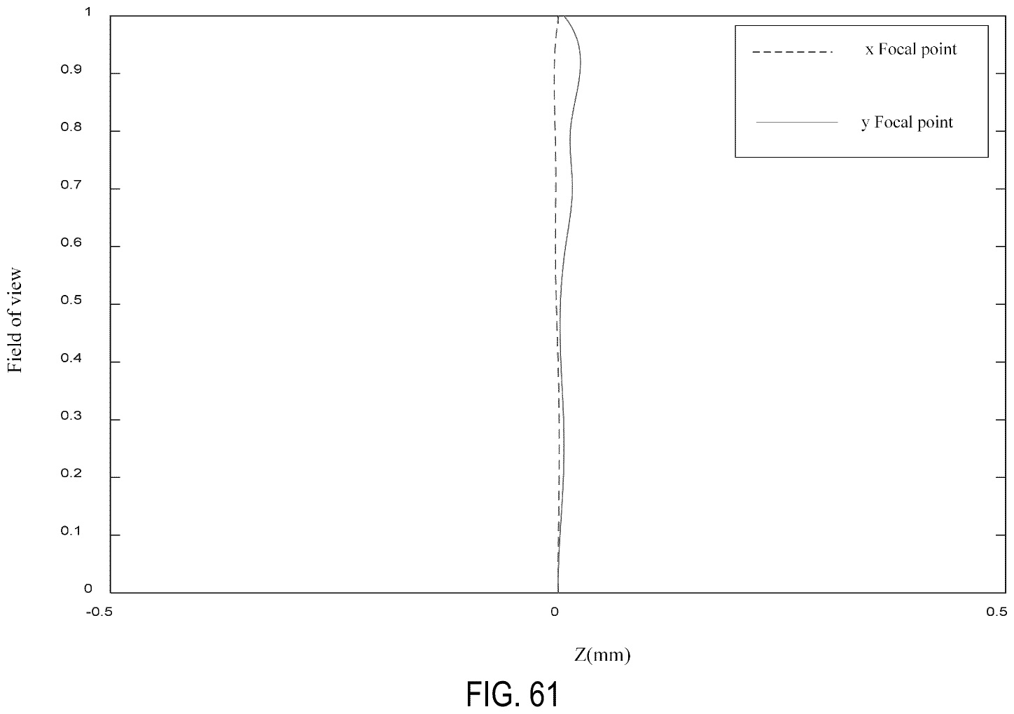

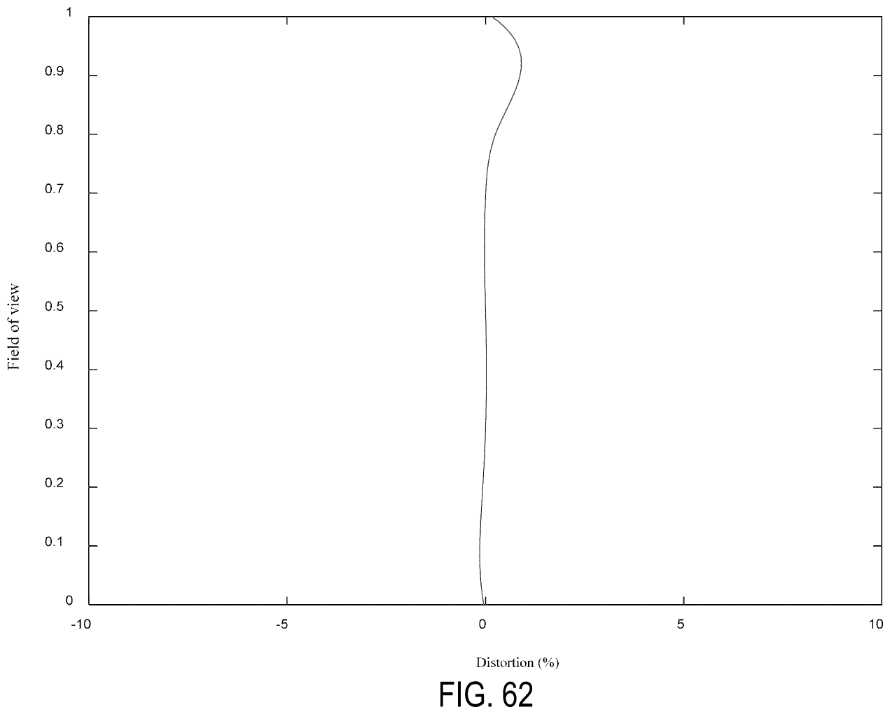

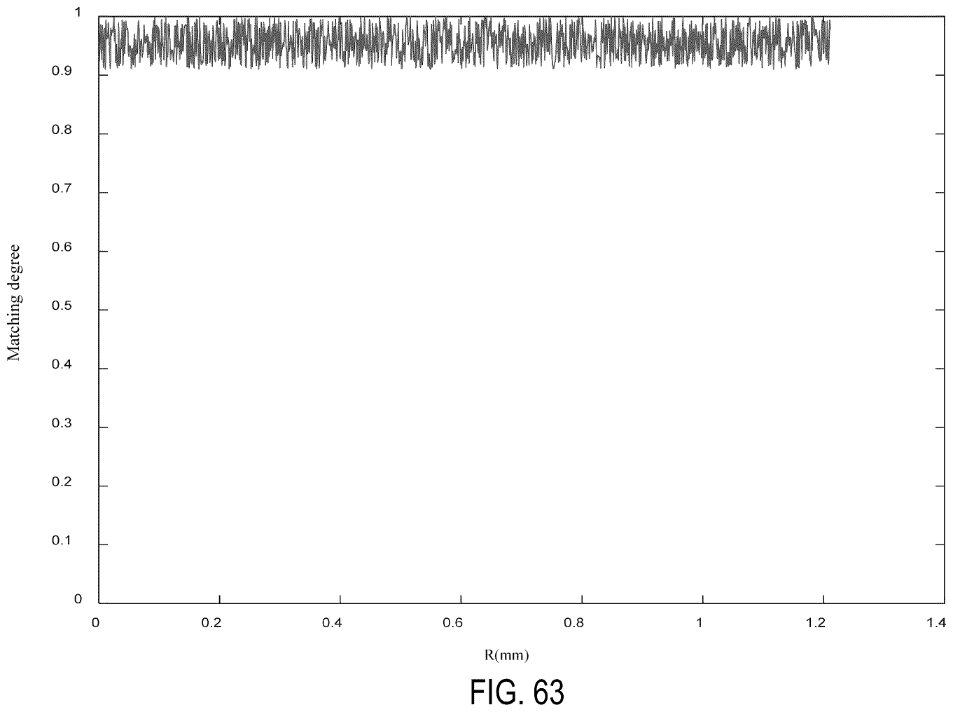

FIG. 60 shows a phase modulation diagram of the metalens in the optical system provided by embodiment 7 at the wavelengths of 486.13 nm, 587.56 nm, and 656.27 nm. It can be seen in FIG. 60 that the phases cover 0-2π of the metalens at different wavelengths. FIG. 61 shows an astigmatism diagram of the optical system. According to FIG. 61, the astigmatism of the optical system at the different fields of view from 0 to 1 is less than 0.5 mm. FIG. 62 shows a distortion diagram of the optical system. According to FIG. 62, the distortion of the optical system at the different fields of view from 0 to 1 is less than 5%. FIG. 63 shows the matching degree of the wide spectrum of the metalens in the optical system in embodiment 7. According to FIG. 63, the real phase of embodiment 7 and the theoretical phase is greater than 90%. The optical system in embodiment 7 has a high MTF and has good control of astigmatism and distortion, therefore the optical system has good imaging quality.

TABLE 7-1

| Parameter item | Parameter value | |
|---|---|---|
| Working wavelength(WL) | VIS(400-700 nm) | |
| Effective focal length(EFL) | 4.1 | mm |
| Field of view(2ω) | 74º | |
| F number | 1.8 | |
| Image height(ImgH) | 3.0896 | mm |
| Total track length(TTL) | 5.2 | mm |

TABLE 7-2

| Numbered | | Radius | Thickness | |
|---|---|---|---|---|
| surface | Surface type | (mm) | (mm) | Material |
| STO | Spherical surface | Infinite | −0.3413 | |
| L₁ₒ | Aspheric surface | 1.9036 | 0.68908 | 545000.559000 |
| L₁ᵢ | Aspheric surface | −210.3016 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 4.53744 | 0.230642 | 636000.239000 |
| L₃ᵢ | Aspheric surface | 2.12E+00 | 0.501069 | |
| L₄ₒ | Aspheric surface | 5.343861 | 0.22 | 636000.239000 |
| L₄ᵢ | Aspheric surface | 3.959183 | 0.05 | |
| L₅ₒ | Aspheric surface | −251.743 | 1.061091 | 544000.559000 |
| L₅ᵢ | Aspheric surface | −2.28126 | 0.251432 | |
| L₆ₒ | Aspheric surface | 7.867148 | 0.590268 | 544000.559000 |
| L₆ᵢ | Aspheric surface | 5.603892 | 0.734994 | |
| L₇ₒ | Aspheric surface | −2.47986 | 0.22 | 544000.559000 |
| L₇ᵢ | Aspheric surface | 8.385433 | 0.05097 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 7-3-1

| Numbered surface | L₁ₒ | L₁ᵢ | L₃ₒ | L₃ᵢ | L₄ₒ | L₄ᵢ |
|---|---|---|---|---|---|---|
| K | −0.00392 | 11808.36 | 3.476954 | 0.5119 | −0.85279 | 1.852692 |
| A | −0.00446 | −0.00246 | −0.06336 | −7.04E−02 | −1.60E−01 | −0.13092 |
| B | 0.023853 | 0.045357 | 0.098932 | 1.09E−01 | 5.71E−02 | 2.66E−02 |
| C | −0.04022 | −0.06604 | −0.09948 | −0.09483 | −0.02876 | −0.01456 |
| D | 0.03459 | 0.040405 | 0.03877 | 0.043232 | 0.004661 | 0.005645 |
| E | −1.20E−02 | −0.01019 | −0.00464 | −0.0092 | −7.19E−05 | −8.36E−05 |
| F | 1.28E−05 | −1.24E−03 | −0.00038 | 0.002212 | 0.000754 | 0.000265 |
| G | 1.37E−04 | 1.22E−04 | −4.54E−04 | −0.00042 | −0.00021 | −6.68E−05 |

TABLE 7-3-2

| Numbered surface | L₅ₒ | L₅ᵢ | L₆ₒ | L₆ᵢ | L₇ₒ | L₇ᵢ |
|---|---|---|---|---|---|---|
| K | −7.6E+14 | 0.147755 | −84.4082 | −6.06246 | −0.37376 | 2.116114 |
| A | 0.032593 | −0.02094 | −0.07605 | −0.03751 | 0.018108 | −0.02568 |
| B | −4.91E−02 | 1.05E−02 | 1.30E−03 | −0.00209 | 0.002725 | 0.00468 |
| C | 0.02735 | −0.00011 | −0.00352 | 0.0009 | −6.87E−05 | −0.0005 |
| D | −0.0058 | −0.00114 | −0.00031 | −1.30E−05 | −3.56E−05 | 2.41E−05 |
| E | 0.00045 | 5.30E−05 | 4.10E−06 | 7.72E−06 | 2.39E−06 | 6.20E−07 |
| F | −9.23E−07 | 8.39E−06 | −1.26E−06 | −4.43E−07 | 5.85E−08 | −3.68E−08 |
| G | −7.43E−06 | 3.08E−06 | 1.73E−06 | −1.94E−07 | 1.04E−09 | −5.85E−09 |

### Embodiment 8

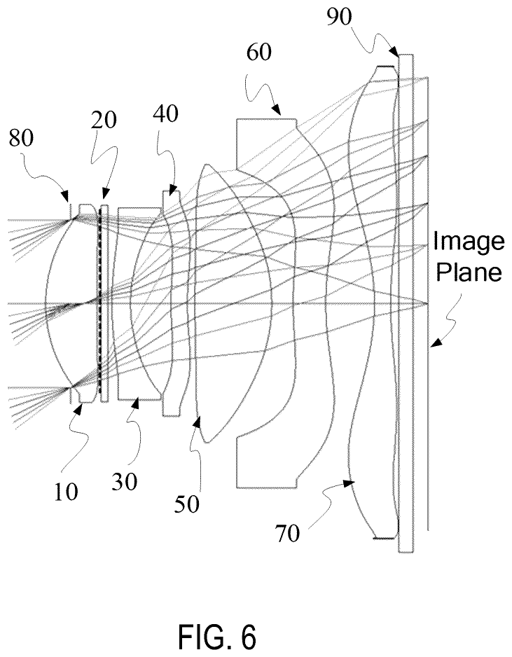

In one embodiment, embodiment 8 provides an optical system, and the optical system is shown in FIG. 6. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 8-1. The curvature, thickness, refractive index, and other parameter item of each lens in the optical system are shown in Table 8-2. The aspherical coefficients of each surface of each lens in the optical system are shown in Table 8-3-1 and Table 8-3-2, and the aspheric coefficients are shown in formula (9).

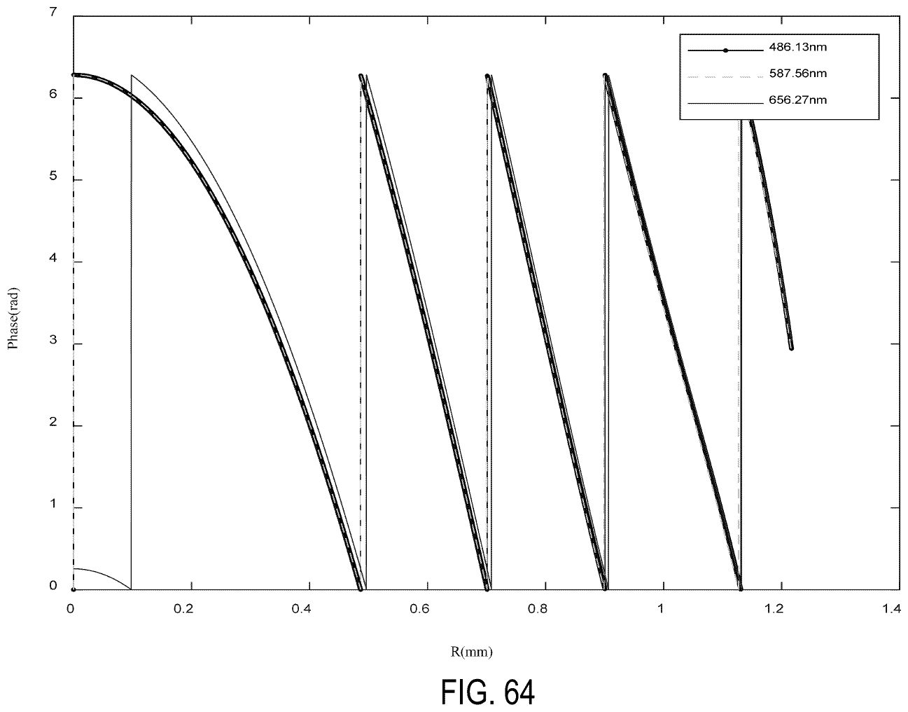

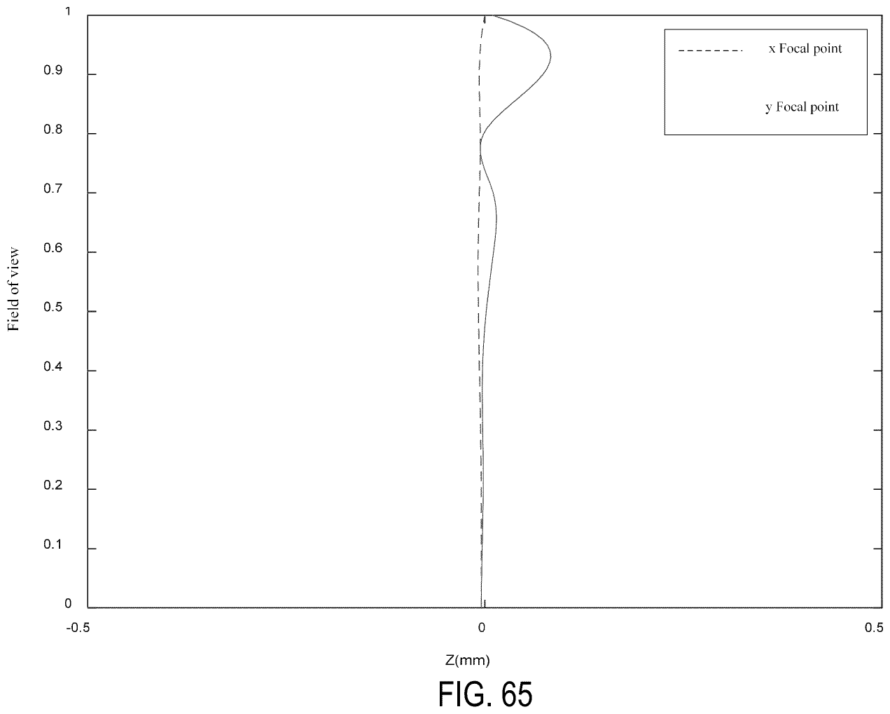

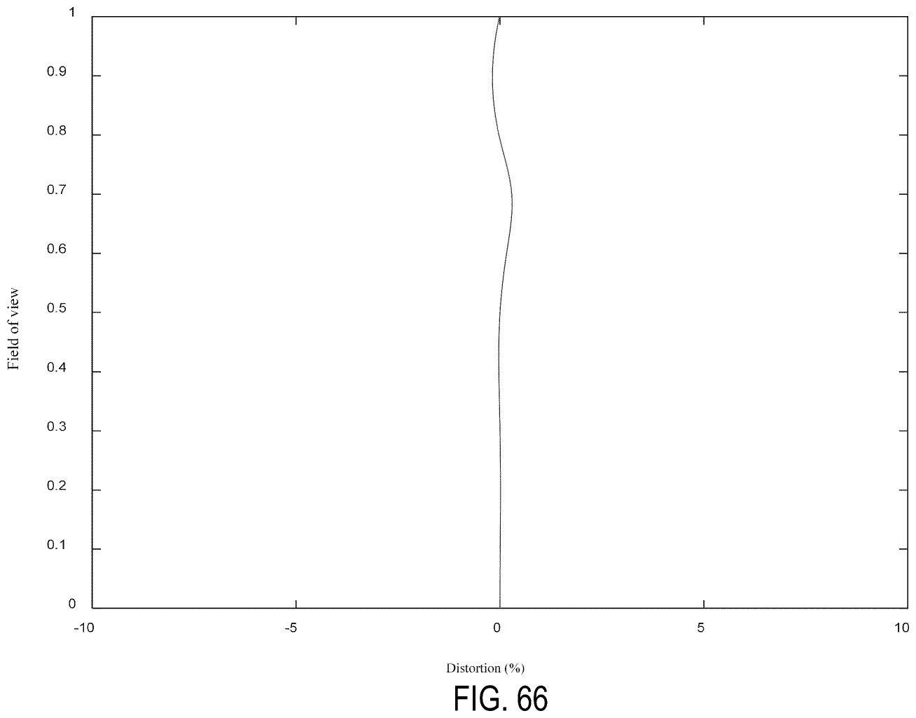

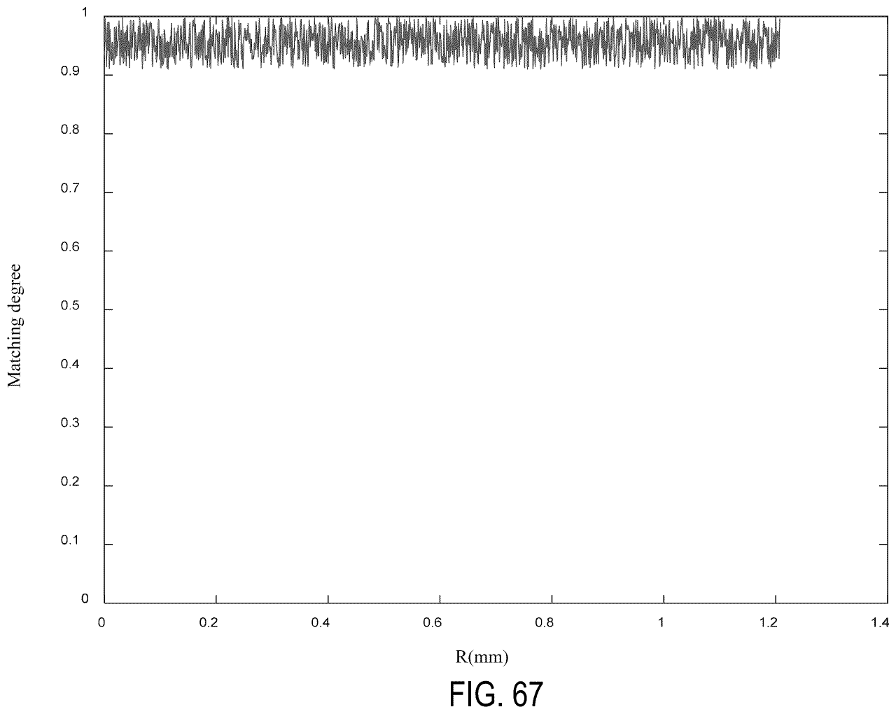

FIG. 64 shows a phase modulation diagram of the metalens in the optical system provided by embodiment 8 at the wavelengths of 486.13 nm, 587.56 nm, and 656.27 nm. It can be seen in FIG. 64 that the phases cover 0-2π of the metalens at different wavelengths. FIG. 65 shows an astigmatism diagram of the optical system. According to FIG. 65, the astigmatism of the optical system at the different fields of view from 0 to 1 is less than 0.5 mm. FIG. 66 shows a distortion diagram of the optical system. According to FIG. 66, the distortion of the optical system at the different fields of view from 0 to 1 is less than 5%. FIG. 67 shows the matching degree of the wide spectrum of the metalens in the optical system in embodiment 8. According to FIG. 67, the real phase of embodiment 8 and the theoretical phase is greater than 90%. The optical system in embodiment 8 has a high MTF and has good control of astigmatism and distortion, therefore the optical system has good imaging quality.

TABLE 8-1

| Parameter item | Parameter value | |
|---|---|---|
| Working wavelength(WL) | VIS(400-700 nm) | |
| Effective focal length(EFL) | 4.1 | mm |
| Field of view(2ω) | 74º | |
| F number | 1.8 | |
| Image height(ImgH) | 3.0896 | mm |
| Total track length(TTL) | 5.2 | mm |

TABLE 8-2

| Numbered | | Radius | Thickness | |
|---|---|---|---|---|
| surface | Surface type | (mm) | (mm) | Material |
| STO | Spherical surface | Infinite | −3.41E−01 | |
| L₁ₒ | Aspheric surface | 1.8954 | 0.701098 | 545000.559000 |
| L₁ᵢ | Aspheric surface | −220.2711 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 4.28E+00 | 2.52E−01 | 636000.239000 |
| L₃ᵢ | Aspheric surface | 1.962719 | 0.553021 | |
| L₄ₒ | Aspheric surface | 4.672389 | 0.22 | 636000.239000 |
| L₄ᵢ | Aspheric surface | 3.58903 | 1.05E−01 | |
| L₅ₒ | Aspheric surface | 38.65493 | 1.04E+00 | 544000.559000 |
| L₅ᵢ | Aspheric surface | −2.25225 | 2.90E−01 | |
| L₆ₒ | Aspheric surface | 4.912755 | 4.43E−01 | 544000.559000 |
| L₆ᵢ | Aspheric surface | 3.83E+00 | 6.62E−01 | |
| L₇ₒ | Aspheric surface | −3.09E+00 | 0.22 | 544000.559000 |
| L₇ᵢ | Aspheric surface | 5.09E+00 | 0.109163 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 8-3-1

| Numbered surface | L₁ₒ | L₁ᵢ | L₃ₒ | L₃ᵢ | L₄ₒ | L₄ᵢ |
|---|---|---|---|---|---|---|
| K | 0.022949 | −535586 | −535586 | −535586 | 1.799108 | 0.483348 |
| A | −0.00425 | −0.00122 | −0.00122 | −0.00122 | −0.16523 | −0.13901 |
| B | 0.025458 | 0.046531 | 0.046531 | 0.046531 | 0.055931 | 0.026597 |
| C | −0.04059 | −0.06696 | −6.70E−02 | −6.70E−02 | −0.02889 | −0.01579 |
| D | 0.034547 | 0.040204 | 4.02E−02 | 4.02E−02 | 4.17E−03 | 5.27E−03 |
| E | −0.01183 | −0.01006 | −0.01006 | −0.01006 | 4.39E−05 | −0.00015 |
| F | 0.000106 | −0.00113 | −0.00113 | −0.00113 | 0.001163 | 0.000295 |
| G | 0.000156 | 0.000166 | 0.000166 | 1.66E−04 | −8.26E−05 | −3.86E−07 |

TABLE 8-3-2

| Numbered surface | L₅ₒ | L₅ᵢ | L₆ₒ | L₆ᵢ | L₇ₒ | L₇ᵢ |
|---|---|---|---|---|---|---|
| K | −6897.53 | 0.027412 | 1.569305 | 0.21336 | −0.11565 | 0.125847 |
| A | 0.035981 | −0.00551 | −0.08328 | −0.03678 | 0.018729 | −0.03952 |
| B | −0.05111 | 0.011401 | 0.006164 | −0.00282 | 0.001362 | 0.005837 |
| C | 0.027 | 1.68E−05 | −0.00282 | 0.000576 | 1.70E−05 | −0.00047 |
| D | −5.83E−03 | −9.66E−04 | −0.0005 | −5.59E−05 | −3.18E−05 | 2.21E−05 |
| E | 0.00046 | 9.49E−05 | 6.21E−05 | 5.16E−06 | 2.25E−06 | 4.68E−07 |
| F | 9.99E−06 | 1.12E−05 | 2.22E−05 | −5.67E−09 | 6.65E−09 | −1.85E−08 |
| G | −1.90E−06 | 6.54E−07 | −6.21E−06 | 1.12E−08 | 5.10E−11 | −6.79E−09 |

### Embodiment 9

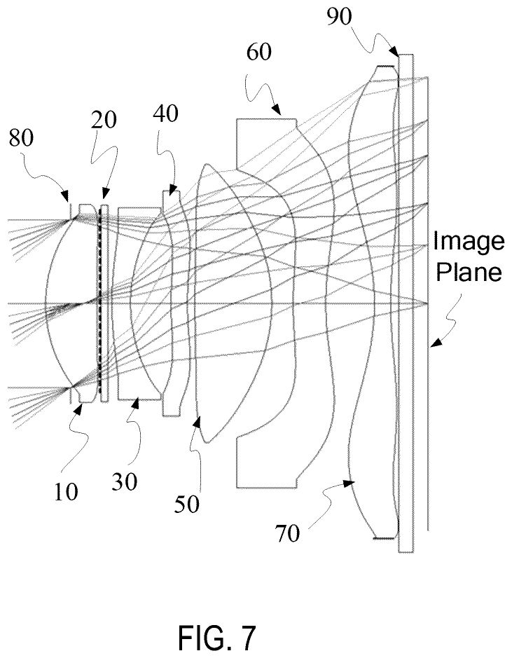

In one embodiment, embodiment 9 provides an optical system, and the optical system is shown in FIG. 7. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 9-1. The curvature, thickness, refractive index, and other parameter item of each lens in the optical system are shown in Table 9-2. The aspherical coefficients of each surface of each lens in the optical system are shown in Table 9-3-1 and Table 9-3-2, and the aspheric coefficients are shown in formula (9).

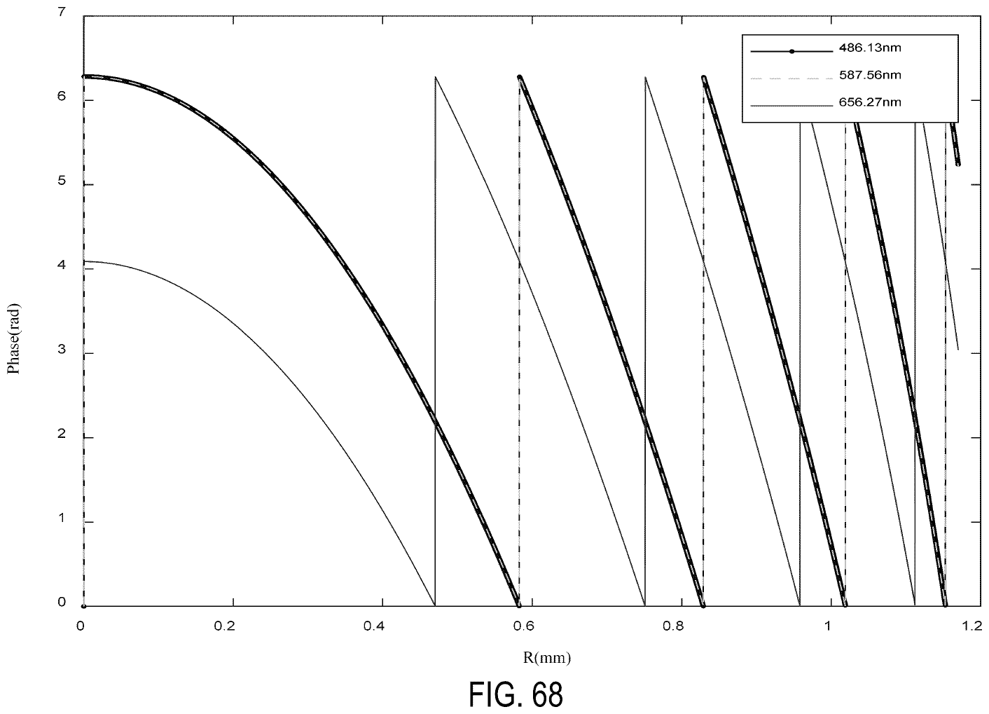

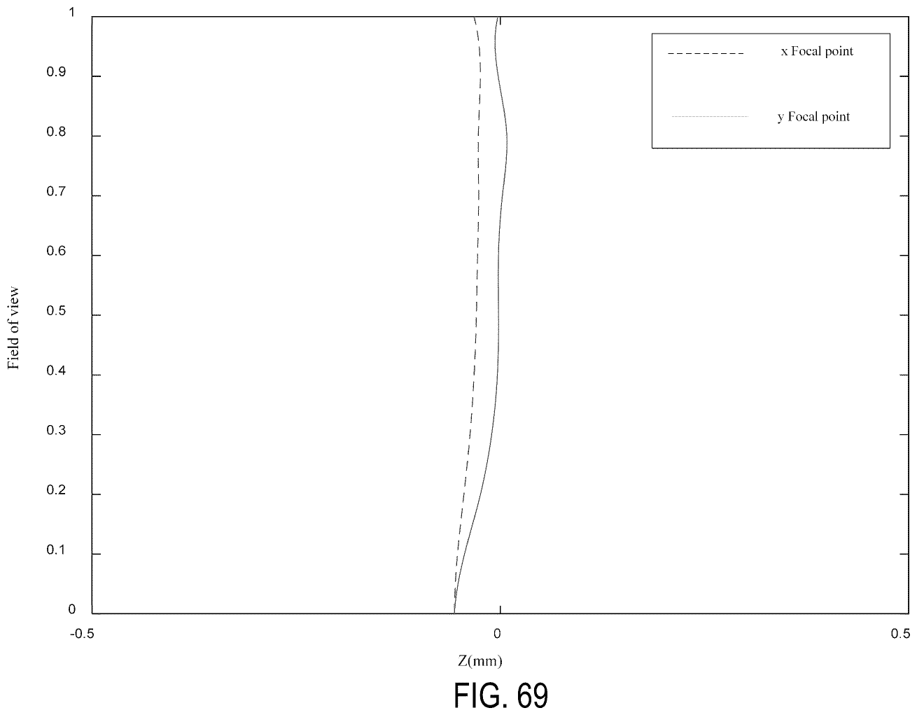

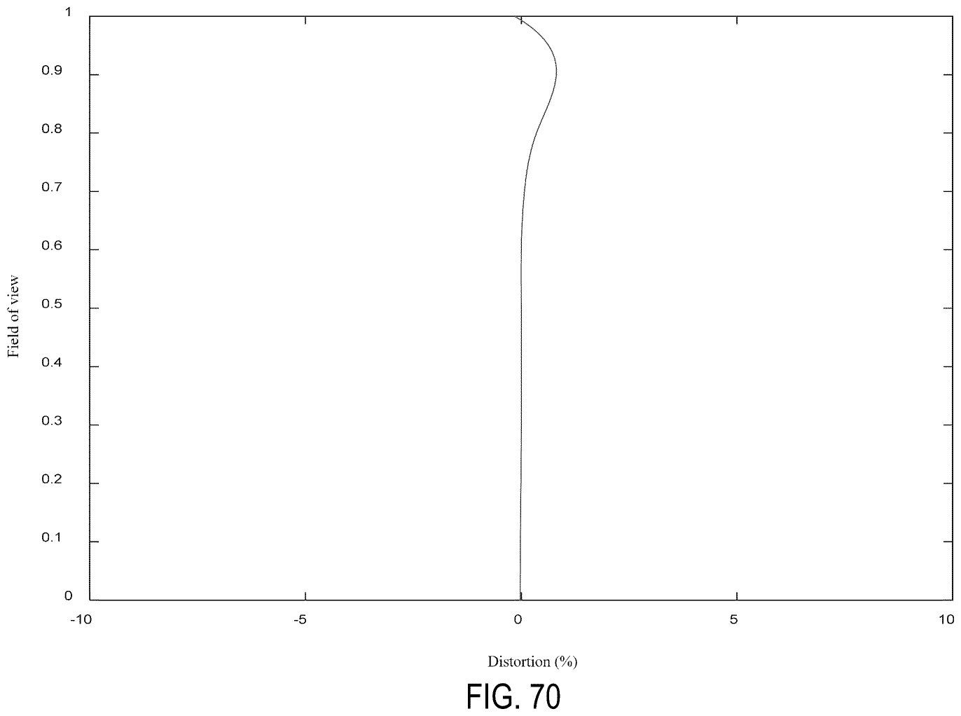

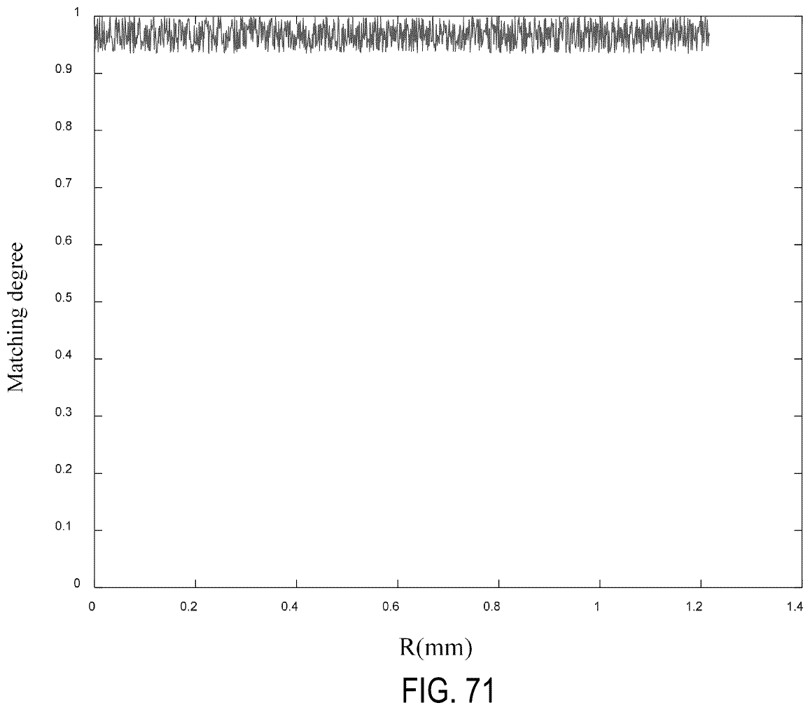

FIG. 68 shows a phase modulation diagram of the metalens in the optical system provided by embodiment 9 at the wavelengths of 486.13 nm, 587.56 nm, and 656.27 nm. It can be seen in FIG. 68 that the phases cover 0-2π of the metalens at different wavelengths. FIG. 69 shows an astigmatism diagram of the optical system. According to FIG. 69, the astigmatism of the optical system at the different fields of view from 0 to 1 is less than 0.5 mm. FIG. 70 shows a distortion diagram of the optical system. According to FIG. 70, the distortion of the optical system at the different fields of view from 0 to 1 is less than 5%. FIG. 71 shows the matching degree of the wide spectrum of the metalens in the optical system in embodiment 9. According to FIG. 71, the real phase of embodiment 9 and the theoretical phase is greater than 90%. The optical system in embodiment 9 has a high MTF and has good control of astigmatism and distortion, therefore the optical system has good imaging quality.

TABLE 9-1

| Parameter item | Parameter value | |
|---|---|---|
| Working wavelength(WL) | VIS(400-700 nm) | |
| Effective focal length(EFL) | 4.1 | mm |
| Field of view(2ω) | 74º | |
| F number | 1.8 | |
| Image height(ImgH) | 3.0896 | mm |
| Total track length(TTL) | 5.4 | mm |

TABLE 9-2

| Numbered | | Radius | Thickness | |
|---|---|---|---|---|
| surface | Surface type | (mm) | (mm) | Material |
| STO | Spherical surface | Infinite | −0.3413 | |
| L₁ₒ | Aspheric surface | 2.0523 | 5.57E−01 | 545000.559000 |
| L₁ᵢ | Aspheric surface | −132.9296 | 0.061692 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 3.31E+00 | 0.232736 | 636000.239000 |
| L₃ᵢ | Aspheric surface | 1.92E+00 | 0.636899 | |
| L₄ₒ | Aspheric surface | 44.77987 | 0.2 | 636000.239000 |
| L₄ᵢ | Aspheric surface | 8.367414 | 0.05 | |
| L₅ₒ | Aspheric surface | 49.62419 | 0.950859 | 544000.559000 |
| L₅ᵢ | Aspheric surface | −2.76024 | 0.462099 | |
| L₆ₒ | Aspheric surface | 5.226672 | 0.773255 | 544000.559000 |
| L₆ᵢ | Aspheric surface | 7.823894 | 0.678946 | |
| L₇ₒ | Aspheric surface | −1.72721 | 0.2 | 544000.559000 |
| L₇ᵢ | Aspheric surface | 316.6393 | 0.046206 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 9-3-1

| Numbered surface | L₁ₒ | L₁ᵢ | L₃ₒ | L₃ᵢ | L₄ₒ | L₄ᵢ |
|---|---|---|---|---|---|---|
| K | 0.13875 | −2.3E+08 | −8.03205 | −0.39389 | 1384.777 | 9.713263 |
| A | −0.00309 | −0.01305 | −0.08037 | −0.11089 | −0.15699 | −0.12212 |
| B | 0.015529 | 0.045518 | 0.107975 | 0.110846 | 0.023142 | 0.011824 |
| C | −0.03042 | −0.05462 | −0.08934 | −0.09057 | −0.03206 | −0.01001 |
| D | 0.032218 | 0.038987 | 0.042135 | 4.28E−02 | 6.25E−03 | 0.008027 |
| E | −0.01432 | −0.01239 | −0.00754 | −1.08E−02 | 9.55E−04 | −3.01E−04 |
| F | 0.000313 | −0.00124 | −0.00196 | 0.000799 | −0.00119 | 1.88E−04 |
| G | 0.001262 | 0.001622 | 0.001162 | −0.00061 | −0.00045 | 6.34E−05 |

TABLE 9-3-2

| Numbered surface | L₅ₒ | L₅ᵢ | L₆ₒ | L₆ᵢ | L₇ₒ | L₇ᵢ |
|---|---|---|---|---|---|---|
| K | −9.79E+03 | 1.95E−01 | −1.16E+01 | 8.60E+00 | −8.89E−01 | −3.10E+17 |
| A | 0.017467 | −0.0381 | −0.06073 | −0.03068 | 0.034811 | −0.00811 |
| B | −0.03775 | 0.011206 | −0.00257 | −0.00525 | 0.001021 | 0.002732 |
| C | 0.025806 | −0.00084 | −0.00051 | 0.001011 | −9.50E−05 | −0.0003 |
| D | −0.00653 | −0.0006 | −6.44E−04 | −9.27E−06 | −3.38E−05 | −2.87E−06 |
| E | 4.45E−04 | 1.43E−05 | −3.71E−05 | 5.57E−06 | 3.07E−06 | 1.77E−06 |
| F | 9.81E−05 | −3.44E−05 | 1.96E−05 | −5.39E−07 | 7.44E−08 | 1.40E−07 |
| G | −1.06E−05 | 4.06E−05 | 6.35E−06 | −1.57E−07 | −1.02E−08 | −1.80E−08 |

### Embodiment 10

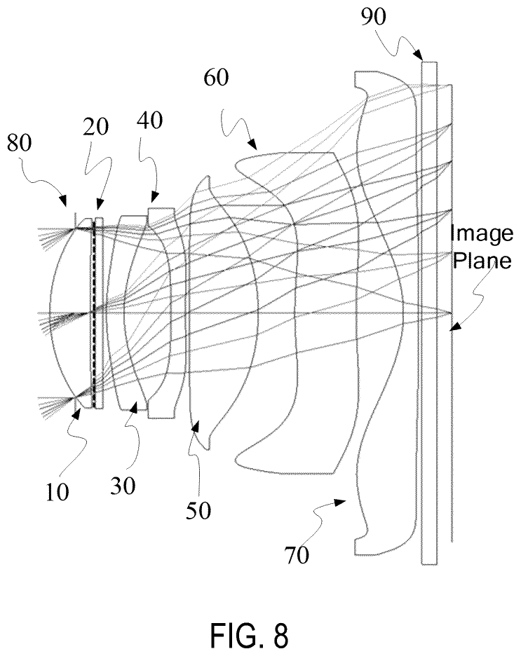

In one embodiment, embodiment 10 provides an optical system, and the optical system is shown in FIG. 8. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 10-1. The curvature, thickness, refractive index, and other parameter item of each lens in the optical system are shown in Table 10-2. The aspherical coefficients of each surface of each lens in the optical system are shown in Table 10-3-1 and Table 10-3-2, and the aspheric coefficients are shown in formula (9).

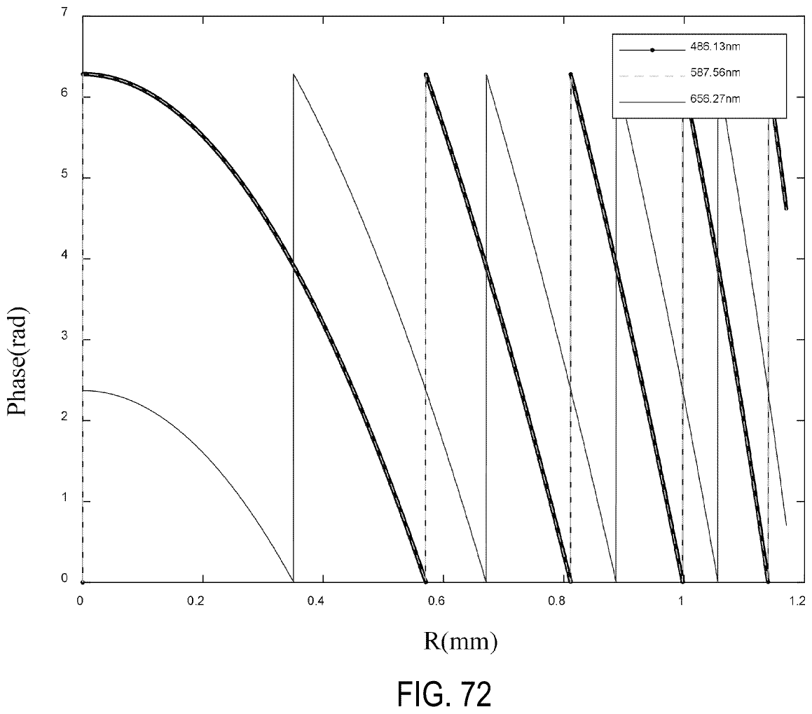

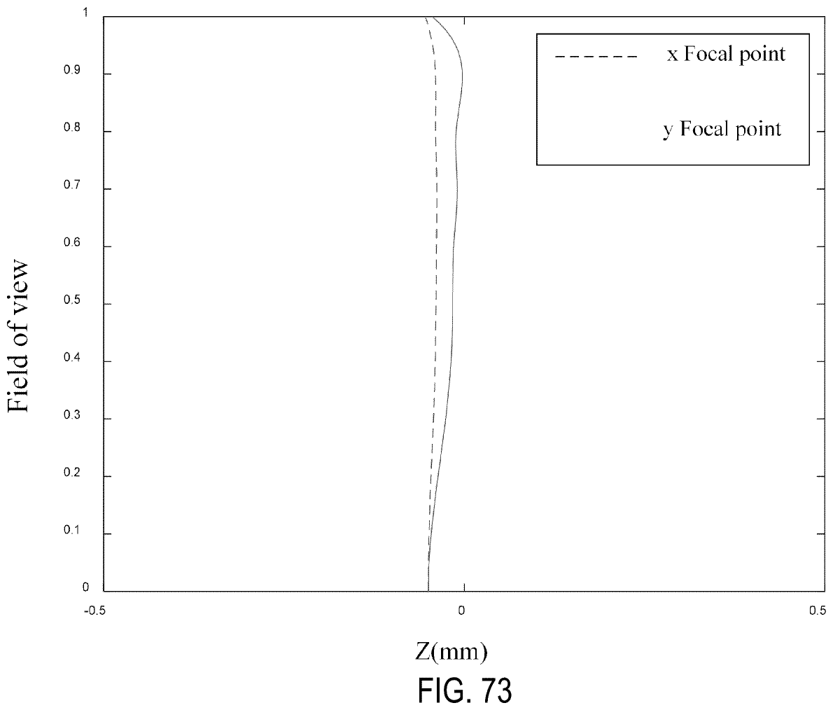

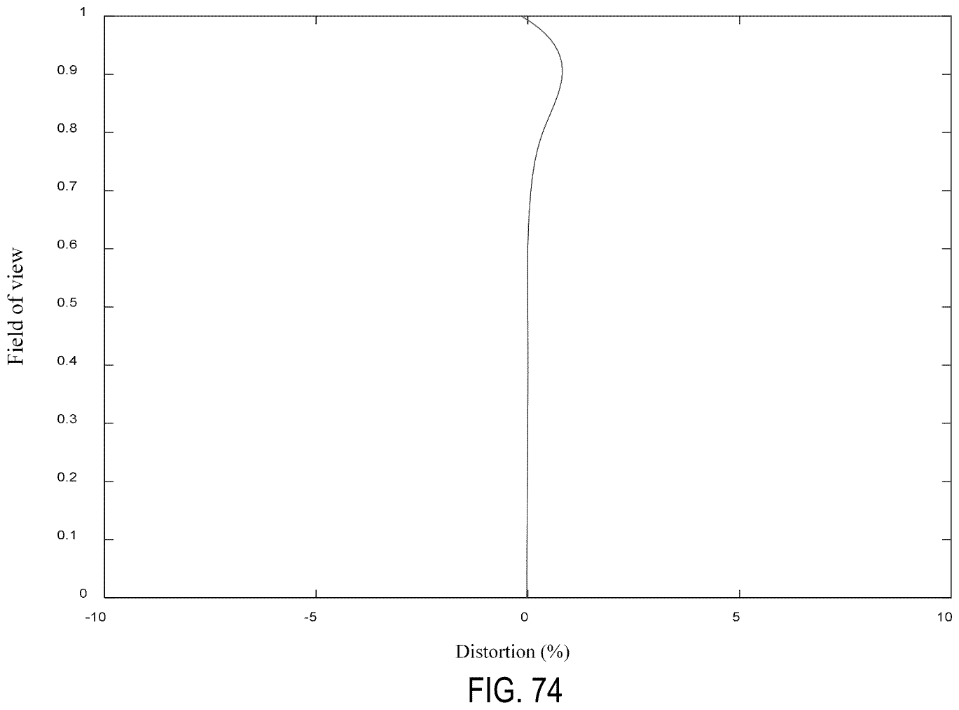

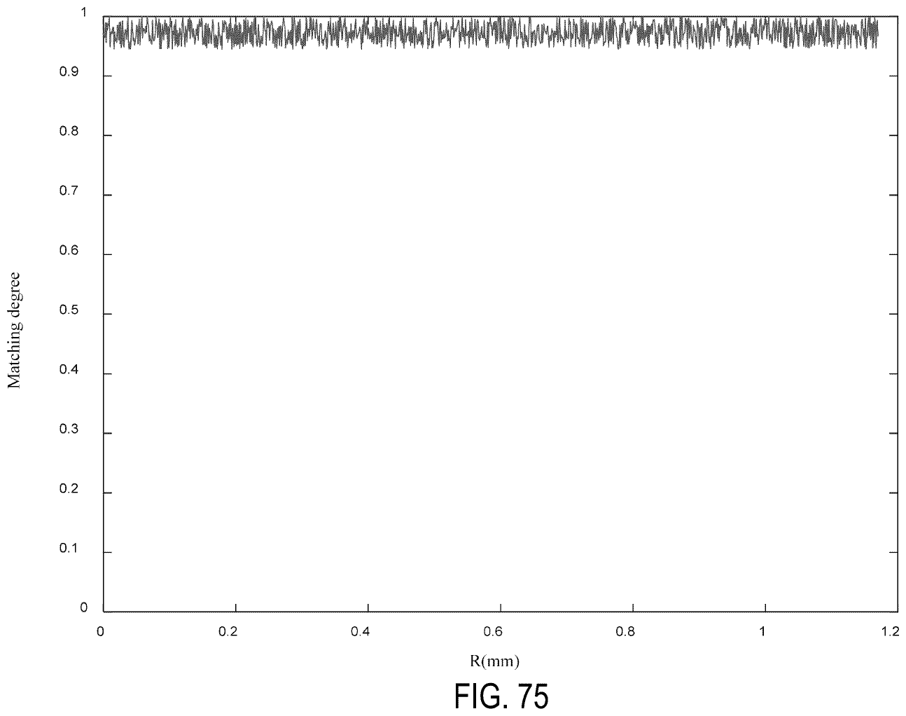

FIG. 72 shows a phase modulation diagram of the metalens in the optical system provided by embodiment 10 at the wavelengths of 486.13 nm, 587.56 nm, and 656.27 nm. It can be seen in FIG. 72 that the phases cover 0-2π of the metalens at different wavelengths. FIG. 73 shows an astigmatism diagram of the optical system. According to FIG. 73, the astigmatism of the optical system at the different fields of view from 0 to 1 is less than 0.5 mm. FIG. 74 shows a distortion diagram of the optical system. According to FIG. 74, the distortion of the optical system at the different fields of view from 0 to 1 is less than 5%. FIG. 75 shows the matching degree of the wide spectrum of the metalens in the optical system in embodiment 10. According to FIG. 75, the real phase of embodiment 10 and the theoretical phase is greater than 90%. The optical system in embodiment 10 has a high MTF and has good control of astigmatism and distortion, therefore the optical system has good imaging quality.

TABLE 10-1

| Parameter item | Parameter value | |
|---|---|---|
| Working wavelength(WL) | VIS(400-700 nm) | |
| Effective focal length(EFL) | 4.1 | mm |
| Field of view(2ω) | 74º | |
| F number | 1.8 | |
| Image height(ImgH) | 3.0896 | mm |
| Total track length(TTL) | 5.4 | mm |

TABLE 10-2

| Numbered | | Radius | Thickness | |
|---|---|---|---|---|
| surface | Surface type | (mm) | (mm) | Material |
| STO | Spherical surface | Infinite | −3.41E−01 | |
| L₁ₒ | Aspheric surface | 2.0695 | 5.49E−01 | 545000.559000 |
| L₁ᵢ | Aspheric surface | −145.9231 | 0.062305 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 3.0743 | 0.234873 | 636000.239000 |
| L₃ᵢ | Aspheric surface | 1.836908 | 0.625871 | |
| L₄ₒ | Aspheric surface | 43.7324 | 2.00E−01 | 636000.239000 |
| L₄ᵢ | Aspheric surface | 8.225134 | 5.00E−02 | |
| L₅ₒ | Aspheric surface | 38.3566 | 0.927383 | 544000.559000 |
| L₅ᵢ | Aspheric surface | −2.83558 | 0.491823 | |
| L₆ₒ | Aspheric surface | 5.0617 | 0.824406 | 544000.559000 |
| L₆ᵢ | Aspheric surface | 7.9319 | 0.633825 | |
| L₇ₒ | Aspheric surface | −1.7481 | 0.2 | 544000.559000 |
| L₇ᵢ | Aspheric surface | 609.7122 | 0.05 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 10-3-1

| Numbered surface | L₁ₒ | L₁ᵢ | L₃ₒ | L₃ᵢ | L₄ₒ | L₄ᵢ |
|---|---|---|---|---|---|---|
| K | 0.141607 | −9.3E+07 | −6.31063 | −0.40645 | 1313.234 | 13.52144 |
| A | −0.0034 | −0.01188 | −0.07903 | −1.11E−01 | −1.56E−01 | −0.12266 |
| B | 0.016345 | 0.046405 | 0.107482 | 1.11E−01 | 2.40E−02 | 1.16E−02 |
| C | −0.03112 | −0.05579 | −0.08976 | −0.09091 | −0.03154 | −1.01E−02 |
| D | 0.032541 | 0.039136 | 0.041936 | 0.042971 | 0.0066 | 7.92E−03 |
| E | −1.42E−02 | −0.01207 | −0.00733 | −0.0107 | 7.67E−04 | −1.68E−04 |
| F | 2.58E−04 | −1.18E−03 | −0.00182 | 0.000751 | −0.00105 | 0.000243 |
| G | −0.204236 | 2.69E−09 | −2.83E−07 | 2.69E−09 | 0.1440297 | 0.2628043 |

TABLE 10-3-2

| Numbered surface | L₅ₒ | L₅ᵢ | L₆ₒ | L₆ᵢ | L₇ₒ | L₇ᵢ |
|---|---|---|---|---|---|---|
| K | −5303.59 | 0.255516 | −4.22119 | 8.537085 | −6.79E−01 | −3.10E+17 |
| A | 0.018715 | −0.03929 | −6.67E−02 | −2.99E−02 | 3.91E−02 | −8.23E−03 |
| B | −3.85E−02 | 1.20E−02 | −2.78E−04 | −4.59E−03 | 1.56E−03 | 2.91E−03 |
| C | 2.59E−02 | −7.79E−04 | −6.08E−04 | 1.01E−03 | −6.38E−05 | −3.52E−04 |
| D | −6.50E−03 | −6.86E−04 | −7.03E−04 | −1.94E−05 | −3.62E−05 | 2.36E−07 |
| E | 4.40E−04 | 5.51E−06 | −4.65E−05 | 4.00E−06 | 2.55E−06 | 2.01E−06 |
| F | 9.42E−05 | −2.79E−05 | 2.99E−05 | −5.39E−07 | 1.15E−07 | 1.25E−07 |
| G | −9.84E−06 | 4.19E−05 | 7.69E−06 | −9.44E−08 | 4.22E−10 | −2.14E−08 |

### Embodiment 11

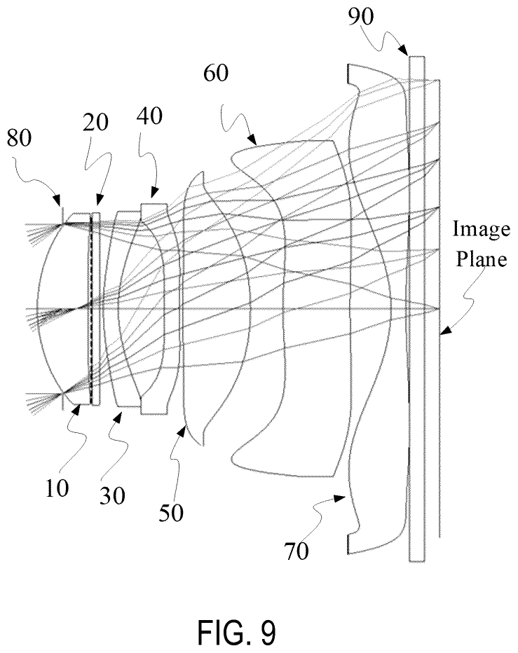

In one embodiment, embodiment 11 provides an optical system, and the optical system is shown in FIG. 9. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 11-1. The curvature, thickness, refractive index, and other parameter item of each lens in the optical system are shown in Table 11-2. The aspherical coefficients of each surface of each lens in the optical system are shown in Table 11-3-1 and Table 11-3-2, and the aspheric coefficients are shown in formula (9).

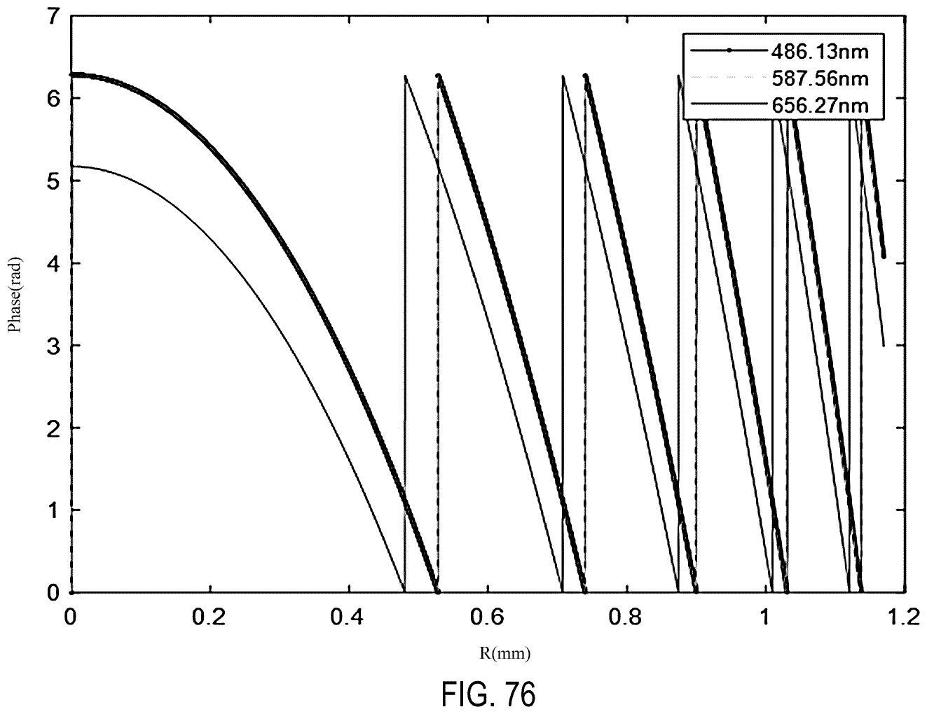

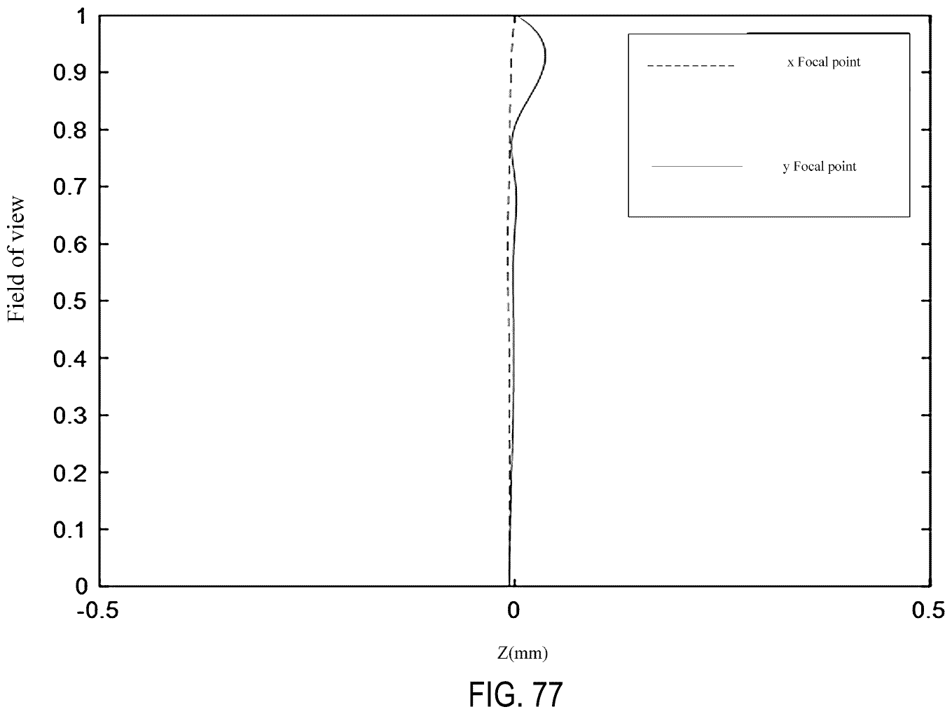

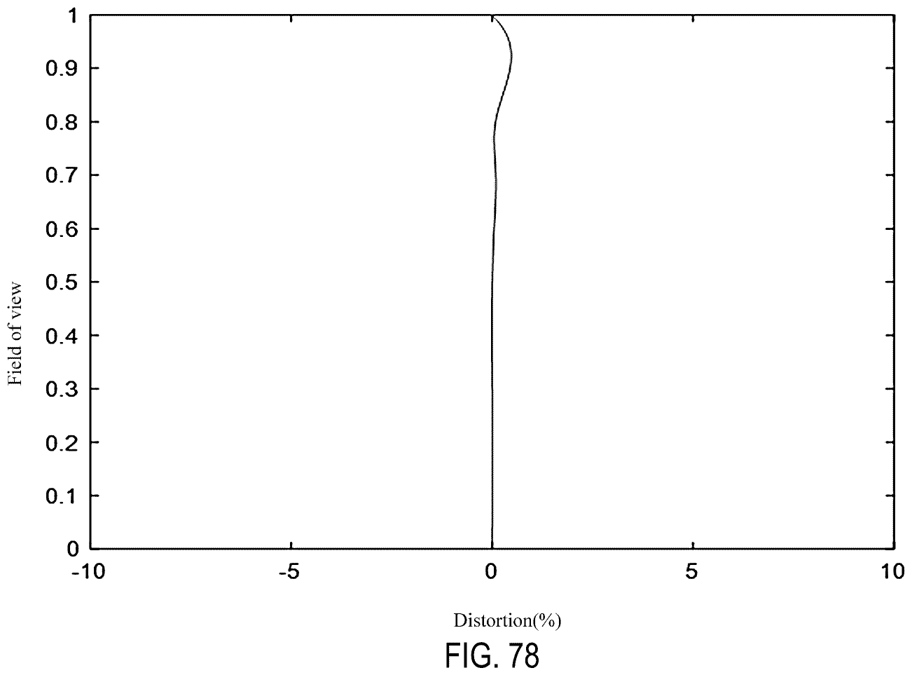

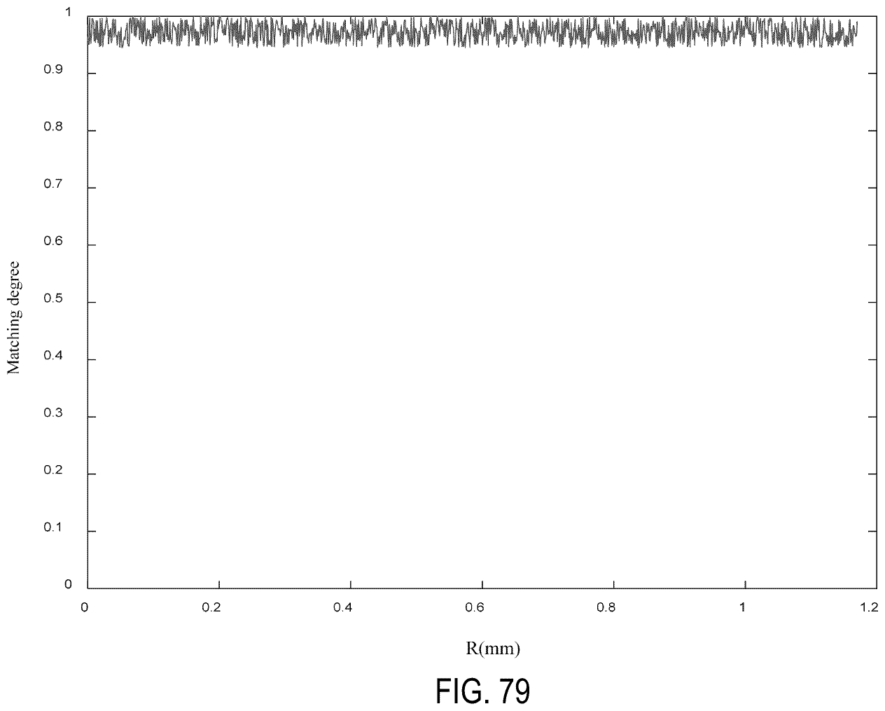

FIG. 76 shows a phase modulation diagram of the metalens in the optical system provided by embodiment 11 at the wavelengths of 486.13 nm, 587.56 nm, and 656.27 nm. It can be seen in FIG. 76 that the phases cover 0-2π of the metalens at different wavelengths. FIG. 77 shows an astigmatism diagram of the optical system. According to FIG. 77, the astigmatism of the optical system at the different fields of view from 0 to 1 is less than 0.5 mm. FIG. 78 shows a distortion diagram of the optical system. According to FIG. 78, the distortion of the optical system at the different fields of view from 0 to 1 is less than 5%. FIG. 79 shows the matching degree of the wide spectrum of the metalens in the optical system in embodiment 11. According to FIG. 79, the real phase of embodiment 11 and the theoretical phase is greater than 90%. The optical system in embodiment 11 has a high MTF and has good control of astigmatism and distortion, therefore the optical system has good imaging quality.

TABLE 11-1

| Parameter item | Parameter value | |
|---|---|---|
| Working wavelength(WL) | VIS(400-700 nm) | |
| Effective focal length(EFL) | 4.1 | mm |
| Field of view(2ω) | 74º | |
| F number | 1.8 | |
| Image height(ImgH) | 3.0896 | mm |
| Total track length(TTL) | 5.4 | mm |

TABLE 11-2

| Numbered | | Radius | Thickness | |
|---|---|---|---|---|
| surface | Surface type | (mm) | (mm) | Material |
| STO | Spherical surface | Infinite | −3.41E−01 | |
| L₁ₒ | Aspheric surface | 2.06 | 6.86E−01 | 545000.559000 |
| L₁ᵢ | Aspheric surface | −92.22 | 5.00E−02 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 3.132673 | 0.200482 | 636000.239000 |
| L₃ᵢ | Aspheric surface | 1.852694 | 0.619744 | |
| L₄ₒ | Aspheric surface | 4.14E+01 | 0.2 | 636000.239000 |
| L₄ᵢ | Aspheric surface | 8.2638 | 0.05 | |
| L₅ₒ | Aspheric surface | 37.74708 | 0.906527 | 544000.559000 |
| L₅ᵢ | Aspheric surface | −2.8231 | 0.437472 | |
| L₆ₒ | Aspheric surface | 6.104617 | 0.898408 | 544000.559000 |
| L₆ᵢ | Aspheric surface | 16.01895 | 0.551306 | |
| L₇ₒ | Aspheric surface | −1.98458 | 0.2 | 544000.559000 |
| L₇ᵢ | Aspheric surface | 9.883158 | 0.05 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 11-3-1

| Numbered surface | L₁ₒ | L₁ᵢ | L₃ₒ | L₃ᵢ | L₄ₒ | L₄ᵢ |
|---|---|---|---|---|---|---|
| K | 0.142972 | −119111 | −3.41757 | −4.52E−01 | 1.16E+03 | 4.16E+00 |
| A | −2.17E−03 | −0.00318 | −0.08183 | −0.11069 | −0.16265 | −1.28E−01 |
| B | 1.64E−02 | 4.52E−02 | 0.10393 | 0.112432 | 2.49E−02 | 1.27E−02 |
| C | −3.18E−02 | −0.05892 | −8.94E−02 | −9.41E−02 | −3.06E−02 | −1.04E−02 |
| D | 0.033004 | 4.01E−02 | 4.19E−02 | 4.39E−02 | 6.26E−03 | 7.98E−03 |
| E | −0.01396 | −0.01104 | −7.12E−03 | −1.00E−02 | 4.56E−04 | 6.06E−05 |
| F | 2.58E−04 | −9.95E−04 | −1.60E−03 | 5.55E−04 | −8.08E−04 | 2.94E−04 |
| G | 1.05E−03 | 9.51E−04 | 8.23E−04 | −5.26E−04 | 3.47E−05 | −1.39E−08 |

TABLE 11-3-2

| Numbered surface | L₅ₒ | L₅ᵢ | L₆ₒ | L₆ᵢ | L₇ₒ | L₇ᵢ |
|---|---|---|---|---|---|---|
| K | −5.18E+03 | 1.97E−01 | −1.04E+01 | −1.30E+00 | −5.81E−01 | −6.95E+01 |
| A | 1.91E−02 | −3.69E−02 | −5.42E−02 | −5.86E−03 | 3.25E−02 | −0.01222 |
| B | −4.03E−02 | 1.19E−02 | 1.09E−03 | −5.86E−03 | 1.49E−03 | 0.002776 |
| C | 2.60E−02 | −8.85E−04 | −0.00151 | 0.000983 | −6.59E−09 | −0.00042 |
| D | −6.36E−03 | −8.86E−04 | −0.00049 | −3.86E−05 | −3.30E−05 | 2.12E−05 |
| E | 0.000453 | 2.70E−05 | 3.50E−05 | 2.96E−06 | 1.82E−06 | 1.36E−06 |
| F | 9.06E−05 | −8.02E−06 | 3.20E−05 | −3.57E−07 | 2.57E−08 | 8.14E−08 |
| G | −9.55E−06 | 4.34E−05 | 8.00E−07 | −1.13E−08 | 1.03E−08 | −2.13E−08 |

### Embodiment 12

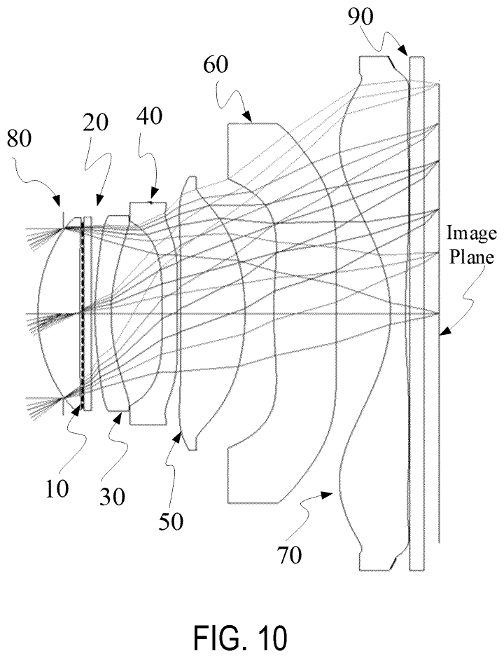

In one embodiment, embodiment 12 provides an optical system, and the optical system is shown in FIG. 10. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 12-1. The curvature, thickness, refractive index, and other parameter item of each lens in the optical system are shown in Table 12-2. The aspherical coefficients of each surface of each lens in the optical system are shown in Table 12-3-1 and Table 12-3-2, and the aspheric coefficients are shown in formula (9).

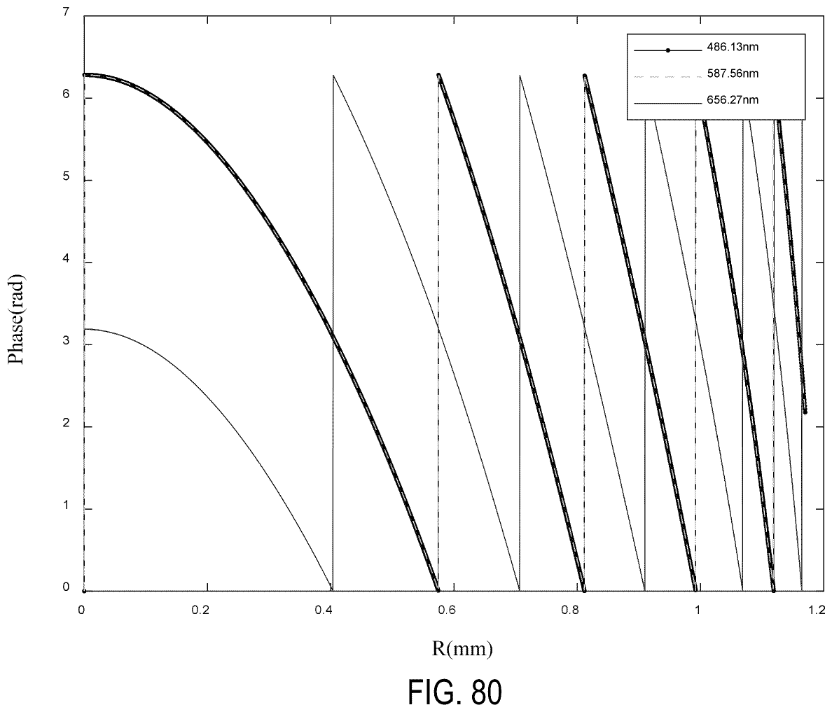

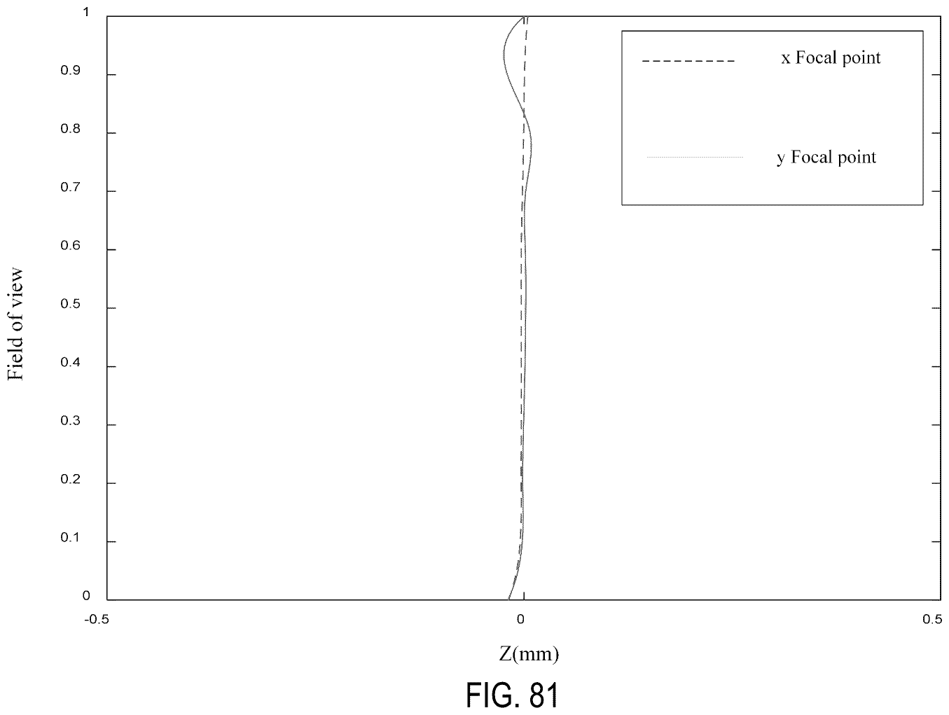

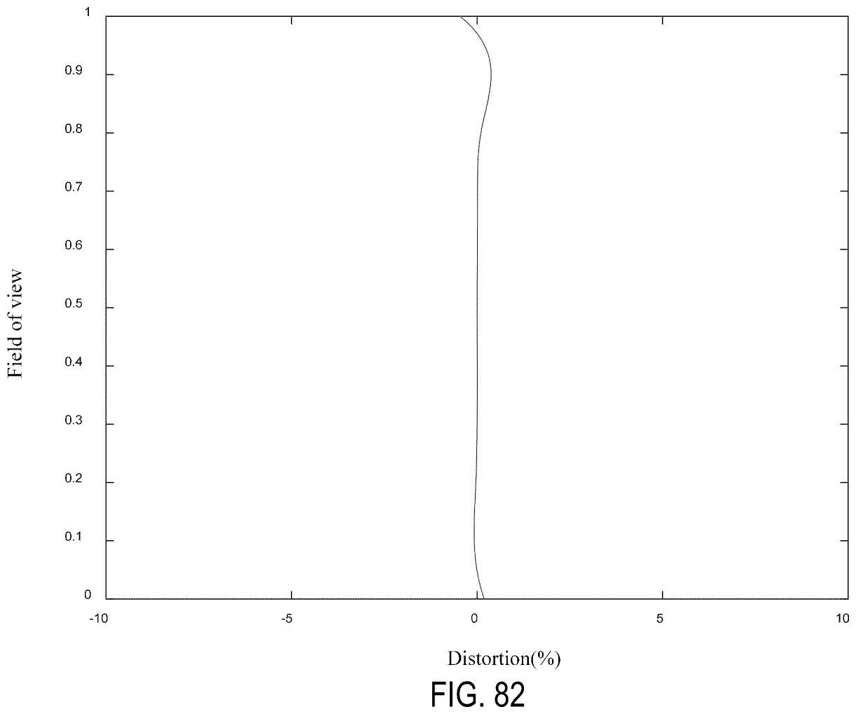

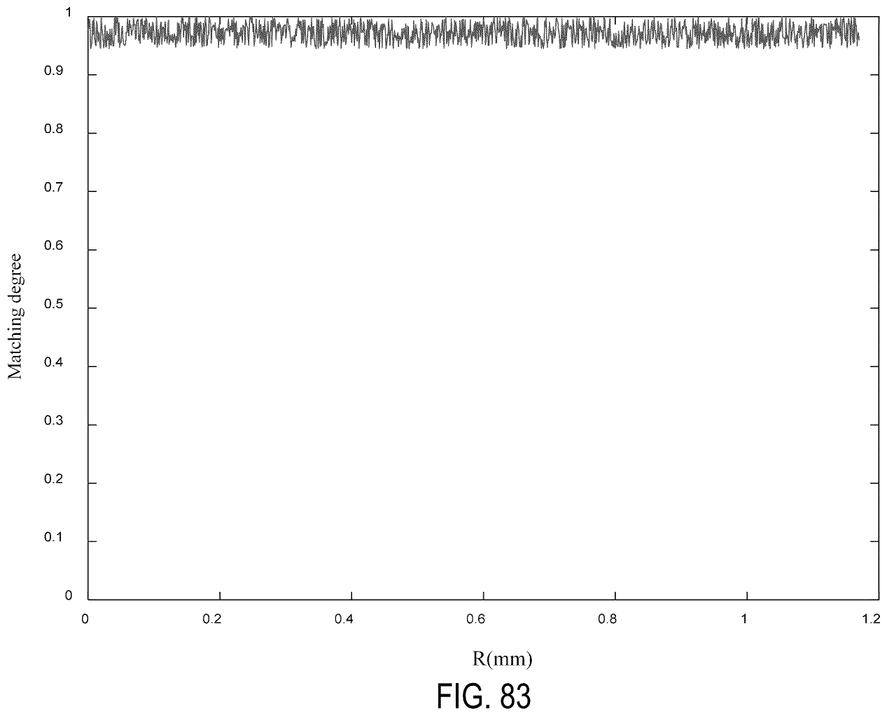

FIG. 80 shows a phase modulation diagram of the metalens in the optical system provided by embodiment 12 at the wavelengths of 486.13 nm, 587.56 nm, and 656.27 nm. It can be seen in FIG. 80 that the phases cover 0-2π of the metalens at different wavelengths. FIG. 81 shows an astigmatism diagram of the optical system. According to FIG. 81, the astigmatism of the optical system at the different fields of view from 0 to 1 is less than 0.5 mm. FIG. 82 shows a distortion diagram of the optical system. According to FIG. 82, the distortion of the optical system at the different fields of view from 0 to 1 is less than 5%. FIG. 83 shows the matching degree of the wide spectrum of the metalens in the optical system in embodiment 12. According to FIG. 83, the real phase of embodiment 12 and the theoretical phase is greater than 90%. The optical system in embodiment 12 has a high MTF and has good control of astigmatism and distortion, therefore the optical system has good imaging quality.

TABLE 12-1

| Parameter item | Parameter value |
|---|---|
| Working wavelength(WL) | VIS(400-700 nm) |
| Effective focal length(EFL) | 4.1 mm |
| Field of view(2ω) | 74° |
| F number | 1.8 |
| Image height(ImgH) | 3.0896 mm |
| Total track length(TTL) | 5.4 mm |

TABLE 12-2

| Numbered | | Radius | Thickness | |
|---|---|---|---|---|
| surface | Surface type | (mm) | (mm) | Material |
| L₁ₒ | Spherical surface | Infinite | −0.3413 | |
| L₁ᵢ | Aspheric surface | 2.0134 | 0.569862 | 545000.559000 |
| L₂ₒ | Aspheric surface | −123.23 | 0.05 | |
| L₂ᵢ | Structural surface (metalens) | Infinite | 0.1 | 458000.676000 |
| L₃ₒ | Spherical surface | Infinite | 0.05 | |
| L₃ᵢ | Aspheric surface | 3.849121 | 0.215751 | 636000.239000 |
| L₄ₒ | Aspheric surface | 2.177862 | 0.688017 | |
| L₄ᵢ | Aspheric surface | −86.7972 | 0.2 | 636000.239000 |
| L₅ₒ | Aspheric surface | 9.749584 | 0.05 | |
| L₅ᵢ | Aspheric surface | 64.54044 | 0.863837 | 544000.559000 |
| L₆ₒ | Aspheric surface | −3.32753 | 0.38745 | |
| L₆ᵢ | Aspheric surface | 5.654288 | 0.845152 | 544000.559000 |
| L₇ₒ | Aspheric surface | 164.2367 | 0.726736 | |
| L₇ᵢ | Aspheric surface | −1.93152 | 0.2 | 544000.559000 |
| IR filterₒ | Aspheric surface | 8.672282 | 0.053196 | |
| IR filterᵢ | Spherical surface | Infinite | 0.2 | 516000.641000 |
| Image plane | Spherical surface | Infinite | 0.2 | |
| L₁ₒ | Spherical surface | Infinite | 0 | |

TABLE 12-3-1

| Numbered surface | L₁ₒ | L₁ᵢ | L₃ₒ | L₃ᵢ | L₄ₒ | L₄ᵢ |
|---|---|---|---|---|---|---|
| K | 0.195356 | −7.01E+11 | −1.08E+01 | −4.54E−01 | −2.37E+14 | 1.31E+01 |
| A | −4.06E−03 | −1.61E−02 | −7.98E−02 | −1.03E−01 | −1.68E−01 | −1.30E−01 |
| B | 0.0133 | 0.047454 | 0.113507 | 0.111385 | 0.035247 | 0.016016 |
| C | −0.02991 | −0.05428 | −0.0914 | −0.0909 | −0.03465 | −0.00946 |
| D | 0.032892 | 0.037943 | 0.042212 | 0.041732 | 0.004982 | 0.008535 |
| E | −0.01511 | −0.01261 | −0.00708 | −0.00948 | 0.003187 | 0.000108 |
| F | 3.44E−05 | −0.00094 | −0.00156 | 0.000188 | −0.00078 | 0.000167 |
| G | 0.001535 | 0.00176 | 0.000926 | −0.0005 | −0.00122 | −7.26E−05 |

TABLE 12-3-2

| Numbered surface | L₅ₒ | L₅ᵢ | L₆ₒ | L₆ᵢ | L₇ₒ | L₇ᵢ |
|---|---|---|---|---|---|---|
| K | −1.37E+16 | 6.79E−01 | 4.72E+00 | −1.43E+16 | −6.55E−01 | 5.88E+00 |
| A | 1.38E−02 | −3.84E−02 | −5.38E−02 | 4.53E−03 | 2.28E−02 | −2.63E−02 |
| B | −0.04167 | 0.007029 | −0.00442 | −0.01274 | 0.002396 | 5.57E−03 |
| C | 0.026293 | −0.00075 | −0.00141 | 1.80E−03 | 2.04E−05 | −6.78E−04 |
| D | −0.00617 | −0.0007 | −3.74E−04 | −1.87E−05 | −3.25E−05 | 1.72E−05 |
| E | 0.000506 | 5.15E−05 | 1.28E−05 | −2.98E−07 | 1.18E−06 | 2.25E−06 |
| F | 8.97E−05 | −3.01E−05 | 3.28E−05 | −8.30E−07 | 7.38E−08 | 1.43E−07 |
| G | −2.08E−05 | 4.07E−05 | −6.21E−06 | −1.93E−08 | 1.16E−09 | −2.45E−08 |

### Embodiment 13

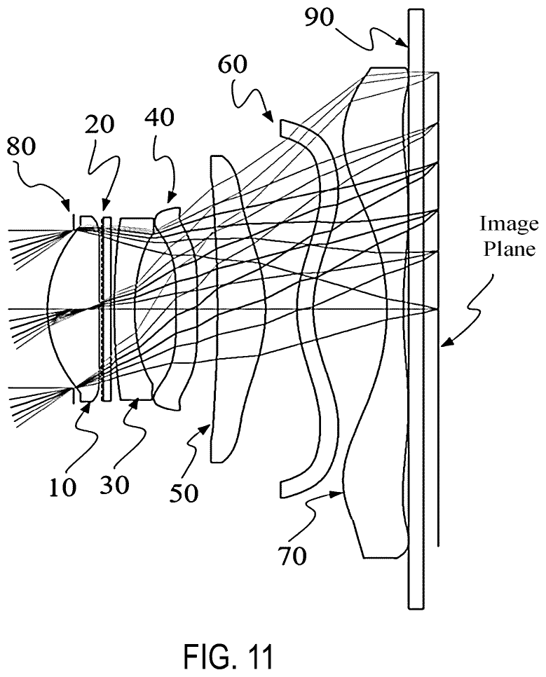

In one embodiment, embodiment 13 provides an optical system, and the optical system is shown in FIG. 11. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 13-1. The curvature, thickness, refractive index, and other parameter item of each lens in the optical system are shown in Table 13-2. The aspherical coefficients of each surface of each lens in the optical system are shown in Table 13-3-1 and Table 13-3-2, and the aspheric coefficients are shown in formula (9).

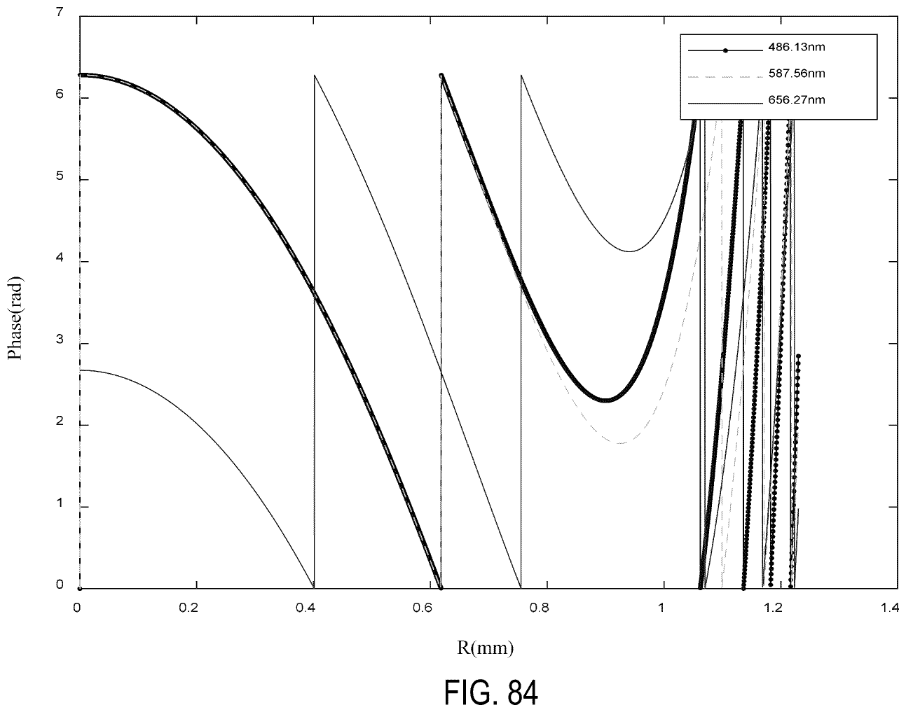

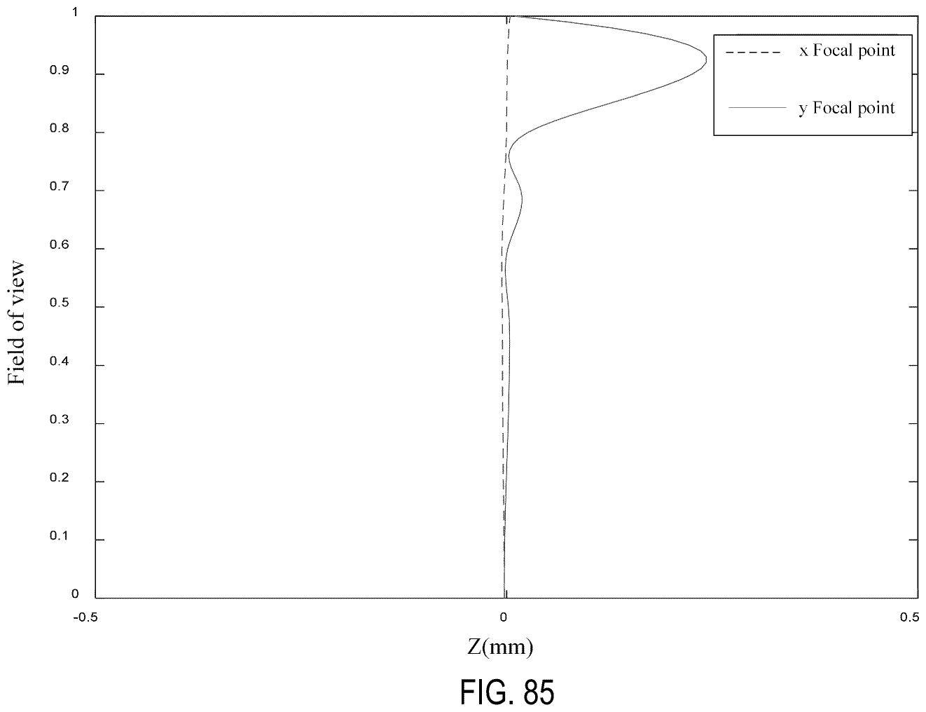

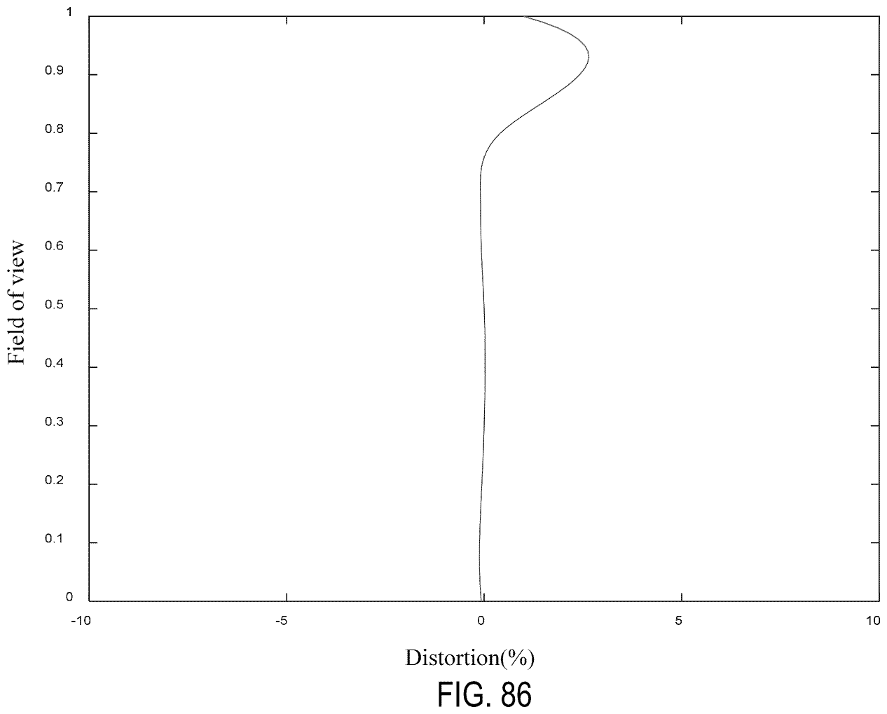

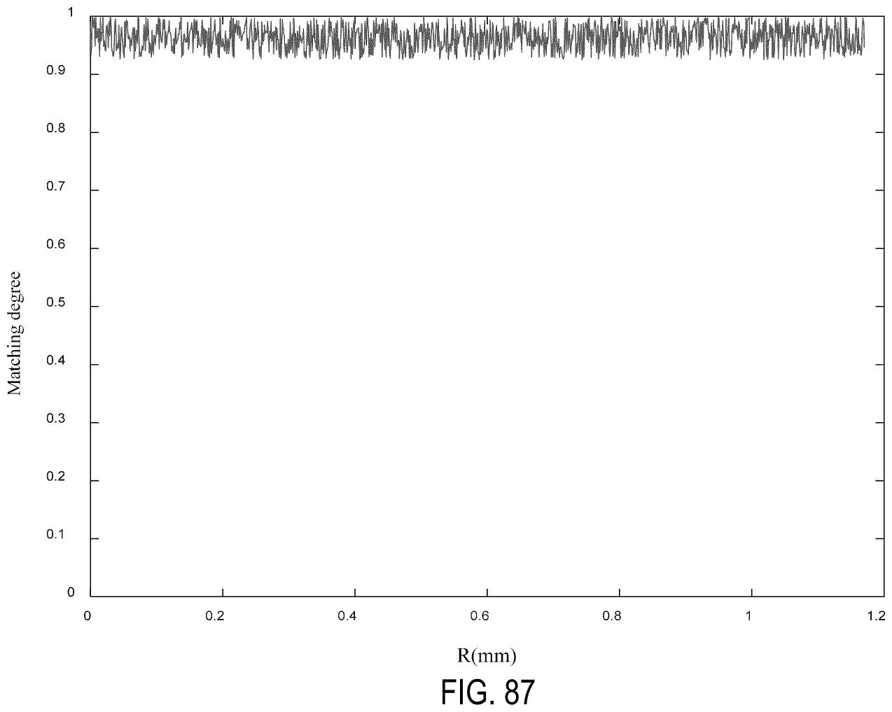

FIG. 84 shows a phase modulation diagram of the metalens in the optical system provided by embodiment 13 at the wavelengths of 486.13 nm, 587.56 nm, and 656.27 nm. It can be seen in FIG. 84 that the phases cover 0-2π of the metalens at different wavelengths. FIG. 85 shows an astigmatism diagram of the optical system. According to FIG. 85, the astigmatism of the optical system at the different fields of view from 0 to 1 is less than 0.5 mm. FIG. 86 shows a distortion diagram of the optical system. According to FIG. 86, the distortion of the optical system at the different fields of view from 0 to 1 is less than 5%. FIG. 87 shows the matching degree of the wide spectrum of the metalens in the optical system in embodiment 13. According to FIG. 87, the real phase of embodiment 13 and the theoretical phase is greater than 90%. The optical system in embodiment 13 has a high MTF and has good control of astigmatism and distortion, therefore the optical system has good imaging quality.

TABLE 13-1

| Parameter item | Parameter value |
|---|---|
| Working wavelength(WL) | VIS(400-700 nm) |
| Effective focal length(EFL) | 4.63 mm |
| Field of view(2ω) | 74° |
| F number | 2.0 |
| Image height(ImgH) | 3.4896 mm |
| Total track length(TTL) | 5.3 mm |

TABLE 13-2

| Numbered | | Radius | Thickness | |
|---|---|---|---|---|
| surface | Surface type | (mm) | (mm) | Material |
| STO | Spherical surface | Infinite | −3.56E−01 | |
| L₁ₒ | Aspheric surface | 1.8736 | 7.06E−01 | 545000.559000 |
| L₁ᵢ | Aspheric surface | 53.4789 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 1.092 | 0.274777 | 636000.239000 |
| L₃ᵢ | Aspheric surface | 2.941 | 0.564419 | |
| L₄ₒ | Aspheric surface | −45.7044 | 0.282478 | 636000.239000 |
| L₄ᵢ | Aspheric surface | 16.01252 | 0.277365 | |
| L₅ₒ | Aspheric surface | −24.1501 | 0.651517 | 544000.559000 |
| L₅ᵢ | Aspheric surface | −2.52406 | 0.425817 | |
| L₆ₒ | Aspheric surface | 2.068743 | 0.221905 | 544000.559000 |
| L₆ᵢ | Aspheric surface | 2.006987 | 0.998343 | |
| L₇ₒ | Aspheric surface | −3.59163 | 0.22 | 544000.559000 |
| L₇ᵢ | Aspheric surface | 6.047643 | 0.077082 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 13-3-1

| Numbered surface | L₁ₒ | L₁ᵢ | L₃ₒ | L₃ᵢ | L₄ₒ | L₄ᵢ |
|---|---|---|---|---|---|---|
| K | −3.07E−02 | −1.10E+16 | 58.04283 | 5.80E+01 | 5.80E+01 | 5.80E+01 |
| A | −0.00659 | −1.22E−02 | −4.09E−02 | −4.09E−02 | −4.09E−02 | −4.09E−02 |
| B | 2.92E−02 | 5.21E−02 | 8.75E−02 | 8.75E−02 | 8.75E−02 | 8.75E−02 |
| C | −0.04503 | −0.06979 | −0.0914 | −0.0914 | −0.0914 | −0.0914 |
| D | 0.032226 | 0.039736 | 0.041021 | 0.041021 | 0.041021 | 0.041021 |
| E | −0.00751 | −0.00899 | −0.00384 | −0.00384 | −0.00384 | −0.00384 |
| F | −0.00155 | −0.00114 | −0.00159 | −0.00159 | −0.00159 | −0.00159 |
| G | 1.34E−04 | 2.67E−05 | −2.24E−05 | −2.24E−05 | −2.24E−05 | −2.24E−05 |

TABLE 13-3-2

| Numbered surface | L₅ₒ | L₅ᵢ | L₆ₒ | L₆ᵢ | L₇ₒ | L₇ᵢ |
|---|---|---|---|---|---|---|
| K | 5.80E+01 | 58.04283 | 5.80E+01 | 5.80E+01 | 5.80E+01 | 5.80E+01 |
| A | −4.09E−02 | −4.09E−02 | −4.09E−02 | −4.09E−02 | −4.09E−02 | −4.09E−02 |
| B | 8.75E−02 | 8.75E−02 | 8.75E−02 | 8.75E−02 | 8.75E−02 | 8.75E−02 |
| C | −0.0914 | −0.0914 | −0.0914 | −0.0914 | −0.0914 | −9.14E−02 |
| D | 0.041021 | 0.041021 | 0.041021 | 4.10E−02 | 4.10E−02 | 4.10E−02 |
| E | −0.00384 | −0.00384 | −3.84E−03 | −3.84E−03 | −3.84E−03 | −3.84E−03 |
| F | −0.00159 | −1.59E−03 | −1.59E−03 | −1.59E−03 | −1.59E−03 | −1.59E−03 |
| G | −2.24E−05 | −2.24E−05 | −2.24E−05 | −2.24E−05 | −2.24E−05 | −2.24E−05 |

### Embodiment 14

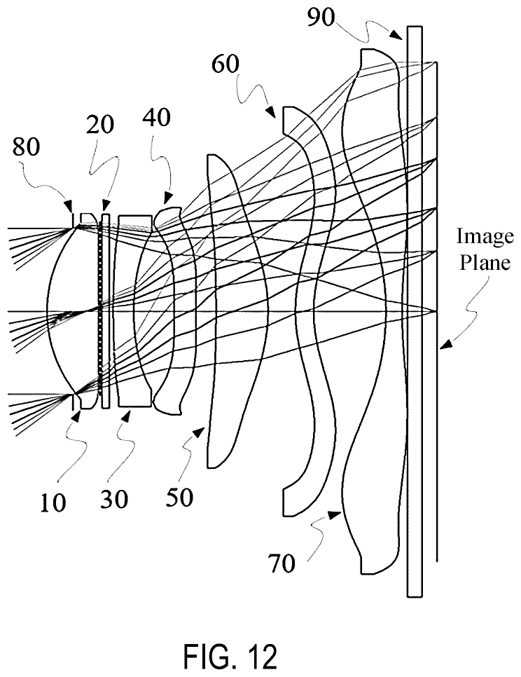

In one embodiment, embodiment 14 provides an optical system, and the optical system is shown in FIG. 12. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 14-1. The curvature, thickness, refractive index, and other parameter item of each lens in the optical system are shown in Table 14-2. The aspherical coefficients of each surface of each lens in the optical system are shown in Table 14-3-1 and Table 14-3-2, and the aspheric coefficients are shown in formula (9).

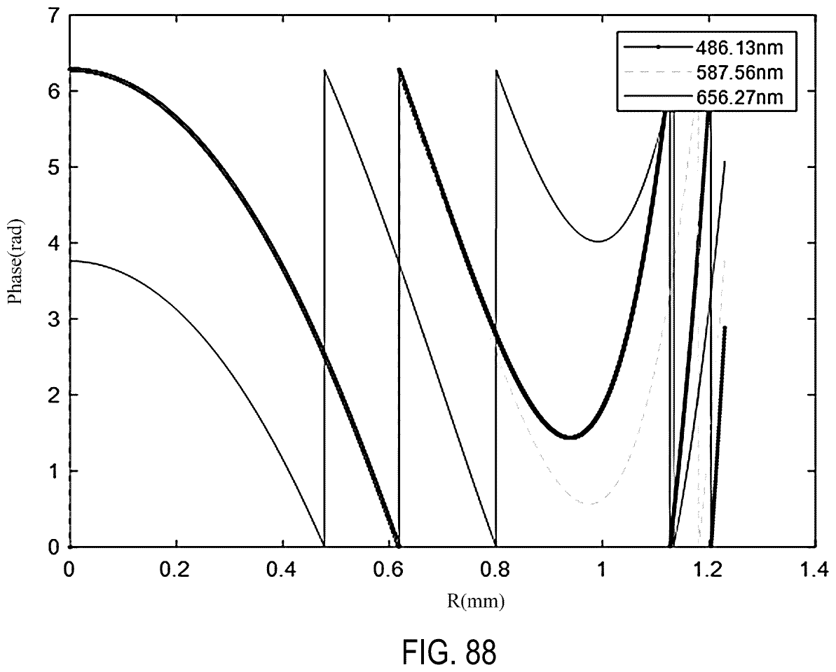

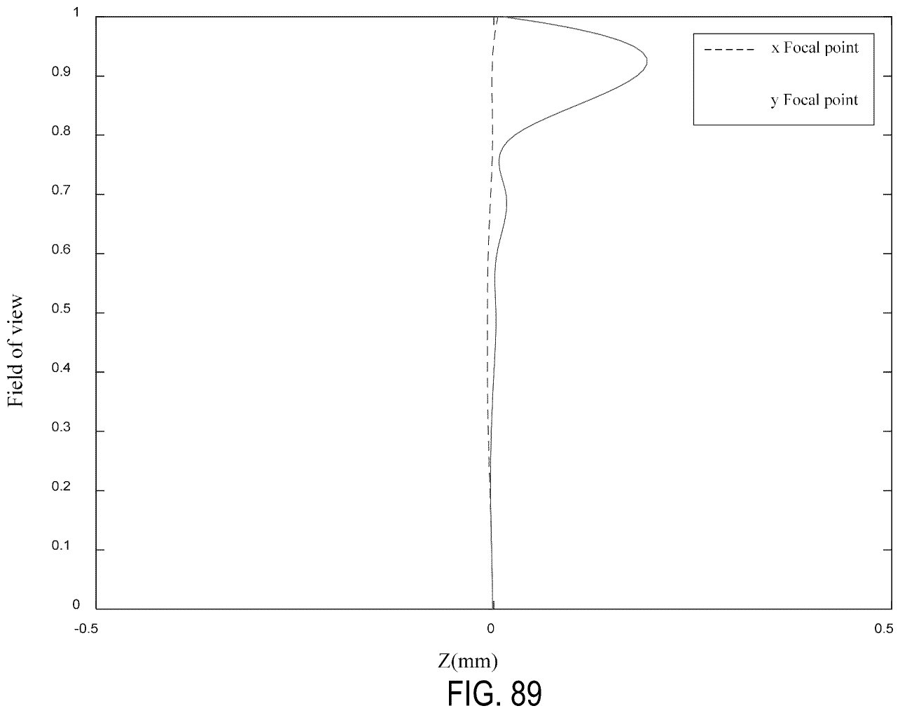

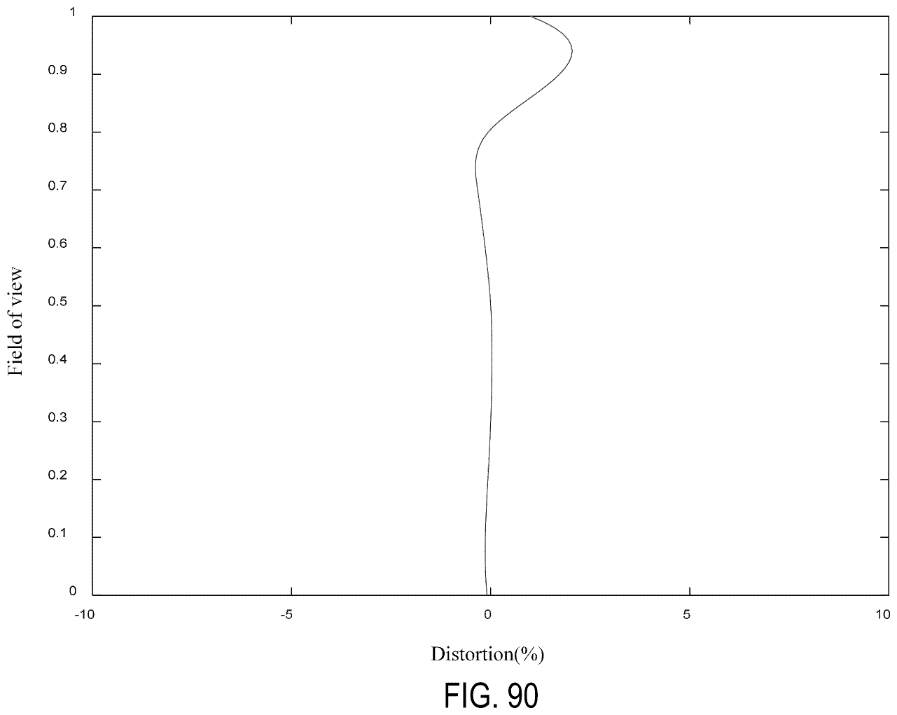

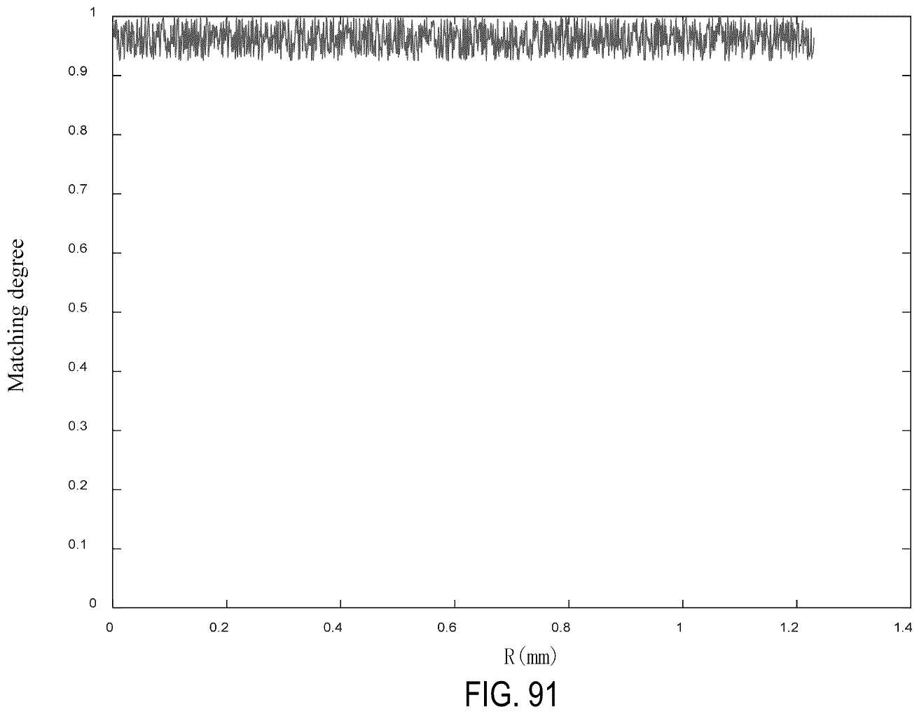

FIG. 88 shows a phase modulation diagram of the metalens in the optical system provided by embodiment 14 at the wavelengths of 486.13 nm, 587.56 nm, and 656.27 nm. It can be seen in FIG. 88 that the phases cover 0-2π of the metalens at different wavelengths. FIG. 89 shows an astigmatism diagram of the optical system. According to FIG. 89, the astigmatism of the optical system at the different fields of view from 0 to 1 is less than 0.5 mm. FIG. 90 shows a distortion diagram of the optical system. According to FIG. 90, the distortion of the optical system at the different fields of view from 0 to 1 is less than 5%. FIG. 91 shows the matching degree of the wide spectrum of the metalens in the optical system in embodiment 14. According to FIG. 91, the real phase of embodiment 14 and the theoretical phase is greater than 90%. The optical system in embodiment 14 has a high MTF and has good control of astigmatism and distortion, therefore the optical system has good imaging quality.

TABLE 14-1

| Parameter item | Parameter value |
|---|---|
| Working wavelength(WL) | VIS(400-700 nm) |
| Effective focal length(EFL) | 4.63 mm |
| Field of view(2ω) | 74° |
| F number | 2.0 |
| Image height(ImgH) | 3.4896 mm |
| Total track length(TTL) | 5.3 mm |

TABLE 14-2

| Numbered | | Radius | Thickness | |
|---|---|---|---|---|
| surface | Surface type | (mm) | (mm) | Material |
| STO | Spherical surface | Infinite | −3.56E−01 | |
| L₁ₒ | Aspheric surface | 1.864 | 0.699326 | 545000.559000 |
| L₁ᵢ | Aspheric surface | 45.207 | 5.00E−02 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 10.8634 | 0.278657 | 636000.239000 |
| L₃ᵢ | Aspheric surface | 2.953876 | 0.552741 | |
| L₄ₒ | Aspheric surface | −62.4697 | 2.95E−01 | 651000.215000 |
| L₄ᵢ | Aspheric surface | 15.33553 | 0.271513 | |
| L₅ₒ | Aspheric surface | −18.6224 | 0.705843 | 544000.559000 |
| L₅ᵢ | Aspheric surface | −2.41373 | 0.374206 | |
| L₆ₒ | Aspheric surface | 2.214616 | 0.248327 | 651000.215000 |
| L₆ᵢ | Aspheric surface | 2.107468 | 0.981502 | |
| L₇ₒ | Aspheric surface | −3.56226 | 0.22 | 544000.559000 |
| L₇ᵢ | Aspheric surface | 6.139346 | 0.071737 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 14-3-1

| Numbered surface | L₁ₒ | L₁ᵢ | L₃ₒ | L₃ᵢ | L₄ₒ | L₄ᵢ |
|---|---|---|---|---|---|---|
| K | −0.02854 | −1.10E+16 | 54.89941 | 2.340258 | −27536.7 | −26.7125 |
| A | −0.00691 | −0.01165 | −0.03946 | −0.04008 | −0.17285 | −0.14283 |
| B | 0.0294 | 0.052557 | 0.088919 | 0.08093 | 0.051397 | 0.02291 |
| C | −0.0448 | −0.06932 | −0.09087 | −0.0726 | −0.03973 | −0.00685 |
| D | 0.032188 | 0.039918 | 0.041102 | 0.035384 | 0.012813 | 0.003335 |
| E | −0.0076 | −0.00895 | −0.00394 | −0.00593 | 0.000639 | 0.000328 |
| F | −0.00155 | −0.00115 | −0.0017 | 0.00146 | 0.001198 | 0.000784 |
| G | 0.00021 | −3.44E−06 | −8.69E−05 | 0.000466 | 0.000662 | 1.77E−05 |

TABLE 14-3-2

| Numbered surface | L₅ₒ | L₅ᵢ | L₆ₒ | L₆ᵢ | L₇ₒ | L₇ᵢ |
|---|---|---|---|---|---|---|
| K | 90.56237 | 0.092339 | −0.87976 | −1.3102 | −0.00546 | −4.21181 |
| A | 0.01444 | 0.024729 | −0.05656 | −0.04598 | −0.00355 | −0.03014 |
| B | −0.0327 | 0.003478 | 0.001959 | −0.00147 | 0.00275 | 0.004989 |
| C | 0.022331 | 0.00219 | 9.13E−05 | 0.001158 | 6.49E−05 | −0.00047 |
| D | −0.00623 | −0.00095 | 3.65E−05 | −0.0001 | −3.07E−05 | 2.18E−05 |
| E | 0.000664 | 9.98E−05 | 8.63E−06 | 2.71E−06 | 1.53E−06 | 8.27E−08 |
| F | −1.35E−06 | −1.98E−06 | −1.17E−06 | −8.78E−08 | −2.66E−09 | −8.53E−09 |
| G | −1.21E−06 | −4.18E−08 | −2.21E−07 | −1.11E−08 | −6.64E−11 | −1.87E−09 |

### Embodiment 15

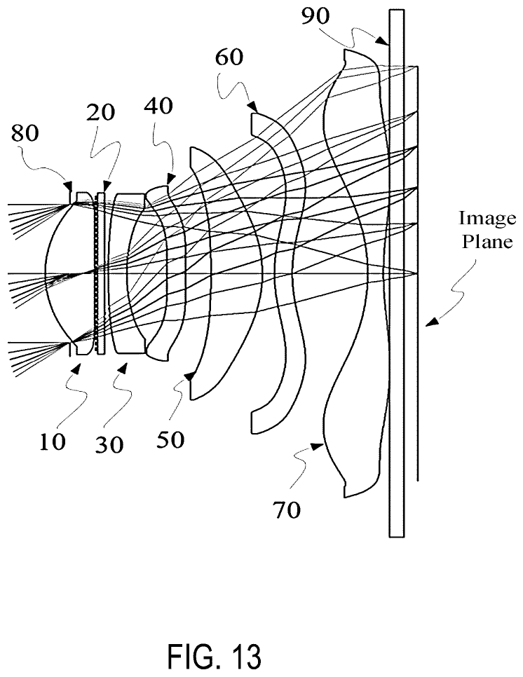

In one embodiment, embodiment 15 provides an optical system, and the optical system is shown in FIG. 13. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 15-1. The curvature, thickness, refractive index, and other parameter item of each lens in the optical system are shown in Table 15-2. The aspherical coefficients of each surface of each lens in the optical system are shown in Table 15-3-1 and Table 15-3-2, and the aspheric coefficients are shown in formula (9).

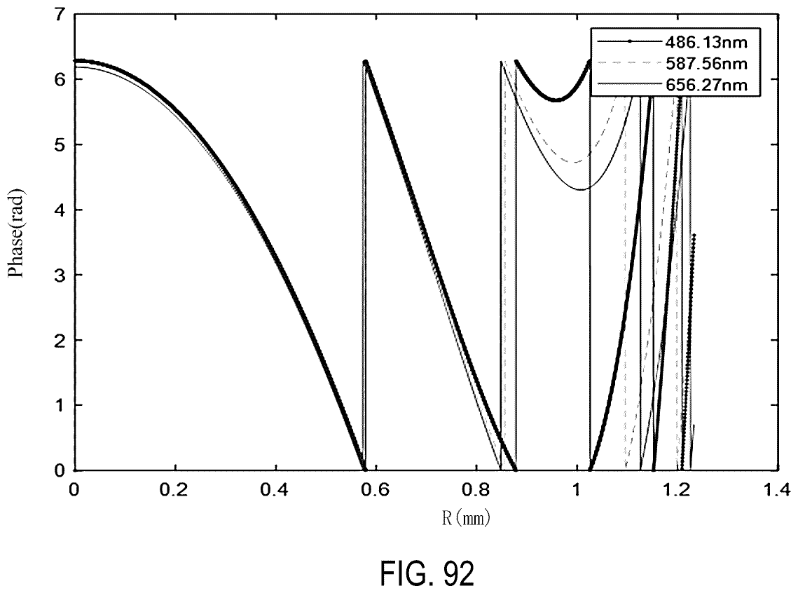

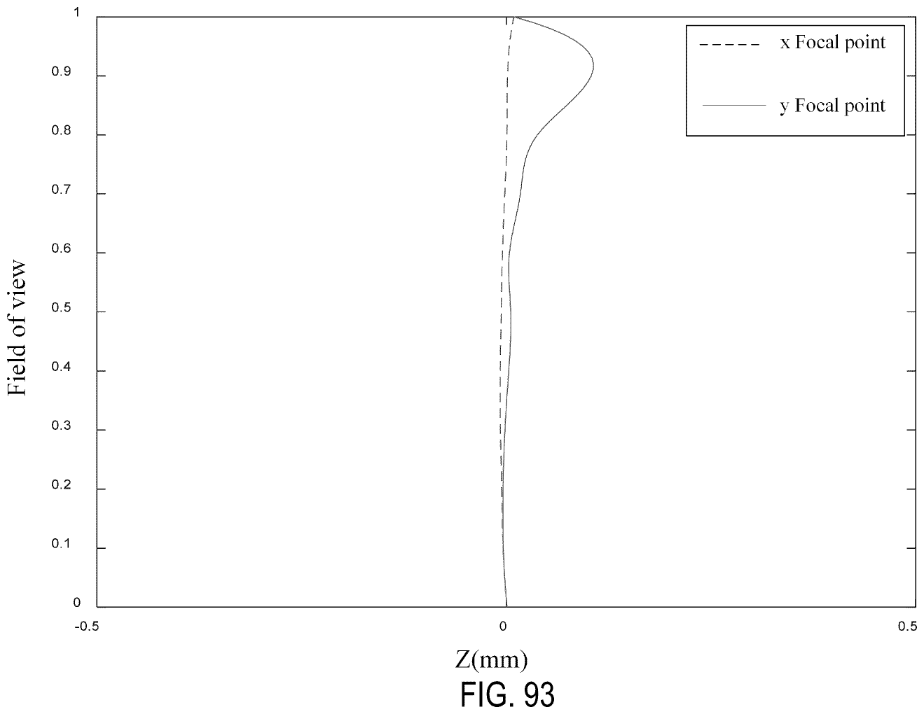

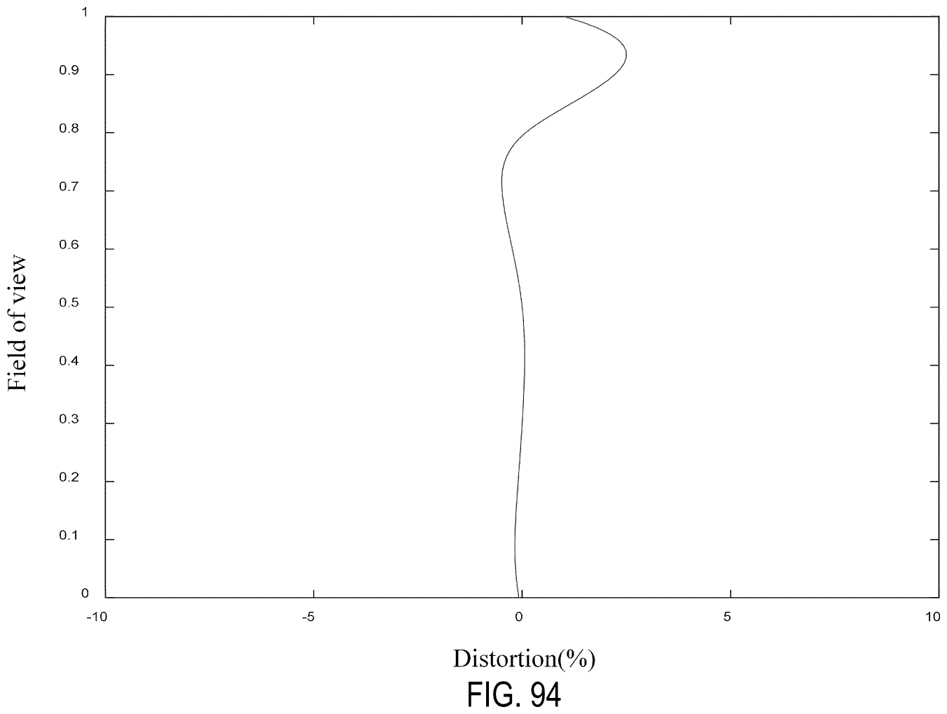

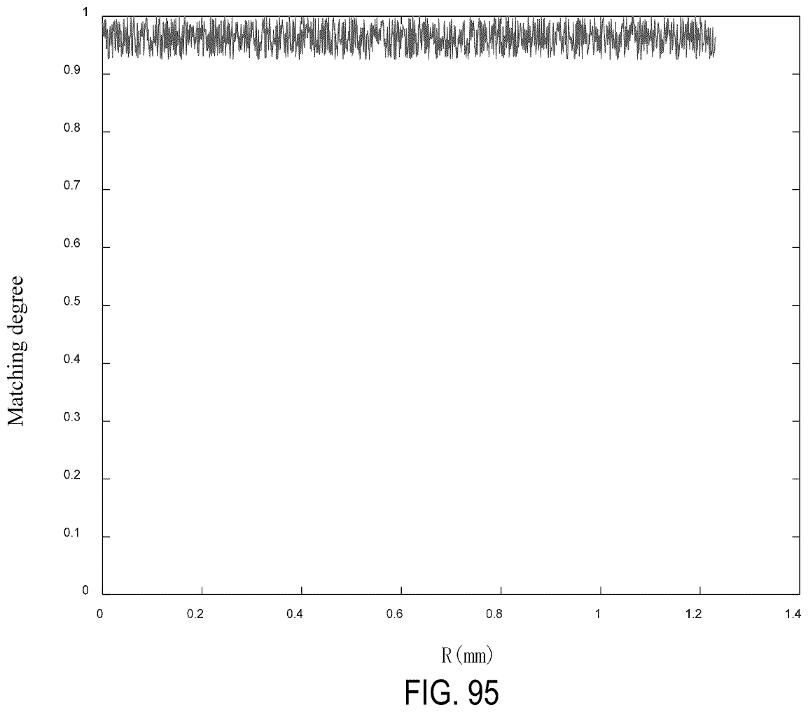

FIG. 92 shows a phase modulation diagram of the metalens in the optical system provided by embodiment 15 at the wavelengths of 486.13 nm, 587.56 nm, and 656.27 nm. It can be seen in FIG. 92 that the phases cover 0-2π of the metalens at different wavelengths. FIG. 93 shows an astigmatism diagram of the optical system. According to FIG. 93, the astigmatism of the optical system at the different fields of view from 0 to 1 is less than 0.5 mm. FIG. 94 shows a distortion diagram of the optical system. According to FIG. 94, the distortion of the optical system at the different fields of view from 0 to 1 is less than 5%. FIG. 95 shows the matching degree of the wide spectrum of the metalens in the optical system in embodiment 15. According to FIG. 95, the real phase of embodiment 15 and the theoretical phase is greater than 90%. The optical system in embodiment 15 has a high MTF and has good control of astigmatism and distortion, therefore the optical system has good imaging quality.

TABLE 15-1

| Parameter item | Parameter value |
|---|---|
| Working wavelength(WL) | VIS(400-700 nm) |
| Effective focal length(EFL) | 4.63 mm |
| Field of view(2ω) | 74° |
| F number | 2.0 |
| Image height(ImgH) | 3.4896 mm |
| Total track length(TTL) | 5.3 mm |

TABLE 15-2

| Numbered | | Radius | Thickness | |
|---|---|---|---|---|
| surface | Surface type | (mm) | (mm) | Material |
| STO | Spherical surface | Infinite | −0.3562 | |
| L₁ₒ | Aspheric surface | 1.8609 | 0.696492 | 545000.559000 |
| L₁ᵢ | Aspheric surface | 49.3749 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 10.28729 | 0.263557 | 636000.239000 |
| L₃ᵢ | Aspheric surface | 2.930154 | 5.74E−01 | |
| L₄ₒ | Aspheric surface | −955.699 | 0.261035 | 651000.215000 |
| L₄ᵢ | Aspheric surface | 15.9984 | 0.361623 | |
| L₅ₒ | Aspheric surface | −14.383 | 7.31E−01 | 544000.559000 |
| L₅ᵢ | Aspheric surface | −2.41452 | 0.171996 | |
| L₆ₒ | Aspheric surface | 2.7024 | 0.252343 | 651000.215000 |
| L₆ᵢ | Aspheric surface | 2.683056 | 1.074494 | |
| L₇ₒ | Aspheric surface | −3.45067 | 0.222622 | 544000.559000 |
| L₇ᵢ | Aspheric surface | 5.42708 | 0.091029 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 15-3-1

| Numbered surface | L₁ₒ | L₁ᵢ | L₃ₒ | L₃ᵢ | L₄ₒ | L₄ᵢ |
|---|---|---|---|---|---|---|
| K | −0.03678 | −1.10E+16 | 59.2523 | 2.465013 | −5.8E+12 | −632.858 |
| A | −0.00667 | −0.01278 | −0.04026 | −0.03792 | −0.16892 | −0.13776 |
| B | 0.028733 | 0.052642 | 0.089626 | 0.082577 | 0.050538 | 0.023016 |
| C | −0.04473 | −0.06898 | −0.09077 | −0.0721 | −0.03911 | −0.00712 |
| D | 0.032121 | 0.039813 | 0.041039 | 0.035882 | 0.012704 | 0.002774 |
| E | −0.0076 | −0.00905 | −0.004 | −0.0057 | 0.000415 | 5.34E−05 |
| F | −0.00155 | −1.17E−03 | −1.74E−03 | 0.00149 | 0.000844 | 8.00E−04 |
| G | 0.000184 | 3.69E−05 | −0.00014 | 0.000373 | 0.000549 | 3.32E−05 |

TABLE 15-3-2

| Numbered surface | L₅ₒ | L₅ᵢ | L₆ₒ | L₆ᵢ | L₇ₒ | L₇ᵢ |
|---|---|---|---|---|---|---|
| K | 22.01571 | 0.016301 | −1.50577 | −0.65281 | −0.10523 | 0.284398 |
| A | −0.00044 | 0.007408 | −0.05487 | −0.0468 | −0.00387 | −0.03265 |
| B | −0.0313 | 0.003171 | 2.86E−03 | −0.00367 | 2.72E−03 | 0.004684 |
| C | 0.021793 | 0.002358 | 2.98E−04 | 0.00148 | 6.76E−05 | −4.48E−04 |
| D | −0.00632 | −9.19E−04 | −2.34E−04 | −8.03E−05 | −3.04E−05 | 2.22E−05 |
| E | 6.56E−04 | 1.02E−04 | 6.71E−05 | −1.79E−07 | 1.54E−06 | −2.24E−08 |
| F | −1.33E−06 | −3.90E−06 | 4.81E−07 | −3.99E−07 | −3.71E−09 | −1.12E−08 |
| G | 1.46E−07 | −6.42E−07 | −1.37E−06 | −2.08E−08 | −3.10E−10 | −1.28E−09 |

### Embodiment 16

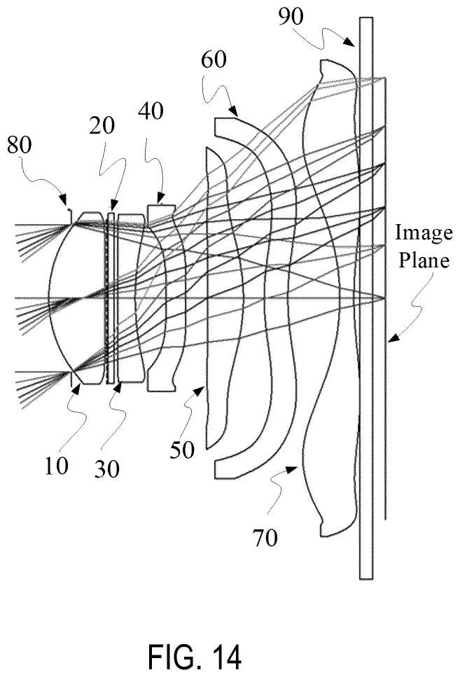

In one embodiment, embodiment 16 provides an optical system, and the optical system is shown in FIG. 14. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 16-1. The curvature, thickness, refractive index, and other parameter item of each lens in the optical system are shown in Table 16-2. The aspherical coefficients of each surface of each lens in the optical system are shown in Table 16-3-1 and Table 16-3-2, and the aspheric coefficients are shown in formula (9).

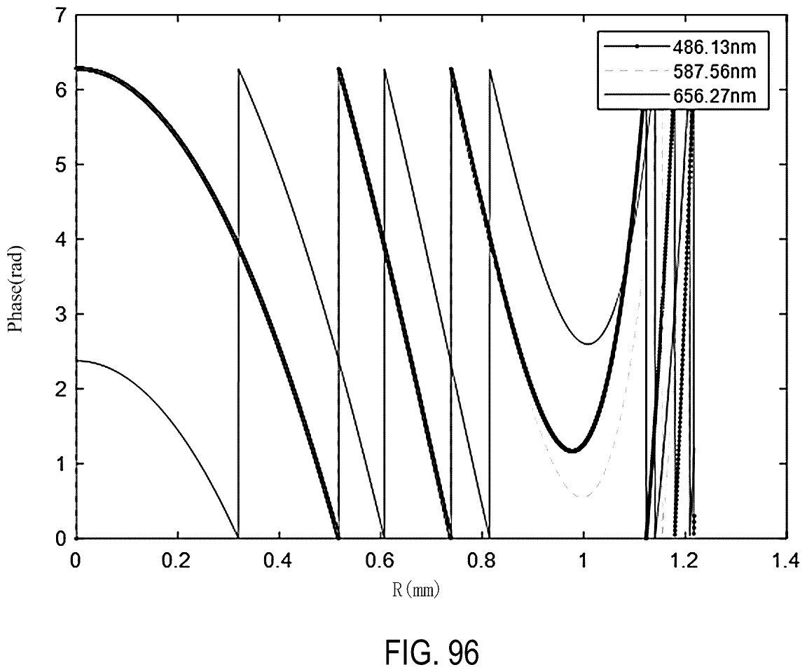

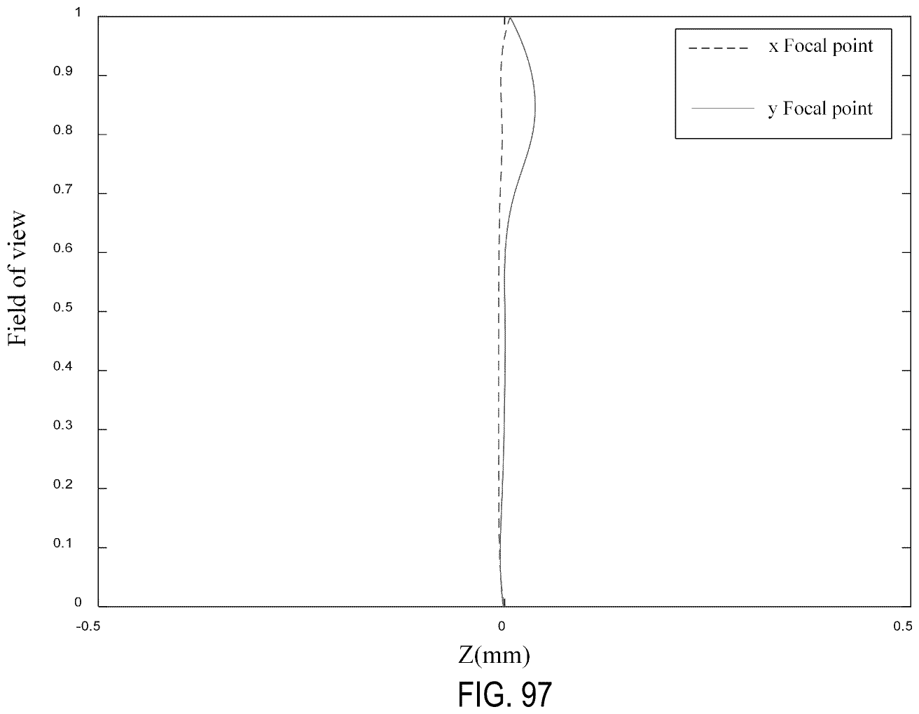

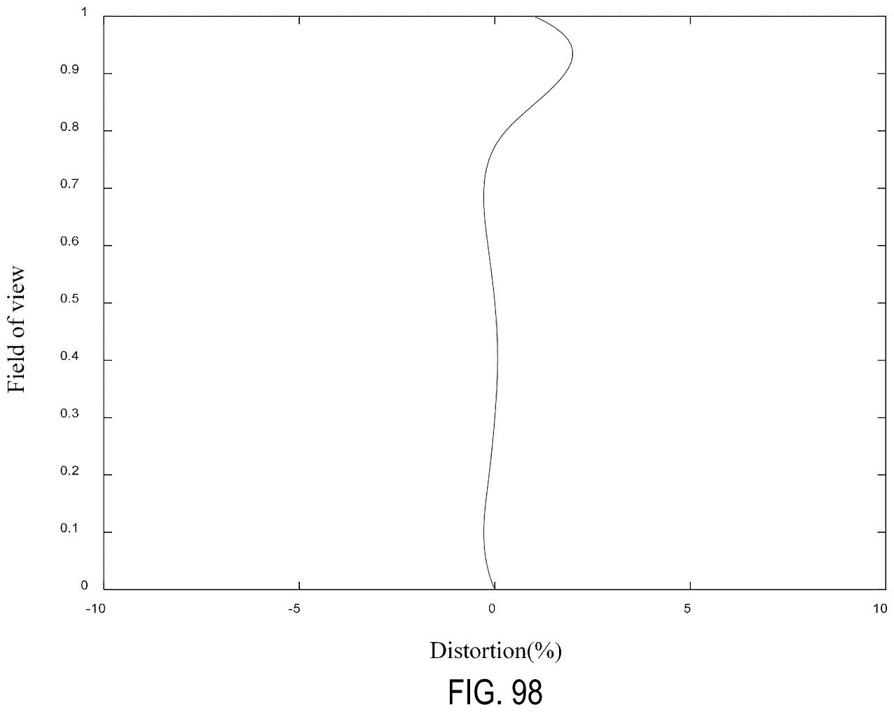

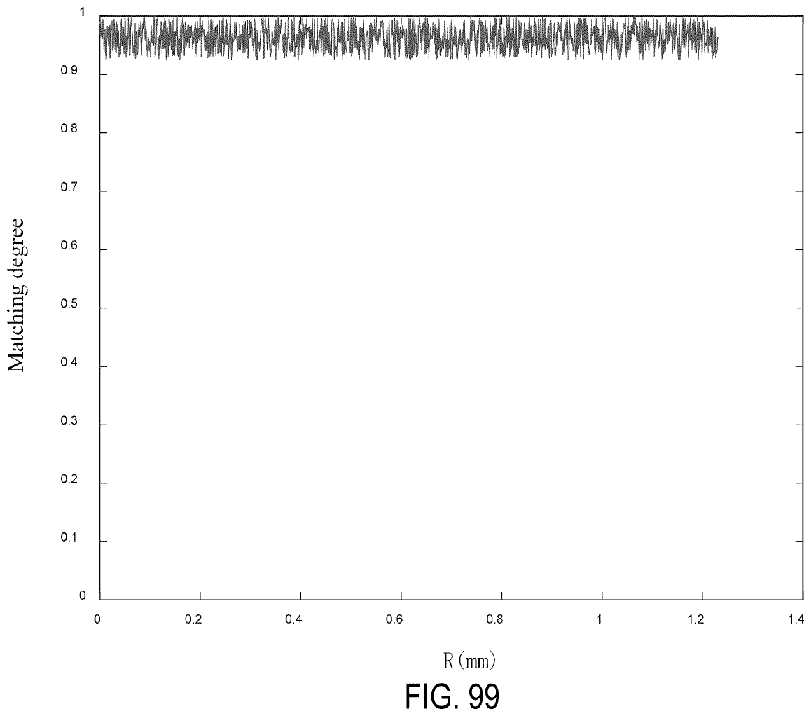

FIG. 96 shows a phase modulation diagram of the metalens in the optical system provided by embodiment 16 at the wavelengths of 486.13 nm, 587.56 nm, and 656.27 nm. It can be seen in FIG. 96 that the phases cover 0-2π of the metalens at different wavelengths. FIG. 97 shows an astigmatism diagram of the optical system. According to FIG. 97, the astigmatism of the optical system at the different fields of view from 0 to 1 is less than 0.5 mm. FIG. 98 shows a distortion diagram of the optical system. According to FIG. 98, the distortion of the optical system at the different fields of view from 0 to 1 is less than 5%. FIG. 99 shows the matching degree of the wide spectrum of the metalens in the optical system in embodiment 16. According to FIG. 99, the real phase of embodiment 16 and the theoretical phase is greater than 90%. The optical system in embodiment 16 has a high MTF and has good control of astigmatism and distortion, therefore the optical system has good imaging quality.

TABLE 16-1

| Parameter item | Parameter value |
|---|---|
| Working wavelength(WL) | VIS(400-700 nm) |
| Effective focal length(EFL) | 4.63 mm |
| Field of view(2ω) | 74° |
| F number | 2.0 |
| Image height(ImgH) | 3.4896 mm |
| Total track length(TTL) | 5.3 mm |

TABLE 16-2

| Numbered | | Radius | Thickness | |
|---|---|---|---|---|
| surface | Surface type | (mm) | (mm) | Material |
| STO | Spherical surface | Infinite | −0.3562 | |
| L₁ₒ | Aspheric surface | 1.8973 | 0.884405 | 545000.559000 |
| L₁ᵢ | Aspheric surface | 39.7543 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 36.11624 | 0.277012 | 636000.239000 |
| L₃ᵢ | Aspheric surface | 3.947913 | 0.485844 | |
| L₄ₒ | Aspheric surface | −34.2535 | 0.310055 | 651000.215000 |
| L₄ᵢ | Aspheric surface | 19.96742 | 0.339959 | |
| L₅ₒ | Aspheric surface | 14674.48 | 0.567373 | 544000.559000 |
| L₅ᵢ | Aspheric surface | −2.98532 | 0.327839 | |
| L₆ₒ | Aspheric surface | 3.596732 | 0.372327 | 651000.215000 |
| L₆ᵢ | Aspheric surface | 3.95 | 0.818634 | |
| L₇ₒ | Aspheric surface | −3.50428 | 0.22 | 544000.559000 |
| L₇ᵢ | Aspheric surface | 4.989452 | 0.096552 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 16-3-1

| Numbered surface | L₁ₒ | L₁ᵢ | L₃ₒ | L₃ᵢ | L₄ₒ | L₄ᵢ |
|---|---|---|---|---|---|---|
| K | −0.02794 | −6.78E+12 | 161.9111 | 1.355479 | 673.7903 | −270.907 |
| A | −0.00681 | −0.0148 | −0.04148 | −0.04411 | −0.17617 | −0.14788 |
| B | 0.028847 | 0.050861 | 0.087246 | 0.079256 | 0.046218 | 0.025909 |
| C | −0.04419 | −0.06909 | −0.09057 | −0.07712 | −0.04244 | −0.00596 |
| D | 0.031895 | 0.039913 | 0.040959 | 0.032874 | 0.012662 | 0.003356 |
| E | −0.00784 | −0.00891 | −0.00414 | −0.0065 | 0.000968 | 2.08E−04 |
| F | −0.00147 | −1.04E−03 | −1.77E−03 | 0.001559 | 0.000743 | 9.26E−04 |
| G | 0.00053 | 1.18E−04 | 0.000338 | −0.00134 | −0.00097 | 2.42E−04 |

TABLE 16-3-2

| Numbered surface | L₅ₒ | L₅ᵢ | L₆ₒ | L₆ᵢ | L₇ₒ | L₇ᵢ |
|---|---|---|---|---|---|---|
| K | −8.384E+11 | 0.214104 | 0.52101 | 0.84486 | −0.05906 | 0.615769 |
| A | 0.014810082 | 0.019869 | −0.05176 | −0.02971 | −0.00266 | −0.0366 |
| B | −0.033023 | 0.004881 | 4.54E−03 | −0.0041 | 2.75E−03 | 0.005134 |
| C | 0.022569 | 0.002147 | −5.09E−04 | 0.001172 | 6.02E−05 | −4.55E−04 |
| D | −0.006194 | −9.81E−04 | −1.27E−06 | −1.01E−04 | −3.12E−05 | 2.10E−05 |
| E | 6.50E−04 | 9.41E−05 | 1.48E−05 | 1.98E−06 | 1.53E−06 | −5.55E−09 |
| F | −9.77E−06 | −1.85E−06 | −7.68E−08 | −1.43E−07 | −1.09E−09 | −1.00E−08 |
| G | −1.08E−06 | −6.57E−08 | −3.60E−07 | −9.57E−09 | −2.71E−11 | −1.45E−09 |

### Embodiment 17

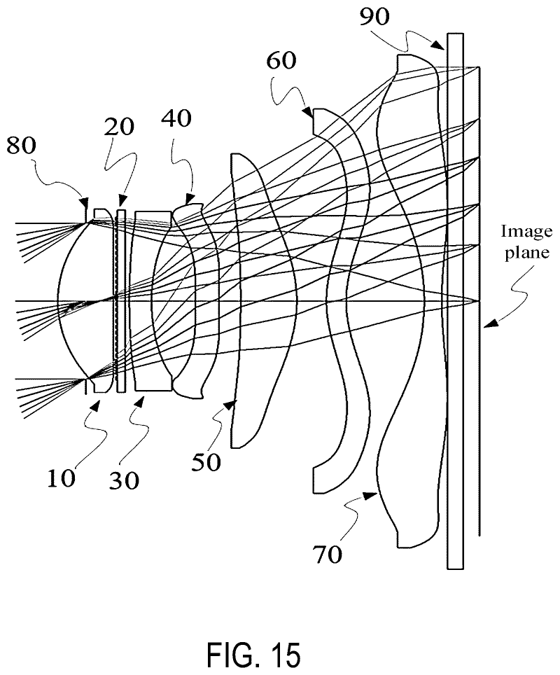

In one embodiment, embodiment 17 provides an optical system, and the optical system is shown in FIG. 15. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 17-1. The curvature, thickness, refractive index, and other parameter item of each lens in the optical system are shown in Table 17-2. The aspherical coefficients of each surface of each lens in the optical system are shown in Table 17-3-1 and Table 17-3-2, and the aspheric coefficients are shown in formula (9).

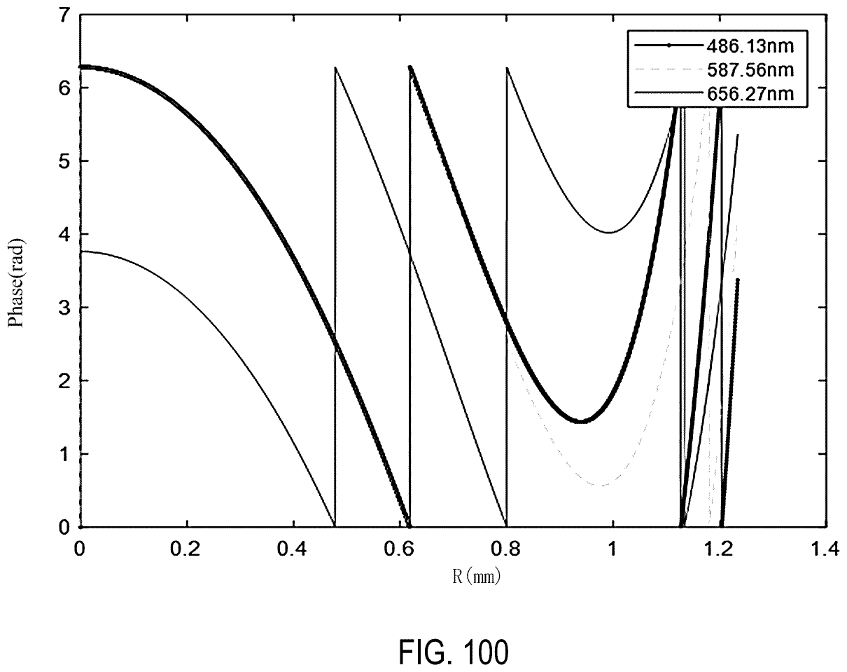

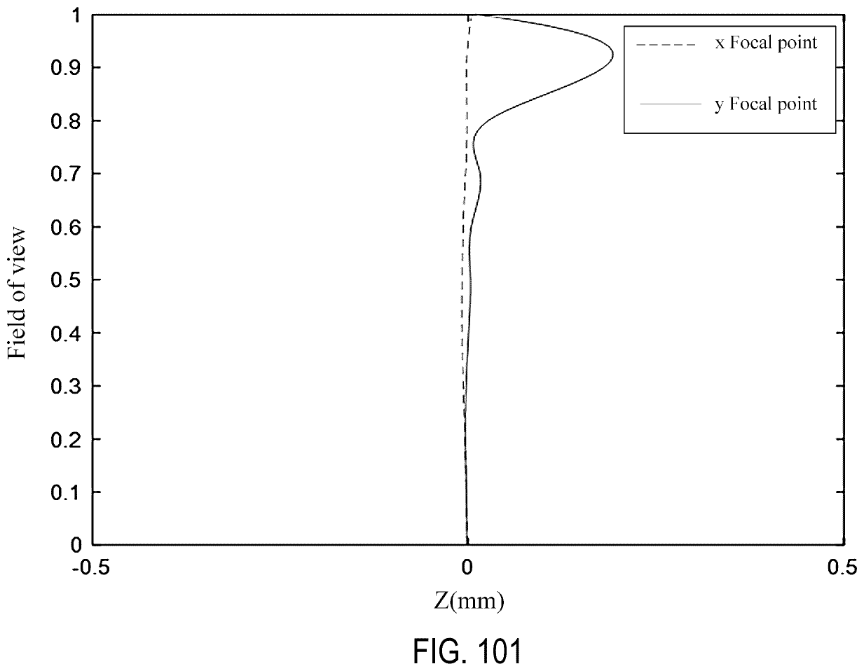

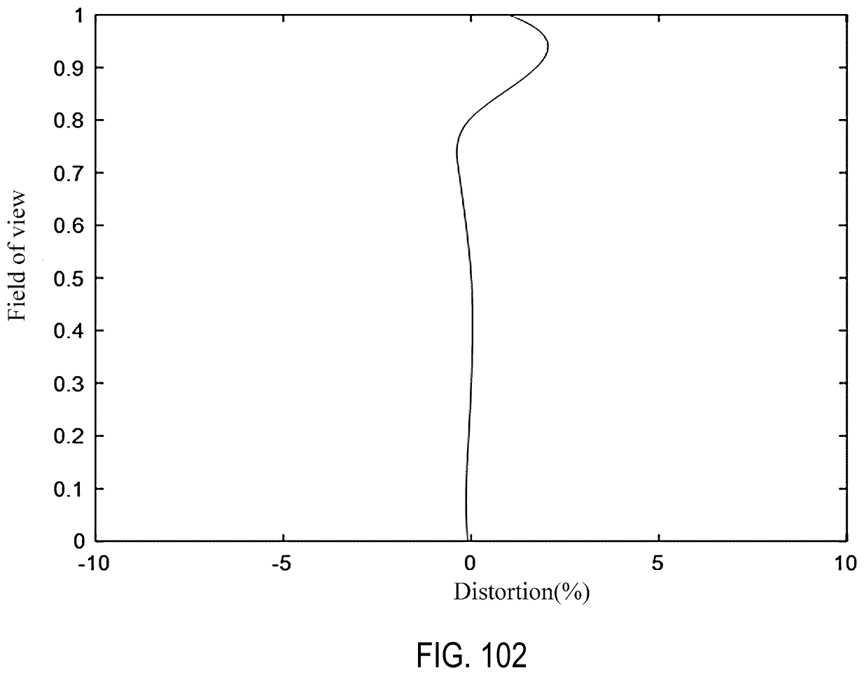

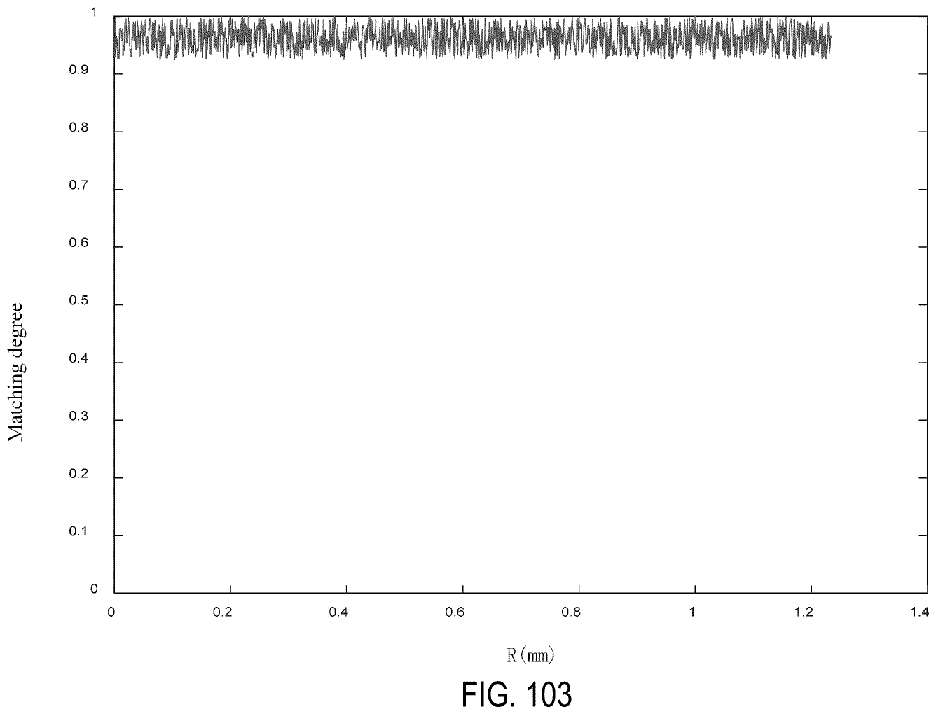

FIG. 100 shows a phase modulation diagram of the metalens in the optical system provided by embodiment 17 at the wavelengths of 486.13 nm, 587.56 nm, and 656.27 nm. It can be seen in FIG. 100 that the phases cover 0-2π of the metalens at different wavelengths. FIG. 101 shows an astigmatism diagram of the optical system. According to FIG. 101, the astigmatism of the optical system at the different fields of view from 0 to 1 is less than 0.5 mm. FIG. 102 shows a distortion diagram of the optical system. According to FIG. 102, the distortion of the optical system at the different fields of view from 0 to 1 is less than 5%. FIG. 103 shows the matching degree of the wide spectrum of the metalens in the optical system in embodiment 17. According to FIG. 103, the real phase of embodiment 17 and the theoretical phase is greater than 90%. The optical system in embodiment 3 has a high MTF and has good control of astigmatism and distortion, therefore the optical system has good imaging quality.

TABLE 17-1

| Parameter item | Parameter value |
|---|---|
| Working wavelength(WL) | VIS(400-700 nm) |
| Effective focal length(EFL) | 4.63 mm |
| Field of view(2ω) | 74° |
| F number | 2.0 |
| Image height(ImgH) | 3.4896 mm |
| Total track length(TTL) | 5.3 mm |

TABLE 17-2

| Numbered | | Radius | Thickness | |
|---|---|---|---|---|
| surface | Surface type | (mm) | (mm) | Material |
| STO | Aspheric surface | Infinite | −0.3562 | |
| L₁ₒ | Aspheric surface | 1.864 | 0.699326 | 545000.559000 |
| L₁ᵢ | Structural surface (metalens) | 45.207 | 0.05 | |
| L₂ₒ | Spherical surface | Infinite | 0.1 | 458000.676000 |
| L₂ᵢ | Aspheric surface | Infinite | 0.05 | |
| L₃ₒ | Aspheric surface | 10.8634 | 0.278657 | 636000.239000 |
| L₃ᵢ | Aspheric surface | 2.953876 | 0.552741 | |
| L₄ₒ | Aspheric surface | −62.4697 | 2.95E−01 | 651000.215000 |
| L₄ᵢ | Aspheric surface | 15.33553 | 2.72E−01 | |
| L₅ₒ | Aspheric surface | −18.6224 | 7.06E−01 | 544000.559000 |
| L₅ᵢ | Aspheric surface | −2.41 | 3.74E−01 | |
| L₆ₒ | Aspheric surface | 2.21 | 0.248327 | 651000.215000 |
| L₆ᵢ | Aspheric surface | 2.11 | 9.82E−01 | |
| L₇ₒ | Aspheric surface | −3.56226 | 0.22 | 544000.559000 |
| L₇ᵢ | Spherical surface | 6.14 | 7.17 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 17-3-1

| Numbered surface | L₁ₒ | L₁ᵢ | L₃ₒ | L₃ᵢ | L₄ₒ | L₄ᵢ |
|---|---|---|---|---|---|---|
| K | −0.02854 | −1.10E+16 | 54.89941 | 2.340257987 | −2.75E+04 | −2.67E+01 |
| A | −0.00691 | −0.01165 | −3.95E−02 | −4.01E−02 | −1.73E−01 | −1.43E−01 |
| B | 0.0294 | 0.052557 | 8.89E−02 | 8.09E−02 | 5.14E−02 | 2.29E−02 |
| C | −0.0448 | −0.06932 | −9.09E−02 | −7.26E−02 | −3.97E−02 | −6.85E−03 |
| D | 0.032188 | 0.039918 | 0.041102 | 0.035384398 | 0.0128127 | 3.33E−03 |
| E | −0.0076 | −0.00895 | −0.00394 | −0.00593499 | 6.39E−04 | 3.28E−04 |
| F | −0.00155 | −0.00115 | −0.0017 | 1.46E−03 | 1.20E−03 | 7.84E−04 |
| G | 0.00021 | −3.44E−06 | −8.69E−05 | 0.000466185 | 0.0006616 | 1.77E−05 |

TABLE 17-3-2

| Numbered surface | L₅ₒ | L₅ᵢ | L₆ₒ | L₆ᵢ | L₇ₒ | L₇ᵢ |
|---|---|---|---|---|---|---|
| K | 9.06E+01 | 9.23E−02 | −8.80E−01 | −1.3102 | −0.00546 | −4.21181 |
| A | 1.44E−02 | 2.47E−02 | −5.66E−02 | −0.04598 | −0.00355 | −0.03014 |
| B | −3.27E−02 | 3.48E−03 | 1.96E−03 | −0.00147 | 0.00275 | 0.004989 |
| C | 2.23E−02 | 2.19E−03 | 9.13E−05 | 1.16E−03 | 6.49E−05 | −0.00047 |
| D | −6.23E−03 | −9.51E−04 | 3.65E−05 | −1.01E−04 | −3.07E−05 | 2.18E−05 |
| E | 6.64E−04 | 9.98E−05 | 8.63E−06 | 2.71E−06 | 1.53E−06 | 8.27E−08 |
| F | −1.35E−06 | −1.98E−06 | −1.17E−06 | −8.78E−08 | −2.66E−09 | −8.53E−09 |
| G | −1.21E−06 | −4.18E−08 | −2.21E−07 | −1.11E−08 | −6.64E−11 | −1.87E−09 |

### Embodiment 18

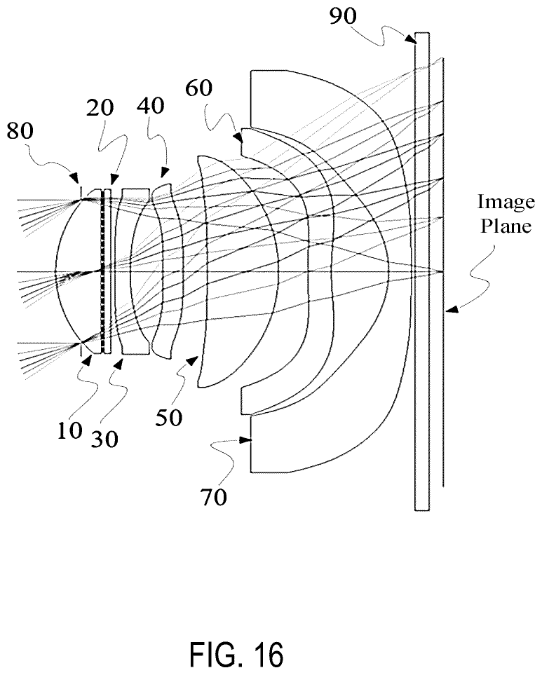

In one embodiment, embodiment 18 provides an optical system, and the optical system is shown in FIG. 16. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 18-1. The curvature, thickness, refractive index, and other parameter item of each lens in the optical system are shown in Table 18-2. The aspherical coefficients of each surface of each lens in the optical system are shown in Table 18-3-1 and Table 18-3-2, and the aspheric coefficients are shown in formula (9).

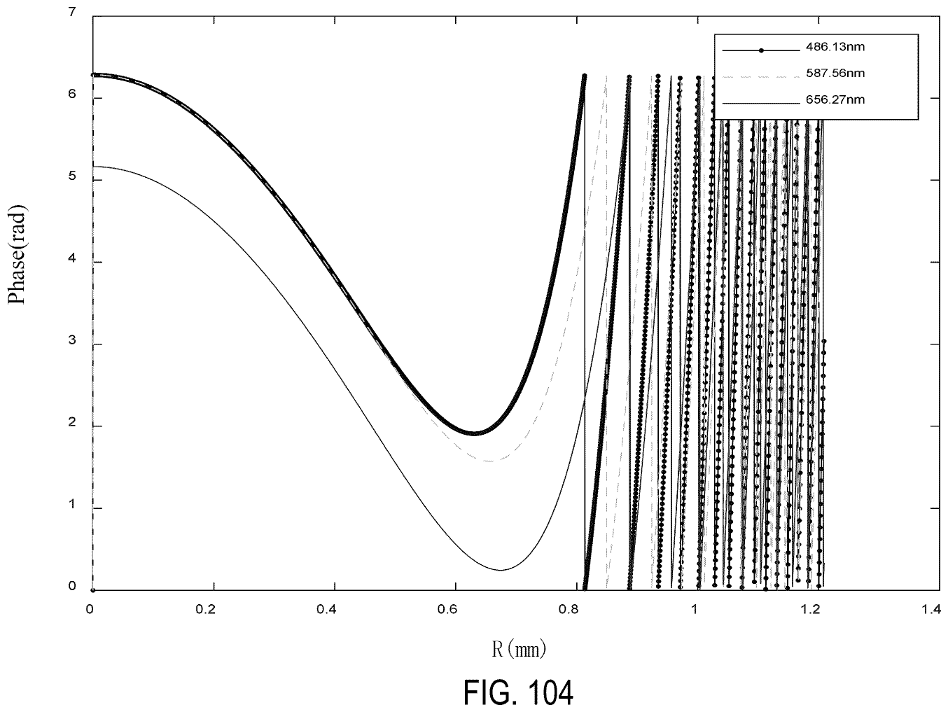

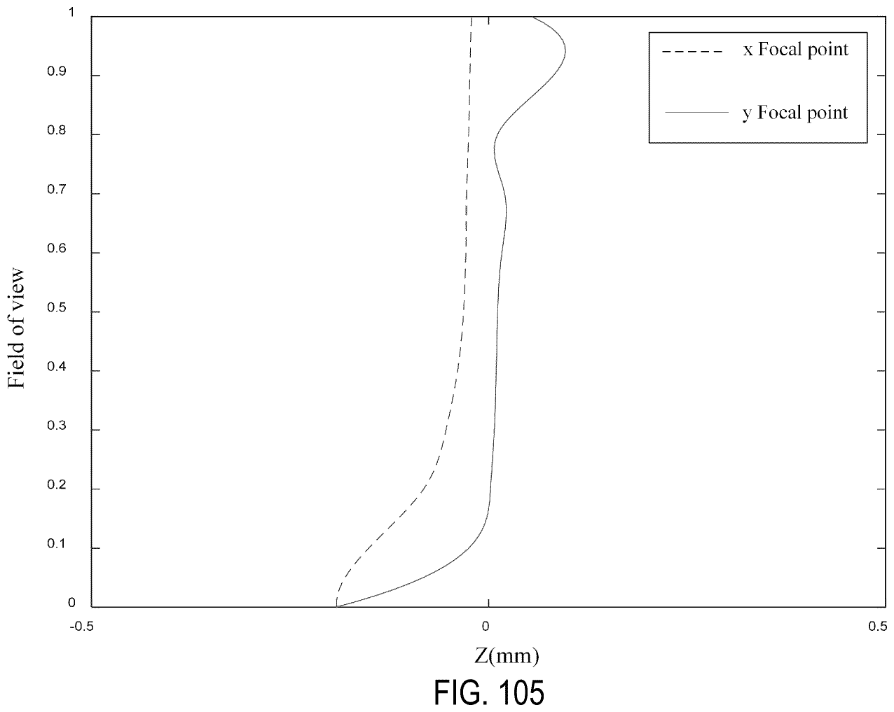

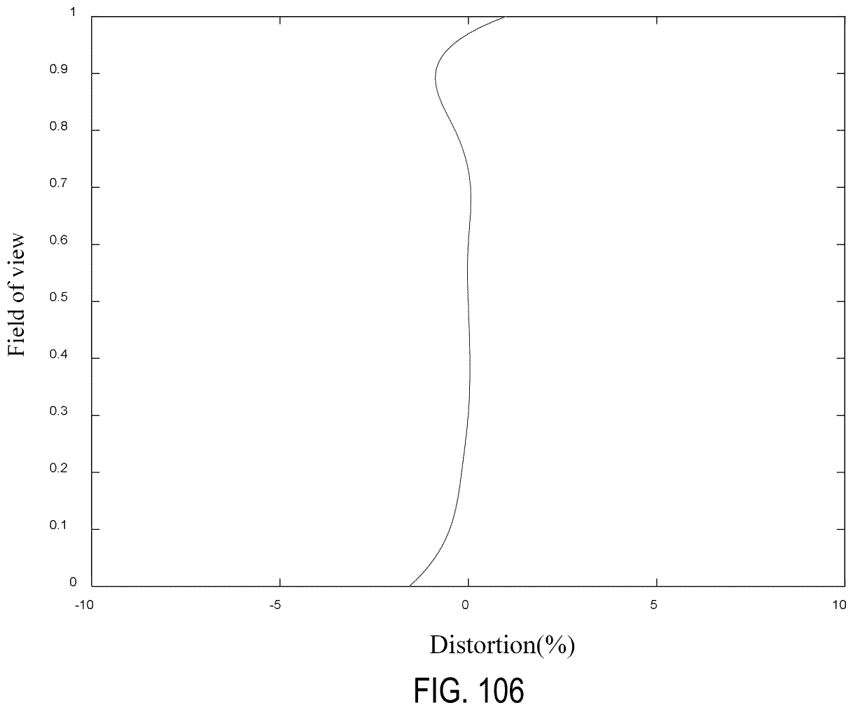

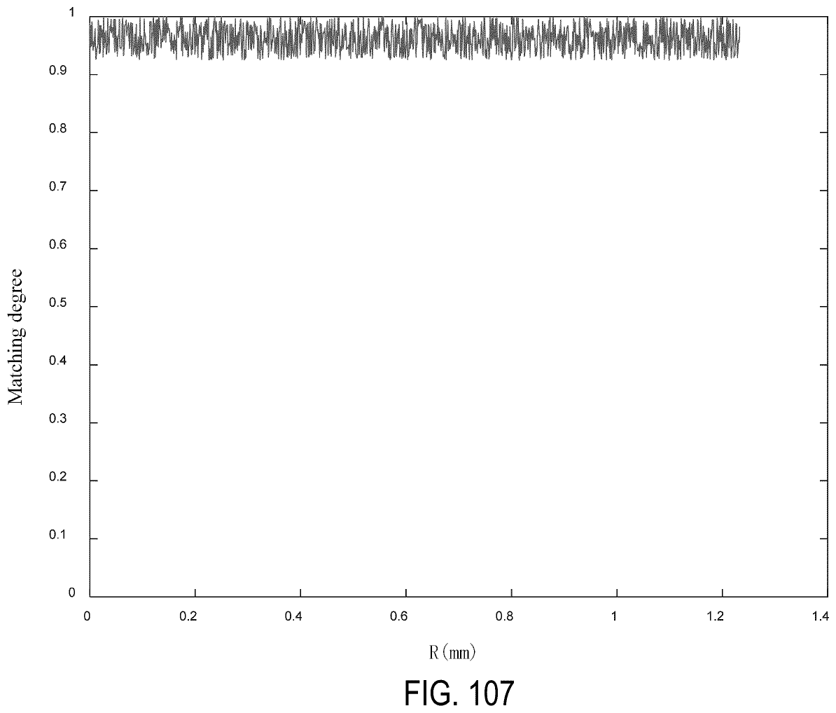

FIG. 104 shows a phase modulation diagram of the metalens in the optical system provided by embodiment 18 at the wavelengths of 486.13 nm, 587.56 nm, and 656.27 nm. It can be seen in FIG. 104 that the phases cover 0-2π of the metalens at different wavelengths. FIG. 105 shows an astigmatism diagram of the optical system. According to FIG. 105, the astigmatism of the optical system at the different fields of view from 0 to 1 is less than 0.5 mm. FIG. 106 shows a distortion diagram of the optical system. According to FIG. 106, the distortion of the optical system at the different fields of view from 0 to 1 is less than 5%. FIG. 107 shows the matching degree of the wide spectrum of the metalens in the optical system in embodiment 18. According to FIG. 107, the real phase of embodiment 18 and the theoretical phase is greater than 90%. The optical system in embodiment 18 has a high MTF and has good control of astigmatism and distortion, therefore the optical system has good imaging quality.

TABLE 18-1

| Parameter item | Parameter value |
|---|---|
| Working wavelength(WL) | VIS(400-700 nm) |
| Effective focal length(EFL) | 4.63 mm |
| Field of view(2ω) | 74° |
| F number | 2.0 |
| Image height(ImgH) | 3.4896 mm |
| Total track length(TTL) | 5.5 mm |

TABLE 18-2

| Numbered | | Radius | Thickness | |
|---|---|---|---|---|
| surface | Surface type | (mm) | (mm) | Material |
| STO | Spherical surface | Infinite | −3.56E−01 | |
| L₁ₒ | Aspheric surface | 1.9445 | 6.35E−01 | 545000.559000 |
| L₁ᵢ | Aspheric surface | −23.72 | 5.00E−02 | |
| L₂ₒ | Structural surface (metalens) | Infinite | 0.1 | 458000.676000 |
| L₂ᵢ | Spherical surface | Infinite | 5.00E−02 | |
| L₃ₒ | Aspheric surface | 1.70E+01 | 2.20E−01 | 636000.239000 |
| L₃ᵢ | Aspheric surface | 3.37E+00 | 4.68E−01 | |
| L₄ₒ | Aspheric surface | −2.52E+01 | 2.84E−01 | 651000.215000 |
| L₄ᵢ | Aspheric surface | −1.81E+02 | 3.42E−01 | |
| L₅ₒ | Aspheric surface | −2.75E+01 | 1.02E+00 | 544000.559000 |
| L₅ᵢ | Aspheric surface | −2.59E+00 | 0.41428 | |
| L₆ₒ | Aspheric surface | 7.07E+00 | 0.333209 | 651000.215000 |
| L₆ᵢ | Aspheric surface | 4.14E+00 | 0.813517 | |
| L₇ₒ | Aspheric surface | −1.78E+00 | 0.322918 | 544000.559000 |
| L₇ᵢ | Aspheric surface | 5.77086319 | 5.00E−02 | |
| IR filterₒ | Spherical surface | Infinite | 2.00E−01 | 516000.641000 |
| IR filterᵢ | Spherical surface | Infinite | 0.2 | |
| Image plane | Spherical surface | Infinite | 0 | |

TABLE 18-3-1

| Numbered surface | L₁ₒ | L₁ᵢ | L₃ₒ | L₃ᵢ | L₄ₒ | L₄ᵢ |
|---|---|---|---|---|---|---|
| K | −0.00937 | −50844048.9 | 175.4288621 | 3.3768256 | −9.59E+14 | −569396 |
| A | −0.00448 | −0.01352315 | −0.03389375 | −0.0392 | −1.24E−01 | −0.11681 |
| B | 1.93E−02 | 0.049716074 | 0.101936591 | 9.74E−02 | 2.15E−02 | 1.72E−02 |
| C | −0.03422 | −5.95E−02 | −8.54E−02 | −8.01E−02 | −2.18E−02 | −3.12E−04 |
| D | 0.031038 | 3.94E−02 | 4.05E−02 | 3.69E−02 | 2.03E−02 | 5.28E−03 |
| E | −0.01055 | −1.09E−02 | −4.83E−03 | −1.56E−03 | −1.31E−03 | 5.82E−04 |
| F | −0.00132 | −0.00130692 | −0.00221665 | 0.0011397 | 7.18E−05 | 9.21E−04 |
| G | 0.001248 | 0.001097293 | −0.00042836 | −1.90E−03 | 5.97E−04 | −5.49E−04 |

TABLE 18-3-2

| Numbered surface | L₅ₒ | L₅ᵢ | L₆ₒ | L₆ᵢ | L₇ₒ | L₇ᵢ |
|---|---|---|---|---|---|---|
| K | −3.28E+08 | 0.805248 | −101.577 | −38.4601 | −1.13928 | −51359.6 |
| A | −1.43E−02 | 4.38E−04 | −0.08421 | −0.06576 | −0.04311 | −0.03212 |
| B | −2.52E−02 | −1.43E−03 | 0.005672 | 0.006348 | 0.024023 | 0.008859 |
| C | 2.29E−02 | 2.09E−03 | 0.00182 | 0.001183 | −0.00454 | −0.00106 |
| D | −6.43E−03 | −6.52E−04 | −0.00098 | −0.00046 | 0.000403 | 2.29E−07 |
| E | 5.74E−04 | 1.71E−04 | −1.60E−04 | −2.20E−05 | −3.72E−05 | 4.12E−06 |
| F | −1.68E−05 | 4.29E−06 | 3.30E−05 | 1.20E−05 | 2.00E−06 | 2.51E−07 |
| G | 3.16E−06 | −7.85E−06 | 3.20E−06 | −6.53E−07 | −4.09E−07 | −3.12E−08 |

### Embodiment 19

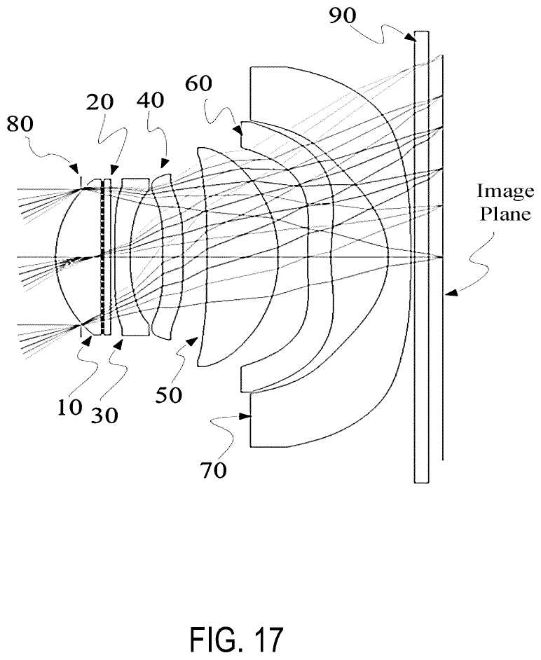

In one embodiment, embodiment 19 provides an optical system, and the optical system is shown in FIG. 17. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 19-1. The curvature, thickness, refractive index, and other parameter item of each lens in the optical system are shown in Table 19-2. The aspherical coefficients of each surface of each lens in the optical system are shown in Table 19-3-1 and Table 19-3-2, and the aspheric coefficients are shown in formula (9).

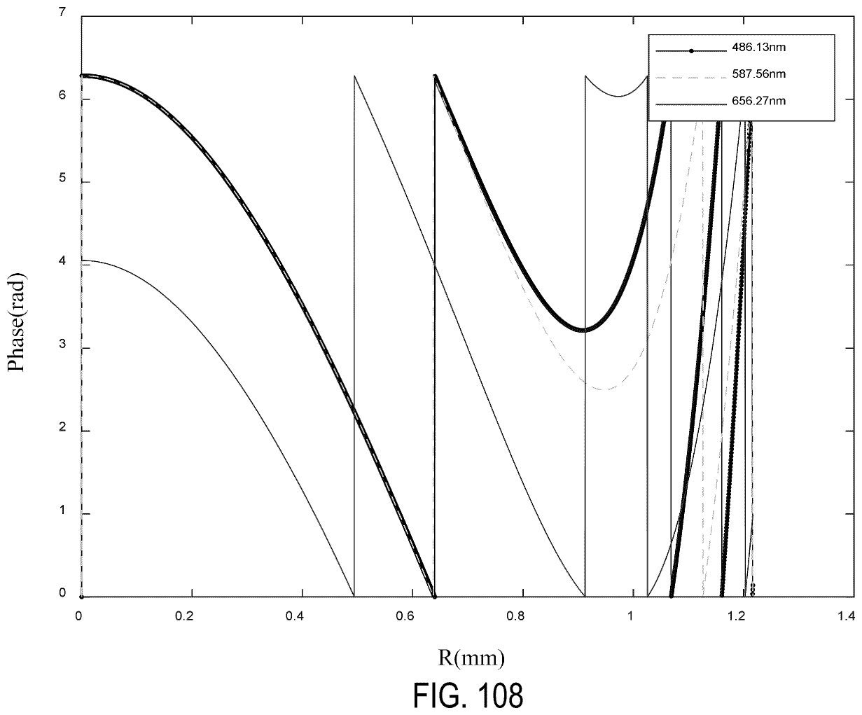

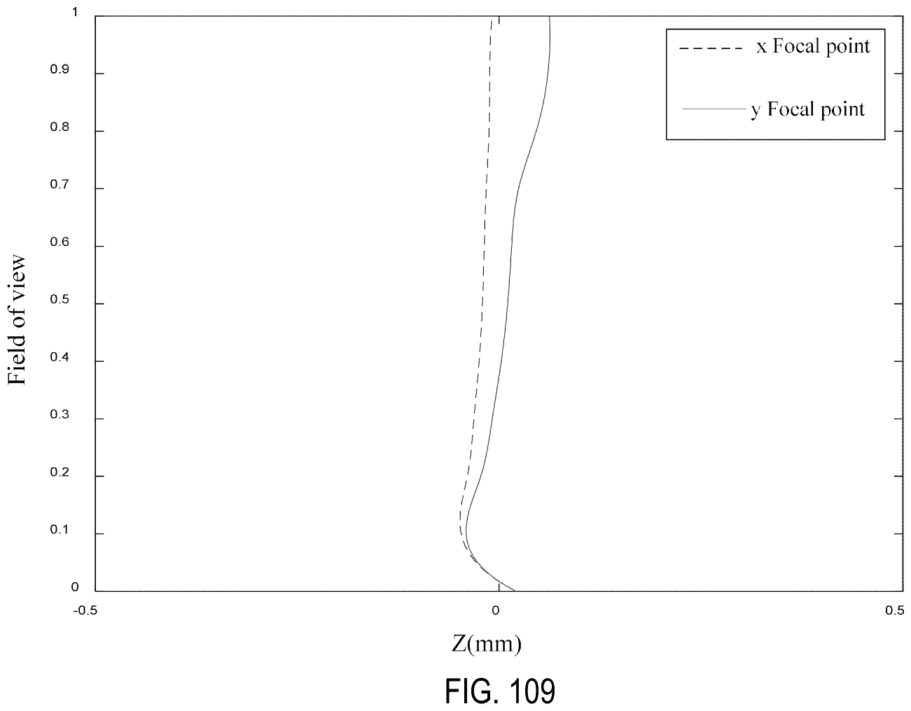

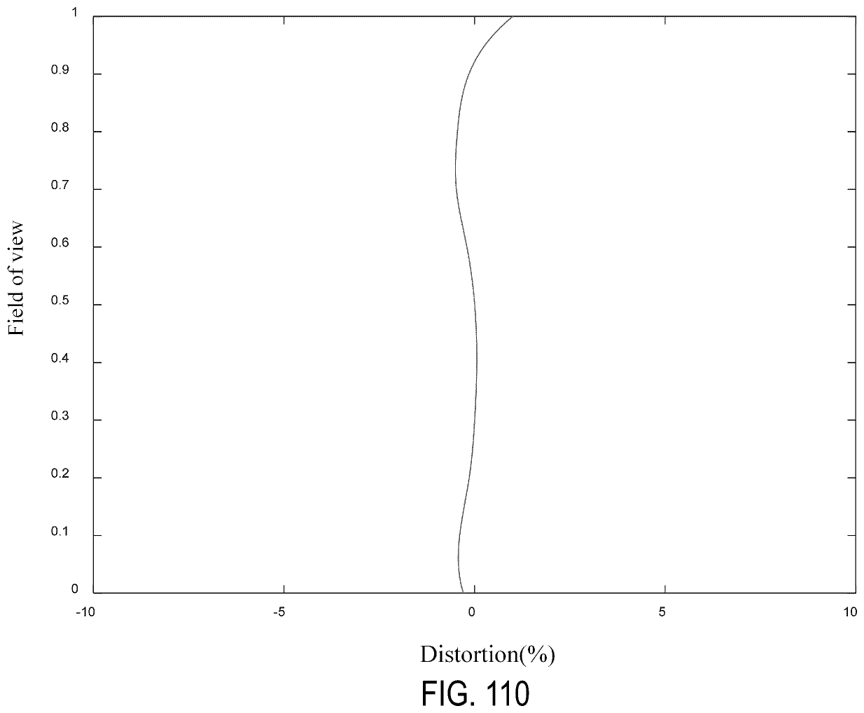

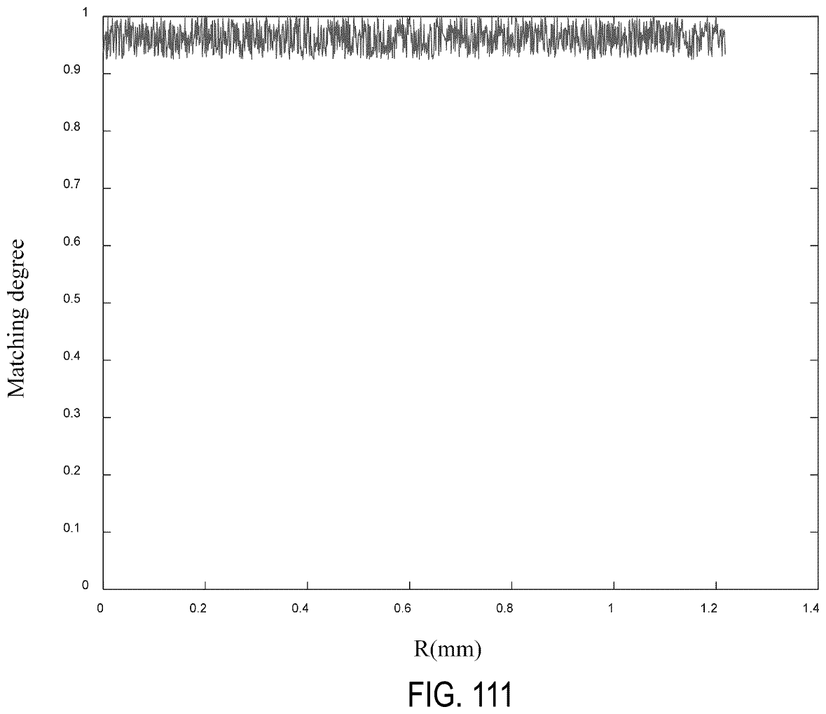

FIG. 108 shows a phase modulation diagram of the metalens in the optical system provided by embodiment 19 at the wavelengths of 486.13 nm, 587.56 nm, and 656.27 nm. It can be seen in FIG. 108 that the phases cover 0-2π of the metalens at different wavelengths. FIG. 109 shows an astigmatism diagram of the optical system. According to FIG. 109, the astigmatism of the optical system at the different fields of view from 0 to 1 is less than 0.5 mm. FIG. 110 shows a distortion diagram of the optical system. According to FIG. 110, the distortion of the optical system at the different fields of view from 0 to 1 is less than 5%. FIG. 111 shows the matching degree of the wide spectrum of the metalens in the optical system in embodiment 19. According to FIG. 111, the real phase of embodiment 19 and the theoretical phase is greater than 90%. The optical system in embodiment 19 has a high MTF and has good control of astigmatism and distortion, therefore the optical system has good imaging quality.

TABLE 19-1

| Parameter item | Parameter value |
|---|---|
| Working wavelength(WL) | VIS(400-700 nm) |
| Effective focal length(EFL) | 4.63 mm |
| Field of view(2ω) | 74° |
| F number | 2.0 |
| Image height(ImgH) | 3.4896 mm |
| Total track length(TTL) | 5.5 mm |

TABLE 19-2

| Numbered | | Radius | Thickness | |
|---|---|---|---|---|
| surface | Surface type | (mm) | (mm) | Material |
| ST0 | Spherical surface | Infinite | −0.3562 | |
| L₁ₒ | Aspheric surface | 1.9045 | 6.66E−01 | 545000.559000 |
| L₁ᵢ | Aspheric surface | −143.163 | 0.05 | |
| L₂ₒ | Structural surface (metalens) | Infinite | 0.1 | 458000.676000 |
| L₂ᵢ | Spherical surface | Infinite | 5.00E−02 | |
| L₃ₒ | Aspheric surface | 1.53E+01 | 2.20E−01 | 636000.239000 |
| L₃ᵢ | Aspheric surface | 3.25E+00 | 5.31E−01 | |
| L₄ₒ | Aspheric surface | −165.296094 | 3.15E−01 | 651000.215000 |
| L₄ᵢ | Aspheric surface | 1.83E+01 | 2.96E−01 | |
| L₅ₒ | Aspheric surface | −5.30E+01 | 0.921621 | 544000.559000 |
| L₅ᵢ | Aspheric surface | −2.87E+00 | 0.229714 | |
| L₆ₒ | Aspheric surface | 2.82E+00 | 0.334469 | 651000.215000 |
| L₆ᵢ | Aspheric surface | 2.62E+00 | 1.099616 | |
| L₇ₒ | Aspheric surface | −1.83E+00 | 2.36E−01 | 544000.559000 |
| L₇ᵢ | Aspheric surface | −16.0401726 | 0.05 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 19-3-1

| Numbered surface | L₁ₒ | L₁ᵢ | L₃ₒ | L₃ᵢ | L₄ₒ | L₄ᵢ |
|---|---|---|---|---|---|---|
| K | −0.01077 | −50844043 | 139.4629578 | 3.3487142 | −3.32E+19 | 73.9699 |
| A | −0.00523 | −0.01601111 | −0.02748669 | −0.029833 | −0.147366 | −0.13752 |
| B | 0.021565 | 0.054461849 | 0.093722267 | 0.0856045 | 3.44E−02 | 0.022798 |
| C | −0.03869 | −0.06620372 | −0.08829112 | −0.073872 | −3.32E−02 | −0.00721 |
| D | 3.19E−02 | 0.03997296 | 0.041186059 | 3.52E−02 | 1.29E−02 | 3.09E−03 |
| E | −0.00944 | −9.42E−03 | −4.07E−03 | −4.42E−03 | −2.57E−03 | −8.55E−06 |
| F | −0.00151 | −1.24E−03 | −1.88E−03 | 1.12E−03 | 1.02E−03 | 8.76E−04 |
| G | 0.000705 | 2.21E−04 | −3.29E−04 | −3.63E−04 | 1.60E−03 | −2.57E−05 |

TABLE 19-3-2

| Numbered | | | | | | |
|---|---|---|---|---|---|---|
| surface | L₅ₒ | L₅ᵢ | L₆ₒ | L₆ᵢ | L₇ₒ | L₇ᵢ |
| K | −3.3E+08 | 0.47276 | −0.69673 | −4.00838 | −0.56602 | −51359.6 |
| A | 0.001006 | 0.004594 | −0.07502 | −0.04903 | −0.00873 | −0.03567 |
| B | −3.03E−02 | −3.77E−05 | 0.003565 | 0.000336 | 0.006435 | 0.006788 |
| C | 2.27E−02 | 2.31E−03 | 0.000466 | 0.001275 | −0.00026 | −0.00084 |
| D | −6.30E−03 | −8.45E−04 | −0.00013 | −0.00018 | 2.00E−05 | 2.78E−05 |
| E | 6.44E−04 | 1.16E−04 | −2.03E−05 | −1.60E−05 | 7.52E−06 | 4.28E−06 |
| F | −6.71E−06 | −4.55E−06 | −1.18E−05 | −8.07E−07 | 3.72E−06 | 6.17E−08 |
| G | −2.64E−07 | −2.98E−06 | −3.03E−06 | 3.71E−07 | −1.24E−06 | −5.88E−08 |

### Embodiment 20

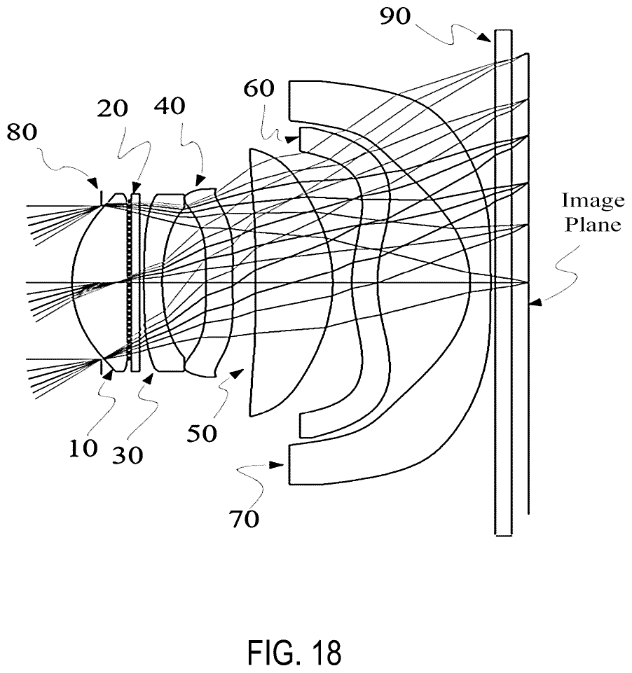

In one embodiment, embodiment 20 provides an optical system, and the optical system is shown in FIG. 18. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 20-1. The curvature, thickness, refractive index, and other parameter item of each lens in the optical system are shown in Table 20-2. The aspherical coefficients of each surface of each lens in the optical system are shown in Table 20-3-1 and Table 20-3-2, and the aspheric coefficients are shown in formula (9).

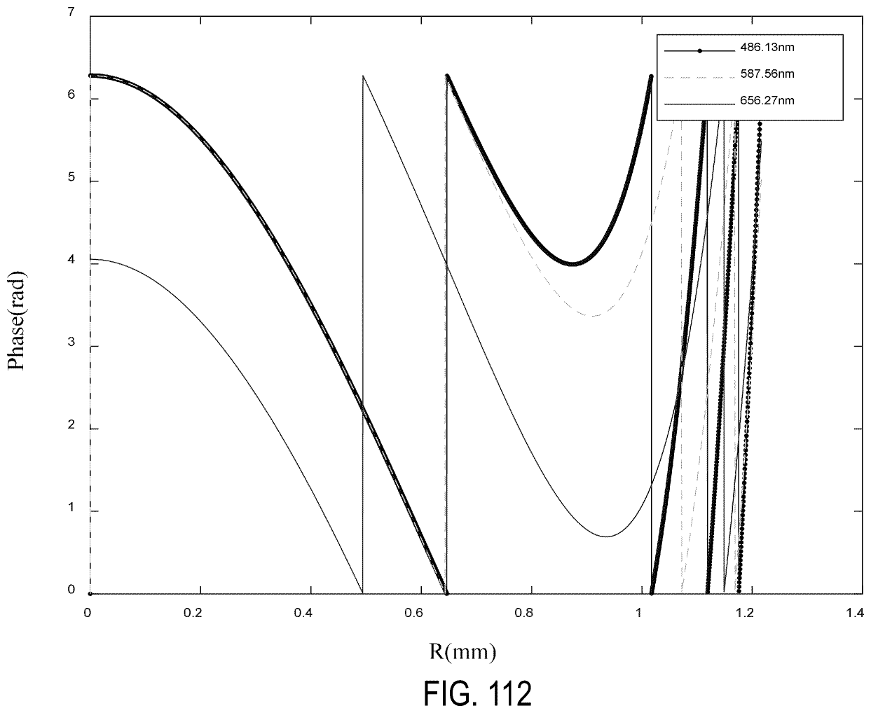

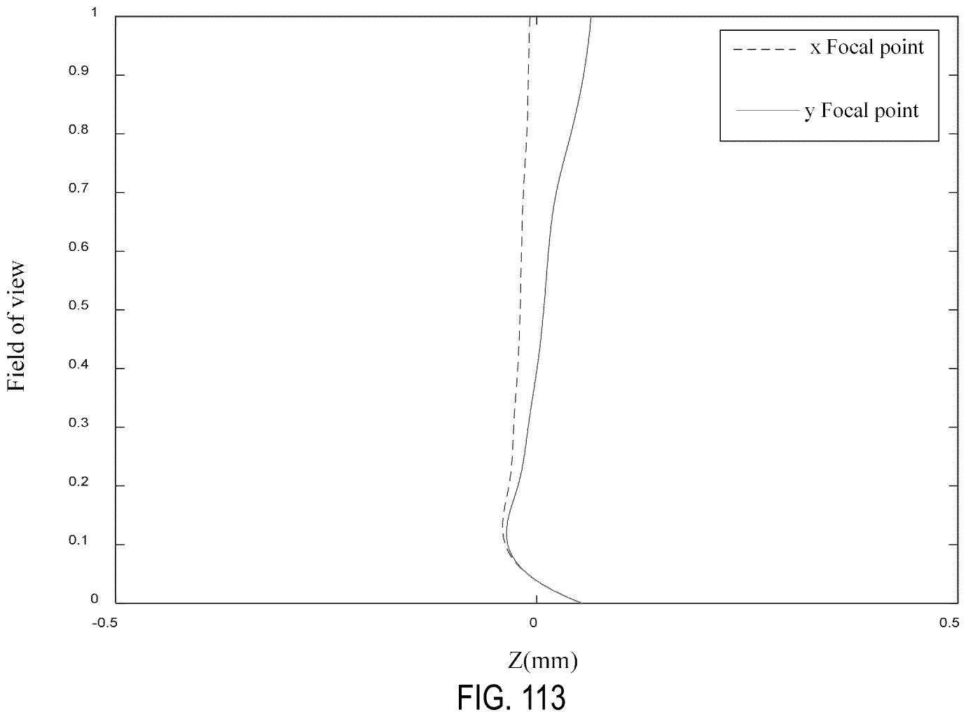

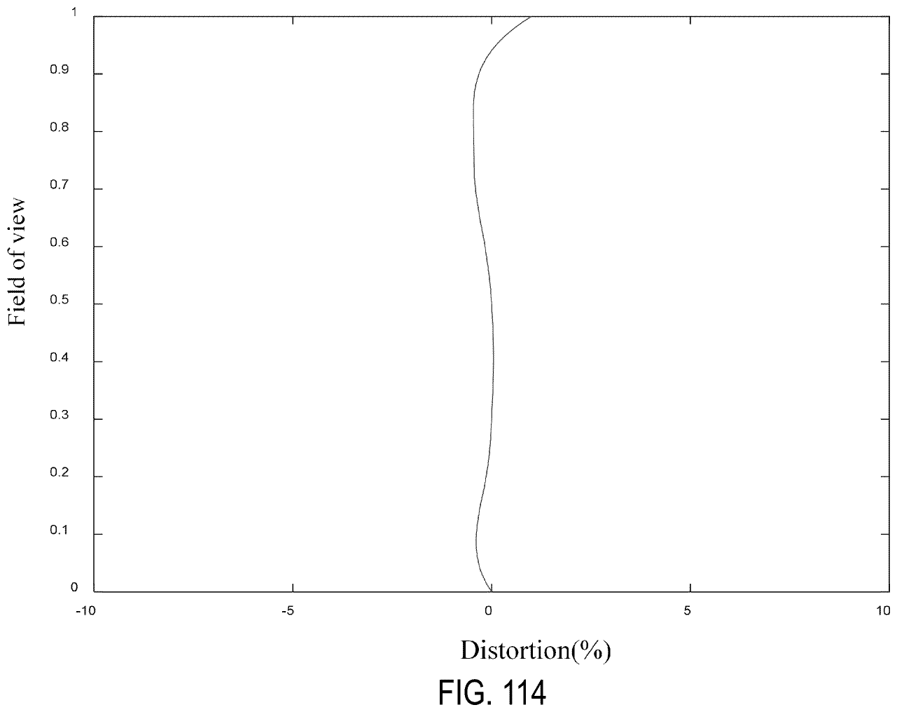

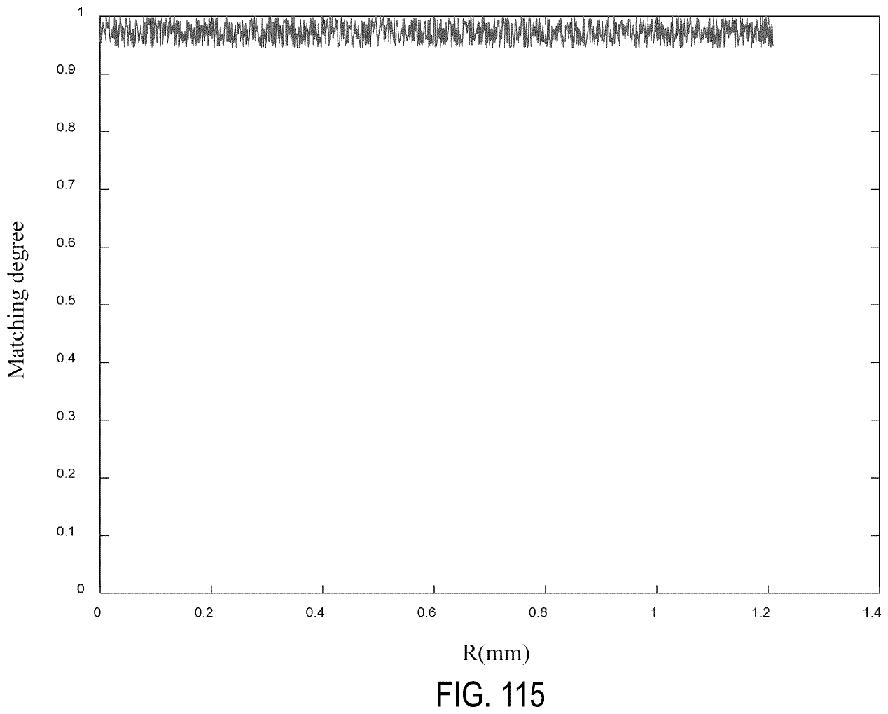

FIG. 112 shows a phase modulation diagram of the metalens in the optical system provided by embodiment 19 at the wavelengths of 486.13 nm, 587.56 nm, and 656.27 nm. It can be seen in FIG. 112 that the phases cover 0-2π of the metalens at different wavelengths. FIG. 113 shows an astigmatism diagram of the optical system. According to FIG. 113, the astigmatism of the optical system at the different fields of view from 0 to 1 is less than 0.5 mm. FIG. 114 shows a distortion diagram of the optical system. According to FIG. 114, the distortion of the optical system at the different fields of view from 0 to 1 is less than 5%. FIG. 115 shows the matching degree of the wide spectrum of the metalens in the optical system in embodiment 20. According to FIG. 115, the real phase of embodiment 20 and the theoretical phase is greater than 90%. The optical system in embodiment 20 has a high MTF and has good control of astigmatism and distortion, therefore the optical system has good imaging quality.

TABLE 20-1

| Parameter item | Parameter value |
|---|---|
| Working wavelength(WL) | VIS(400-700 nm) |
| Effective focal length(EFL) | 4.63 mm |
| Field of view(ω) | 74° |
| F number | 2.0 |
| Image height(ImgH) | 3.4896 mm |
| Total track length(TTL) | 5.5 mm |

TABLE 20-2

| Numbered | | Radius | Thickness | |
|---|---|---|---|---|
| surface | Surface type | (mm) | (mm) | Material |
| ST0 | Spherical surface | Infinite | −0.3562 | |
| L₁ₒ | Aspheric surface | 1.9040 | 6.64E−01 | 545000.559000 |
| L₁ᵢ | Aspheric surface | −180.76 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 1.53E+01 | 2.20E−01 | 636000.239000 |
| L₃ᵢ | Aspheric surface | 3.260652088 | 5.27E−01 | |
| L₄ₒ | Aspheric surface | −546.4470297 | 3.21E−01 | 651000.215000 |
| L₄ᵢ | Aspheric surface | 15.72582041 | 2.73E−01 | |
| L₅ₒ | Aspheric surface | −45.6361754 | 0.932106261 | 544000.559000 |
| L₅ᵢ | Aspheric surface | −2.78E+00 | 2.31E−01 | |
| L₆ₒ | Aspheric surface | 2.72E+00 | 3.06E−01 | 651000.215000 |
| L₆ᵢ | Aspheric surface | 2.55E+00 | 1.12E+00 | |
| L₇ₒ | Aspheric surface | −1.82E+00 | 2.48E−01 | 544000.559000 |
| L₇ᵢ | Aspheric surface | −1.68E+01 | 5.47E−02 | |
| IR filterₒ | Spherical surface | Infinite | 2.00E−01 | 516000.641000 |
| IR filterᵢ | Spherical surface | Infinite | 0.203865473 | |
| Image plane | Spherical surface | Infinite | 0 | |

TABLE 20-3-1

| Numbered | | | | | | |
|---|---|---|---|---|---|---|
| surface | L₁ₒ | L₁ᵢ | L₃ₒ | L₃ᵢ | L₄ₒ | L₄ᵢ |
| K | −0.00960967 | −5.0872E7 | 139.36457 | 3.31E+00 | −4.3E+12 | 106.9743 |
| A | −0.00519191 | −0.01595 | −0.027428 | −0.030131 | −0.14748 | −0.13869 |
| B | 0.021558041 | 0.054561503 | 0.0937156 | 8.54E−02 | 0.035705 | 2.25E−02 |
| C | −0.03867382 | −0.06624 | −0.08827 | −7.38E−02 | −0.03318 | −7.20E−03 |
| D | 0.031896129 | 0.039974607 | 4.12E−02 | 3.52E−02 | 1.28E−02 | 3.08E−03 |
| E | −9.43E−03 | −9.42E−03 | −4.05E−03 | −4.47E−03 | −2.57E−03 | −3.11E−05 |
| F | −1.51E−03 | −1.25E−03 | −1.88E−03 | 1.12E−03 | 1.07E−03 | 8.50E−04 |
| G | 7.02E−04 | 2.15E−04 | −3.42E−04 | −3.38E−04 | 1.60E−03 | −3.86E−05 |

TABLE 20-3-2

| Numbered | | | | | | |
|---|---|---|---|---|---|---|
| surface | L₅ₒ | L₅ᵢ | L₆ₒ | L₆ᵢ | L₇ₒ | L₇ᵢ |
| K | −3.297E8 | 0.491343 | −0.96239 | −3.82611 | −0.58087 | −51286.8 |
| A | 0.001467237 | 0.008419 | −0.07318 | −0.05021 | −0.00851 | −0.03513 |
| B | −3.04E−02 | −0.00025 | 0.003081 | 0.000174 | 0.006551 | 0.006847 |
| C | 2.26E−02 | 0.00231 | 0.000448 | 0.001251 | −0.00038 | −0.00083 |
| D | −6.30E−03 | −0.00084 | −0.00013 | −1.80E−04 | 2.50E−05 | 2.57E−05 |
| E | 6.43E−04 | 1.16E−04 | −1.93E−05 | −1.56E−05 | 8.34E−06 | 3.58E−06 |
| F | −6.53E−06 | −4.27E−06 | −1.09E−05 | −8.94E−07 | 3.75E−06 | 5.70E−08 |
| G | −5.08E−08 | −2.87E−06 | −2.70E−06 | 3.22E−07 | −1.31E−06 | −4.92E−08 |

### Embodiment 21

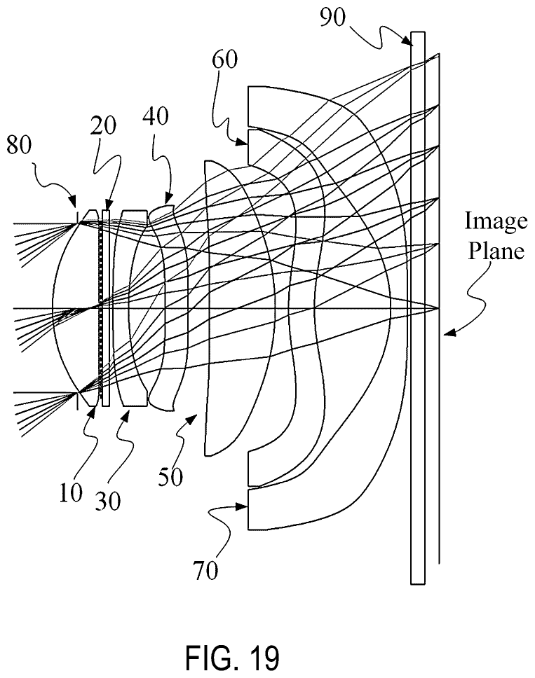

In one embodiment, embodiment 21 provides an optical system, and the optical system is shown in FIG. 19. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 21-1. The curvature, thickness, refractive index, and other parameter item of each lens in the optical system are shown in Table 21-2. The aspherical coefficients of each surface of each lens in the optical system are shown in Table 21-3-1 and Table 21-3-2, and the aspheric coefficients are shown in formula (9).

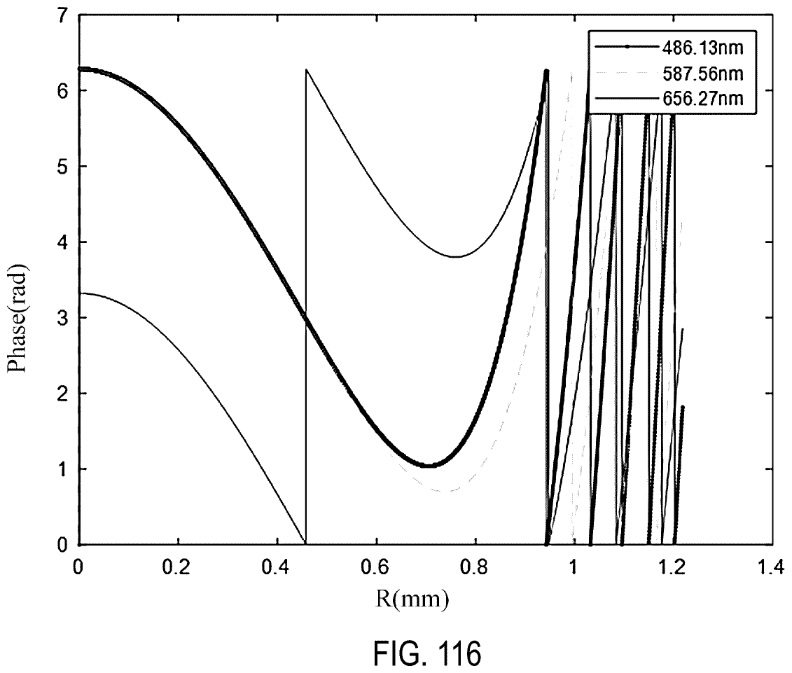

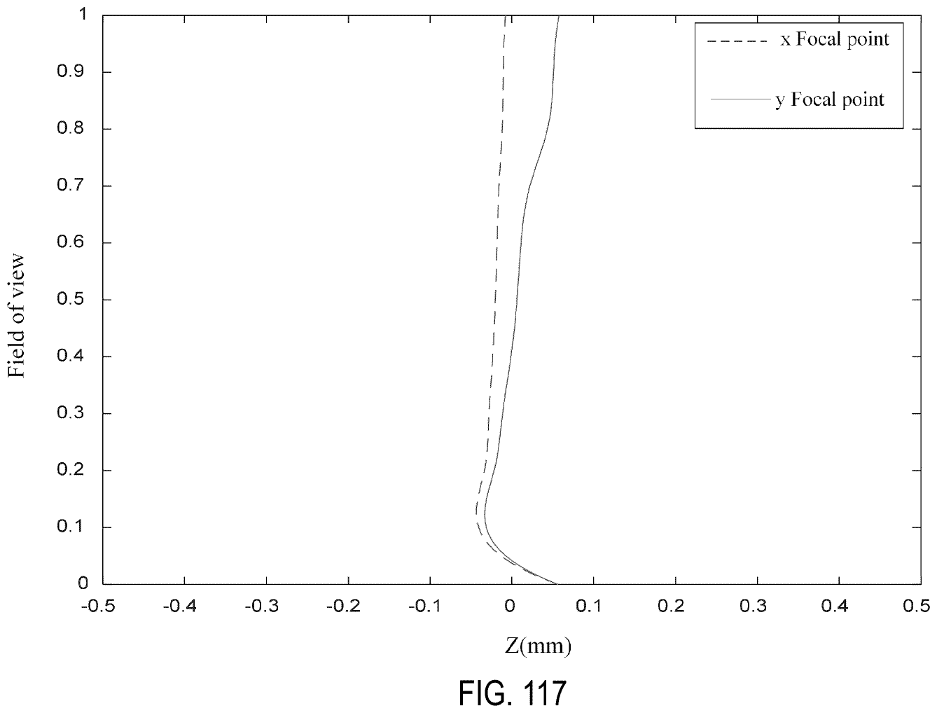

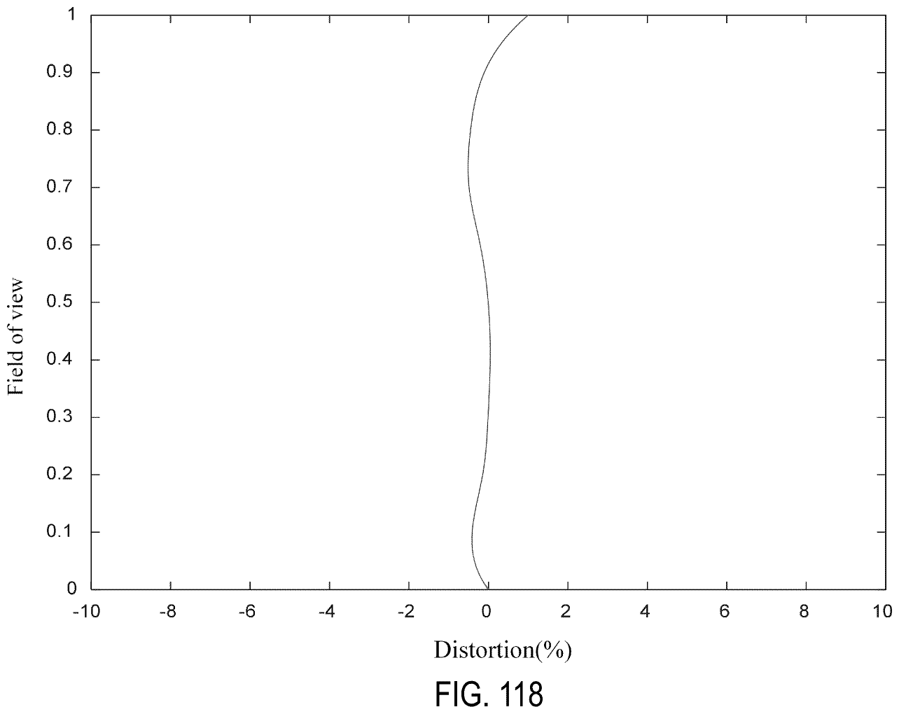

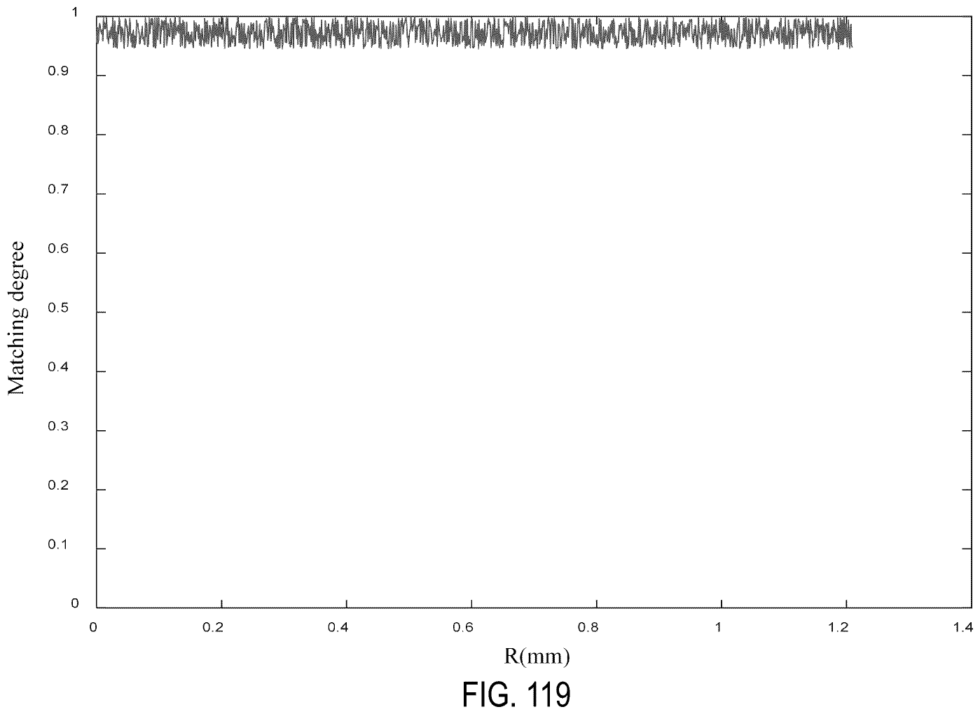

FIG. 116 shows a phase modulation diagram of the metalens in the optical system provided by embodiment 21 at the wavelengths of 486.13 nm, 587.56 nm, and 656.27 nm. It can be seen in FIG. 116 that the phases cover 0-2π of the metalens at different wavelengths. FIG. 117 shows an astigmatism diagram of the optical system. According to FIG. 117, the astigmatism of the optical system at the different fields of view from 0 to 1 is less than 0.5 mm. FIG. 118 shows a distortion diagram of the optical system. According to FIG. 118, the distortion of the optical system at the different fields of view from 0 to 1 is less than 5%. FIG. 119 shows the matching degree of the wide spectrum of the metalens in the optical system in embodiment 21. According to FIG. 119, the real phase of embodiment 21 and the theoretical phase is greater than 90%. The optical system in embodiment 21 has a high MTF and has good control of astigmatism and distortion, therefore the optical system has good imaging quality.

TABLE 21-1

| Parameter item | Parameter value |
|---|---|
| Working wavelength(WL) | VIS(400-700 nm) |
| Effective focal length(EFL) | 4.63 mm |
| Field of view(ω) | 74° |
| F number | 2.0 |
| Image height(ImgH) | 3.4896 mm |
| Total track length(TTL) | 5.5 mm |

TABLE 21-2

| Numbered | | Radius | Thickness | |
|---|---|---|---|---|
| surface | Surface type | (mm) | (mm) | Material |
| ST0 | Spherical surface | Infinite | −0.3562 | |
| L₁ₒ | Aspheric surface | 1.9043 | 0.657865959 | 545000.559000 |
| L₁ᵢ | Aspheric surface | −181.456 | 5.00E−02 | |
| L₂ₒ | Structural surface (metalens) | Infinite | 1.00E−01 | 458000.676000 |
| L₂ᵢ | Spherical surface | Infinite | 5.00E−02 | |
| L₃ₒ | Aspheric surface | 1.53E+01 | 2.24E−01 | 636000.239000 |
| L₃ᵢ | Aspheric surface | 3.30E+00 | 0.520232022 | |
| L₄ₒ | Aspheric surface | 1.28E+02 | 3.24E−01 | 651000.215000 |
| L₄ᵢ | Aspheric surface | 19.66707 | 3.05E−01 | |
| L₅ₒ | Aspheric surface | −2.72E+01 | 9.37E−01 | 544000.559000 |
| L₅ᵢ | Aspheric surface | −2.90E+00 | 1.90E−01 | |
| L₆ₒ | Aspheric surface | 2.90E+00 | 3.67E−01 | 651000.215000 |
| L₆ᵢ | Aspheric surface | 2.57E+00 | 1.09E+00 | |
| L₇ₒ | Aspheric surface | −1.88662 | 0.23837261 | 544000.559000 |
| L₇ᵢ | Aspheric surface | −1.24E+01 | 0.050003014 | |
| IR filterₒ | Spherical surface | Infinite | 0.2 | 516000.641000 |
| IR filterᵢ | Spherical surface | Infinite | 0.2000 | |
| Image plane | Spherical surface | Infinite | 0.0 | |

TABLE 21-3-1

| Numbered | | | | | | |
|---|---|---|---|---|---|---|
| surface | L₁ₒ | L₁ᵢ | L₃ₒ | L₃ᵢ | L₄ₒ | L₄ᵢ |
| K | −0.01203 | −5.1E+07 | 141.4217 | 2.723381 | −1.5E+08 | −291.779 |
| A | −0.00534 | −0.01522 | −0.02507 | −0.0272 | −0.14561 | −0.13216 |
| B | 0.021506 | 0.054445 | 0.094336 | 0.086731 | 0.034928 | 0.023013 |
| C | −0.03851 | −0.06619 | −0.08832 | −0.07339 | −0.03266 | −0.00701 |
| D | 0.031912 | 0.039988 | 0.0411 | 0.035004 | 0.013593 | 0.003224 |
| E | −0.00942 | −0.00935 | −0.00418 | −0.00422 | −0.0022 | 8.32E−05 |
| F | −0.0015 | −0.00127 | −0.002 | 0.001197 | 0.001194 | 0.000934 |
| G | 0.00071 | 0.000255 | −0.00043 | −0.00058 | 0.001749 | 2.88E−06 |

TABLE 21-3-2

| Numbered | | | | | | |
|---|---|---|---|---|---|---|
| surface | L₅ₒ | L₅ᵢ | L₆ₒ | L₆ᵢ | L₇ₒ | L₇ᵢ |
| K | −3.3E+08 | 0.551277 | −3.03583 | −4.49E+00 | −0.70089 | −51364.7 |
| A | 0.000921 | 0.006845 | −0.06598 | −0.0484 | −0.01062 | −0.03548 |
| B | −0.03035 | 0.000376 | 0.003159 | 0.000666 | 0.006281 | 0.00681 |
| C | 0.022662 | 0.002306 | 0.000564 | 0.001178 | −0.0004 | −0.00085 |
| D | −0.0063 | −0.00087 | −0.00015 | −0.00017 | 1.16E−05 | 2.67E−05 |
| E | 0.00064 | 0.000115 | −1.97E−05 | −1.22E−05 | 6.32E−06 | 4.51E−06 |
| F | −7.23E−06 | −4.48E−06 | −1.37E−05 | −5.74E−07 | 3.59E−06 | 1.21E−07 |
| G | 2.16E−07 | −2.91E−06 | −1.97E−06 | 3.31E−07 | −1.07E−06 | −6.65E−08 |

### Embodiment 22

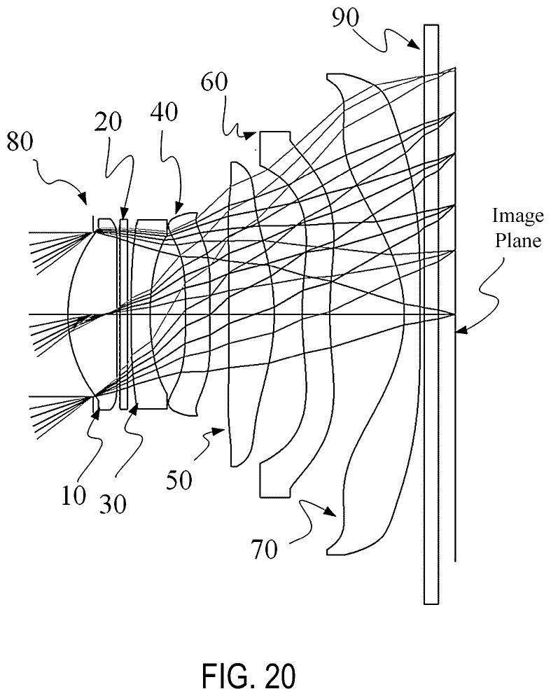

In one embodiment, embodiment 22 provides an optical system, and the optical system is shown in FIG. 20. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 22-1. The curvature, thickness, refractive index, and other parameter item of each lens in the optical system are shown in Table 22-2. The aspherical coefficients of each surface of each lens in the optical system are shown in Table 22-3-1 and Table 22-3-2, and the aspheric coefficients are shown in formula (9).

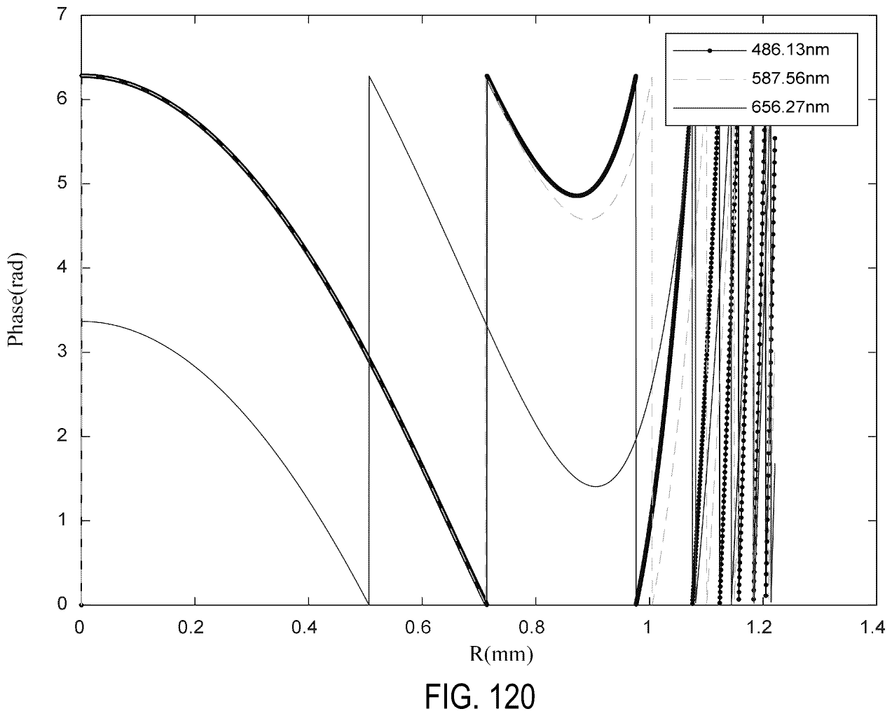

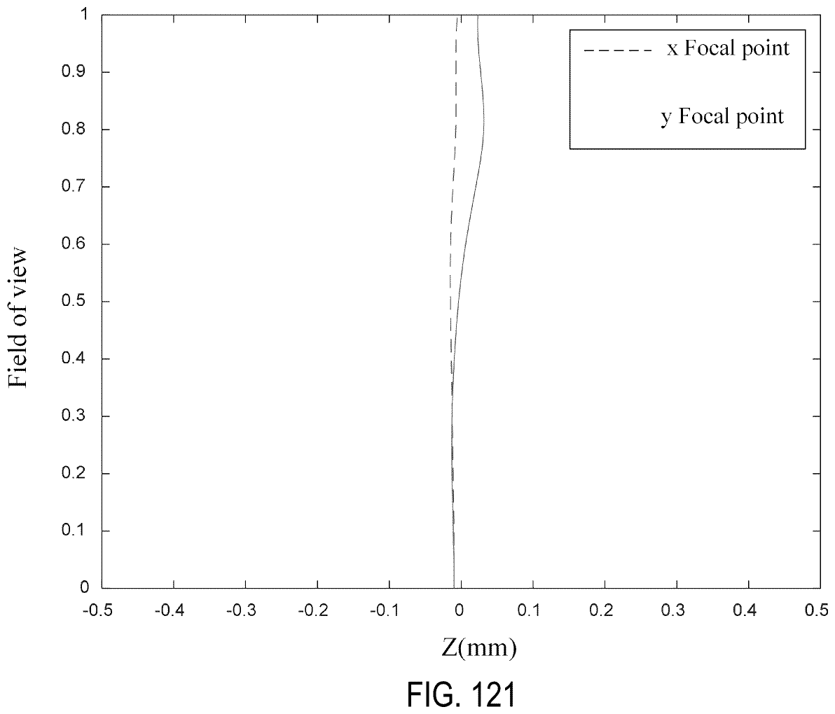

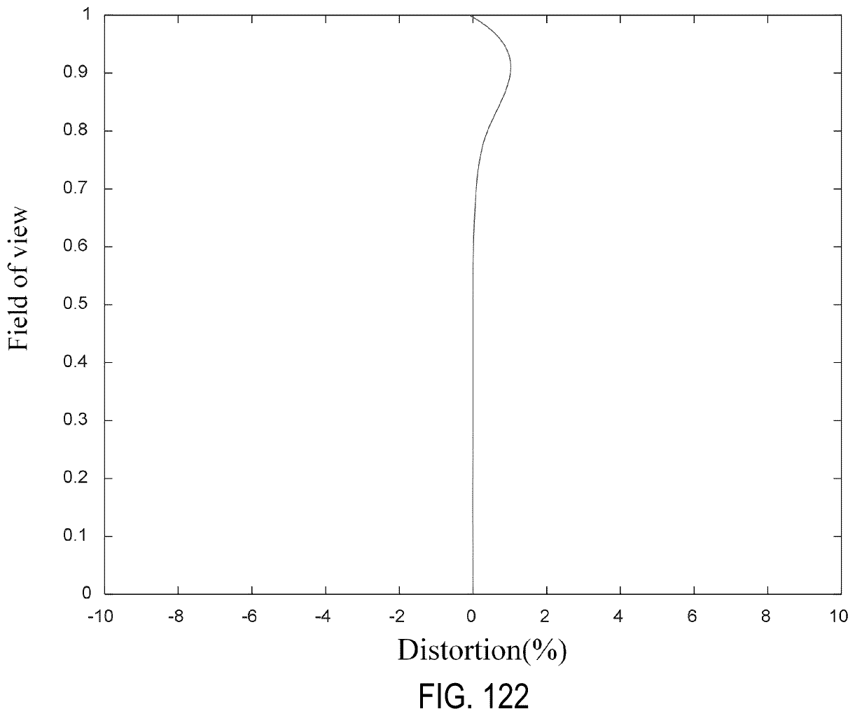

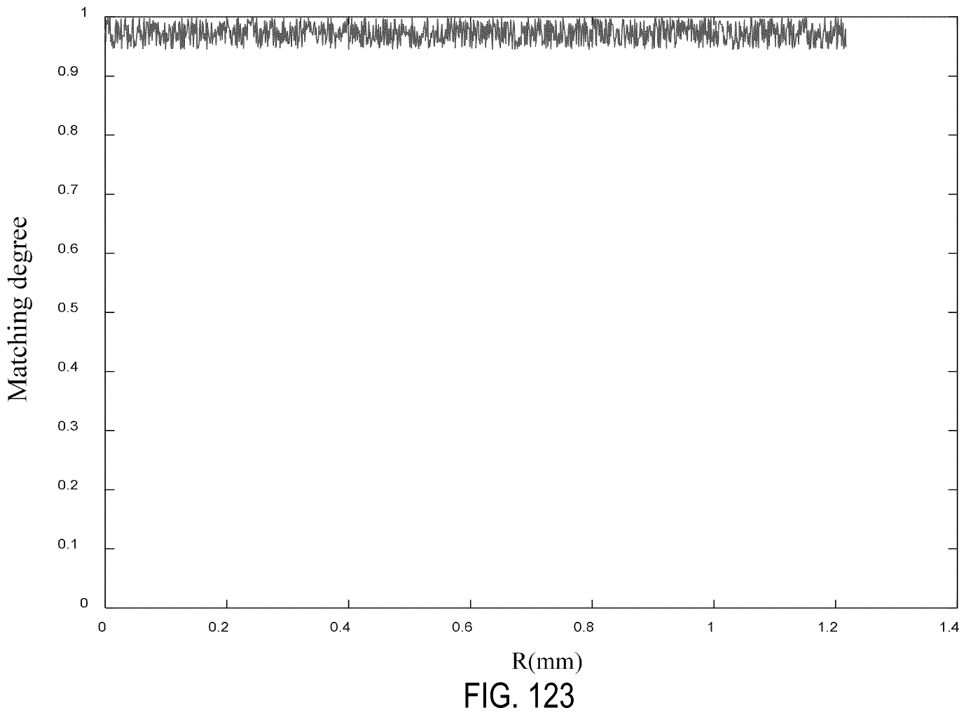

FIG. 120 shows a phase modulation diagram of the metalens in the optical system provided by embodiment 22 at the wavelengths of 486.13 nm, 587.56 nm, and 656.27 nm. It can be seen in FIG. 120 that the phases cover 0-2π of the metalens at different wavelengths. FIG. 121 shows an astigmatism diagram of the optical system. According to FIG. 121, the astigmatism of the optical system at the different fields of view from 0 to 1 is less than 0.5 mm. FIG. 122 shows a distortion diagram of the optical system. According to FIG. 122, the distortion of the optical system at the different fields of view from 0 to 1 is less than 5%. FIG. 123 shows the matching degree of the wide spectrum of the metalens in the optical system in embodiment 22. According to FIG. 123, the real phase of embodiment 22 and the theoretical phase is greater than 90%. The optical system in embodiment 22 has a high MTF and has good control of astigmatism and distortion, therefore the optical system has good imaging quality.

TABLE 22-1

| Parameter item | Parameter value |
|---|---|
| Working wavelength(WL) | VIS(400-700 nm) |
| Effective focal length(EFL) | 4.63 mm |
| Field of view(ω) | 74° |
| F number | 2.0 |
| Image height(ImgH) | 3.4896 mm |
| Total track length(TTL) | 5.5 mm |

TABLE 22-2

| Numbered | | Radius | Thickness | |
|---|---|---|---|---|
| surface | Surface type | (mm) | (mm) | Material |
| ST0 | Spherical surface | Infinite | −0.3562 | |
| L₁ₒ | Aspheric surface | 1.8942 | 0.694982 | 545000.559000 |
| L₁ᵢ | Aspheric surface | −456.81 | 0.050521 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 14.5729 | 0.270279 | 636000.239000 |
| L₃ᵢ | Aspheric surface | 3.232955 | 0.504437 | |
| L₄ₒ | Aspheric surface | −32.9542 | 0.344971 | 651000.215000 |
| L₄ᵢ | Aspheric surface | 14.39599 | 0.267711 | |
| L₅ₒ | Aspheric surface | 103.2699 | 0.643865 | 544000.559000 |
| L₅ᵢ | Aspheric surface | −3.09506 | 0.398399 | |
| L₆ₒ | Aspheric surface | 4.517556 | 0.391674 | 651000.215000 |
| L₆ᵢ | Aspheric surface | 5.108754 | 1.057344 | |
| L₇ₒ | Aspheric surface | −2.02338 | 0.22 | 544000.559000 |
| L₇ᵢ | Aspheric surface | 41.1915 | 0.062854 | |
| IR filterₒ | Spherical surface | Infinite | 0.2 | 516000.641000 |
| IR filterᵢ | Spherical surface | Infinite | 0.242964 | |
| Image plane | Spherical surface | Infinite | 0 | |

TABLE 22-3-1

| Numbered | | | | | | |
|---|---|---|---|---|---|---|
| surface | L₁ₒ | L₁ᵢ | L₃ₒ | L₃ᵢ | L₄ₒ | L₄ᵢ |
| K | 0.00336 | −5.1E+07 | 128.9914 | 2.730243 | −8851.43 | 68.4431 |
| A | −0.00742 | −0.01367 | −0.03338 | −0.03537 | −0.16766 | −0.14177 |
| B | 0.028642 | 0.054643 | 0.089246 | 0.081722 | 0.059958 | 0.024854 |
| C | −0.04465 | −0.06896 | −0.09086 | −0.07273 | −0.03976 | −0.00627 |
| D | 0.032273 | 0.039578 | 0.040616 | 0.035592 | 1.25E−02 | 0.003375 |
| E | −0.00754 | −0.0092 | −0.00409 | −0.00637 | 0.000589 | 9.97E−05 |
| F | −0.00153 | −0.00123 | −0.00186 | 0.001165 | 1.51E−03 | 7.39E−04 |
| G | 0.000188 | 2.85E−05 | −0.00027 | 0.000306 | 0.000729 | −3.88E−05 |

TABLE 22-3-2

| Numbered | | | | | | |
|---|---|---|---|---|---|---|
| surface | L₅ₒ | L₅ᵢ | L₆ₒ | L₆ᵢ | L₇ₒ | L₇ᵢ |
| K | −63988.1 | 0.164305 | −0.35259 | 2.753289 | −0.92699 | −4560.55 |
| A | 0.010053 | 0.014617 | −0.05535 | −0.04521 | 0.007019 | −0.02089 |
| B | −0.03165 | 0.003587 | 0.002515 | −0.00163 | 0.002566 | 0.004683 |
| C | 0.02272 | 0.002291 | −0.00056 | 1.01E−03 | 5.67E−05 | −5.96E−04 |
| D | −0.00622 | −9.21E−04 | 3.24E−05 | −1.19E−04 | −3.63E−05 | 2.28E−05 |
| E | 6.48E−04 | 9.81E−05 | 1.25E−05 | 1.23E−06 | 1.11E−06 | 1.25E−06 |
| F | −8.34E−06 | −3.52E−06 | −2.12E−06 | 1.18E−07 | 1.02E−07 | 4.80E−08 |
| G | −1.01E−06 | −9.47E−07 | −6.91E−07 | 5.26E−08 | −6.67E−09 | −1.24E−08 |

### Embodiment 23

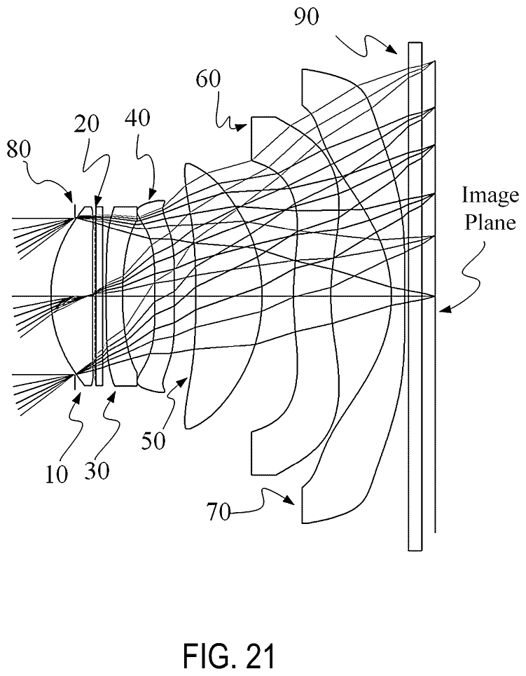

In one embodiment, embodiment 23 provides an optical system, and the optical system is shown in FIG. 21. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 23-1. The curvature, thickness, refractive index, and other parameter item of each lens in the optical system are shown in Table 23-2. The aspherical coefficients of each surface of each lens in the optical system are shown in Table 23-3-1 and Table 23-3-2, and the aspheric coefficients are shown in formula (9).

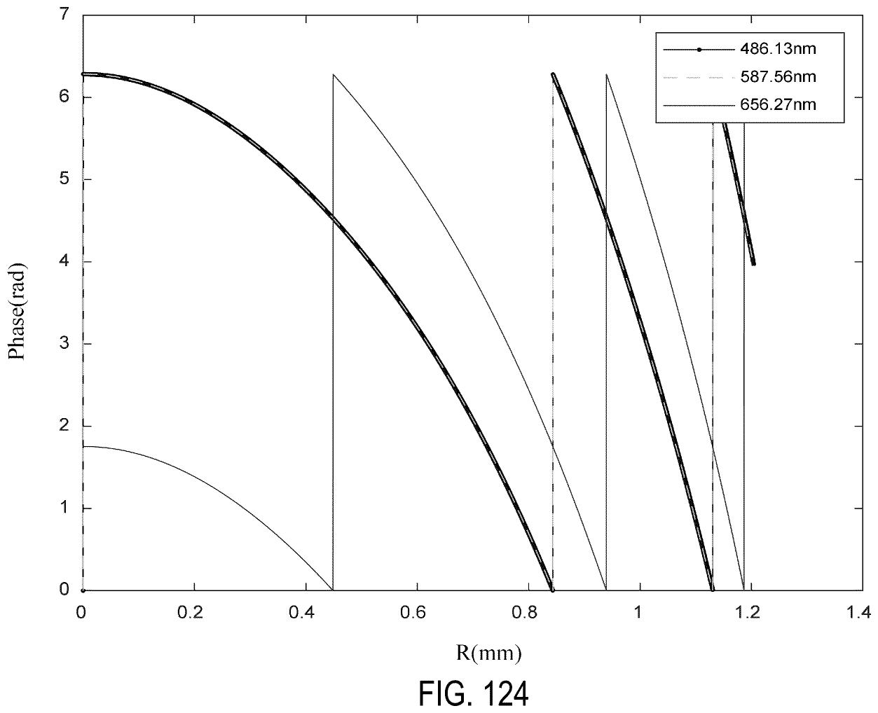

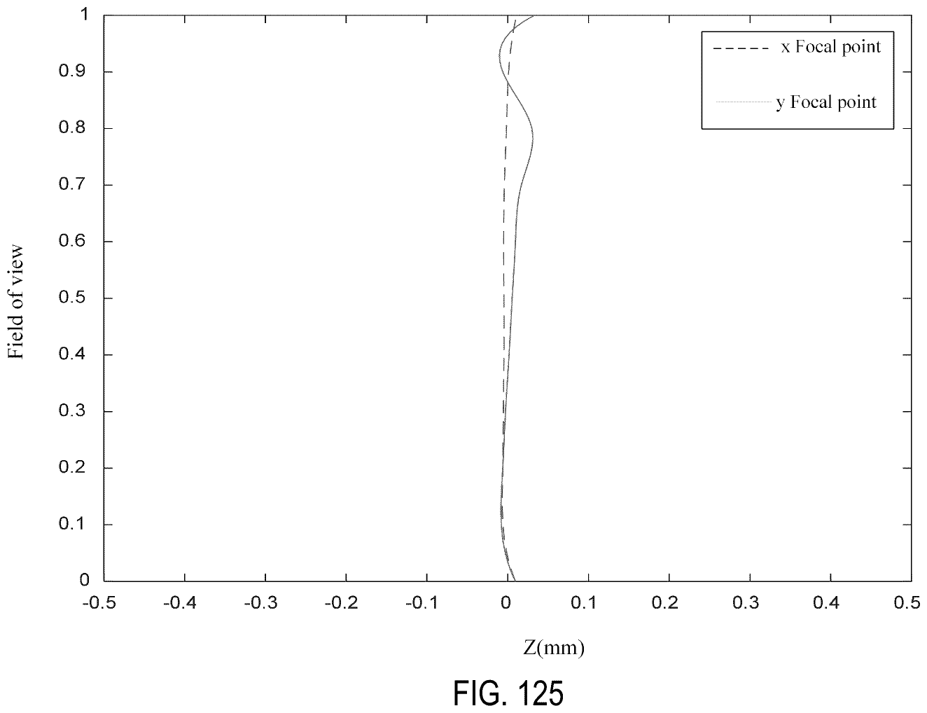

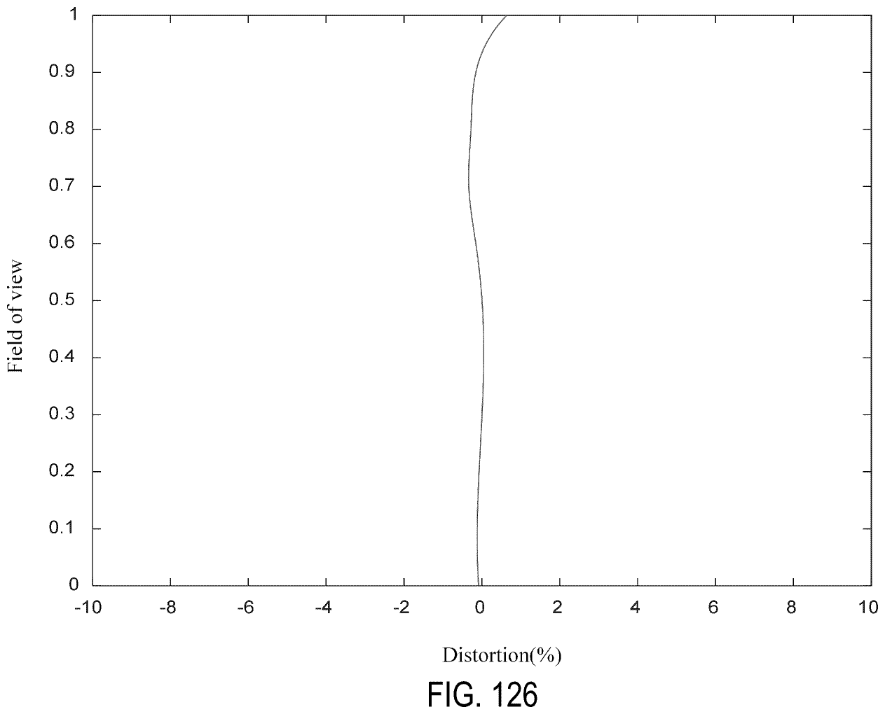

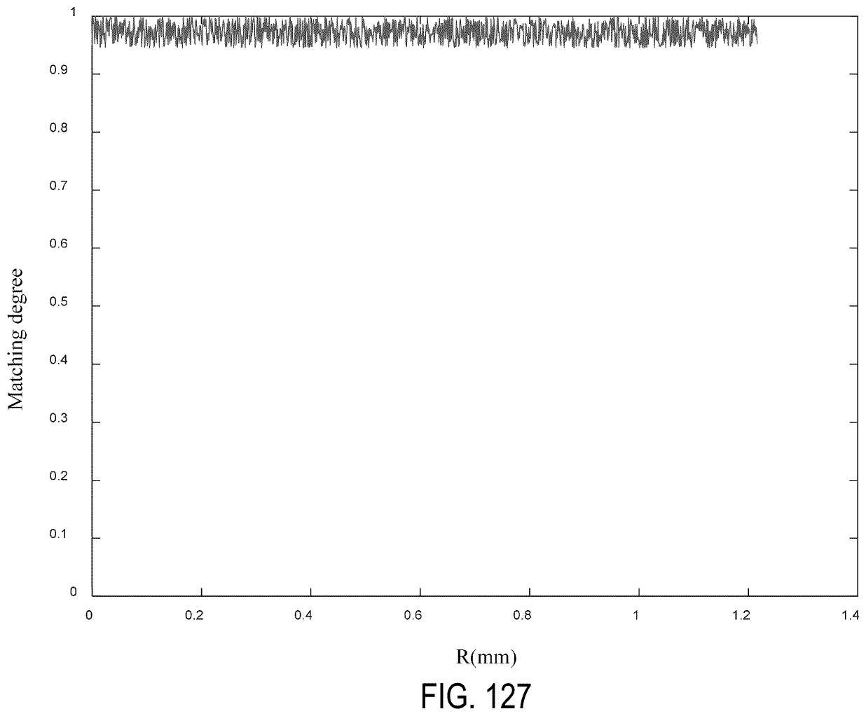

FIG. 124 shows a phase modulation diagram of the metalens in the optical system provided by embodiment 23 at the wavelengths of 486.13 nm, 587.56 nm, and 656.27 nm. It can be seen in FIG. 124 that the phases cover 0-2π of the metalens at different wavelengths. FIG. 125 shows an astigmatism diagram of the optical system. According to FIG. 125, the astigmatism of the optical system at the different fields of view from 0 to 1 is less than 0.5 mm. FIG. 126 shows a distortion diagram of the optical system. According to FIG. 126, the distortion of the optical system at the different fields of view from 0 to 1 is less than 5%. FIG. 127 shows the matching degree of the wide spectrum of the metalens in the optical system in embodiment 23. According to FIG. 127, the real phase of embodiment 23 and the theoretical phase is greater than 90%. The optical system in embodiment 23 has a high MTF and has good control of astigmatism and distortion, therefore the optical system has good imaging quality.

TABLE 23-1

| Parameter item | Parameter value |
|---|---|
| Working wavelength(WL) | VIS(400-700 nm) |
| Effective focal length(EFL) | 4.63 mm |
| Field of view(ω) | 74° |
| F number | 2.0 |
| Image height(ImgH) | 3.4896 mm |
| Total track length(TTL) | 5.7 mm |

TABLE 23-2

| Numbered | | Radius | Thickness | |
|---|---|---|---|---|
| surface | Surface type | (mm) | (mm) | Material |
| ST0 | Spherical surface | Infinite | −0.3562 | |
| L₁ₒ | Aspheric surface | 1.9608 | 0.619172 | 545000.559000 |
| L₁ᵢ | Aspheric surface | 292.096 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 27.48977 | 0.242622 | 636000.239000 |
| L₃ᵢ | Aspheric surface | 3.86791 | 0.479734 | |
| L₄ₒ | Aspheric surface | −494.974 | 0.289943 | 651000.215000 |
| L₄ᵢ | Aspheric surface | 23.94626 | 0.317591 | |
| L₅ₒ | Aspheric surface | −18.684 | 0.983527 | 544000.559000 |
| L₅ᵢ | Aspheric surface | −2.57836 | 0.466011 | |
| L₆ₒ | Aspheric surface | 4.31879 | 0.5544 | 651000.215000 |
| L₆ᵢ | Aspheric surface | 3.394367 | 0.897001 | |
| L₇ₒ | Aspheric surface | −2.02359 | 0.2 | 544000.559000 |
| L₇ᵢ | Aspheric surface | 157.5462 | 0.05 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 23-3-1

| Numbered | | | | | | |
|---|---|---|---|---|---|---|
| surface | L₁ₒ | L₁ᵢ | L₃ₒ | L₃ᵢ | L₄ₒ | L₄ᵢ |
| K | −0.05017 | −6.5E+11 | 456.17 | 5.228461 | −8.33E+17 | −301.17 |
| A | −0.00415 | −0.01331 | −0.02595 | −0.03499 | −0.153415 | −0.12756 |
| B | 0.025223 | 0.050719 | 0.096644 | 0.087368 | 0.0372547 | 0.024193 |
| C | −0.04148 | −0.06185 | −0.08963 | −0.08023 | −0.037463 | −0.00421 |
| D | 0.032151 | 0.039601 | 0.041878 | 0.040647 | 0.0169318 | 0.002849 |
| E | −0.00842 | −0.00982 | −0.00317 | −0.00668 | 0.0002696 | 0.000244 |
| F | −0.00174 | −0.00139 | −0.00303 | −0.00102 | −4.26E−03 | 0.000888 |
| G | 0.000657 | 0.000357 | 0.000125 | 0.000689 | 0.0036405 | 3.33E−05 |

TABLE 23-3-2

| Numbered | | | | | | |
|---|---|---|---|---|---|---|
| surface | L₅ₒ | L₅ᵢ | L₆ₒ | L₆ᵢ | L₇ₒ | L₇ᵢ |
| K | 34.44624 | 0.065072 | −1.22E+00 | −1.54624 | −0.72533 | −635883 |
| A | −0.01155 | −0.01175 | −5.99E−02 | −0.04653 | −0.00115 | −0.02796 |
| B | −0.0248 | 0.000827 | 0.002208 | 0.001087 | 0.003301 | 0.004771 |
| C | 0.022111 | 0.002149 | 0.000437 | 0.00086 | 0.000138 | −0.00039 |
| D | −0.00667 | −0.00078 | 7.12E−06 | −0.00013 | −2.57E−05 | 1.06E−05 |
| E | 0.000684 | 0.000127 | −3.17E−05 | −1.12E−06 | −7.39E−07 | −7.42E−07 |
| F | 4.25E−05 | −9.30E−06 | −7.86E−06 | −8.04E−07 | −5.41E−08 | 3.42E−07 |
| G | −8.72E−06 | −2.85E−06 | −1.58E−06 | 1.82E−07 | −2.34E−11 | −2.58E−08 |

### Embodiment 24

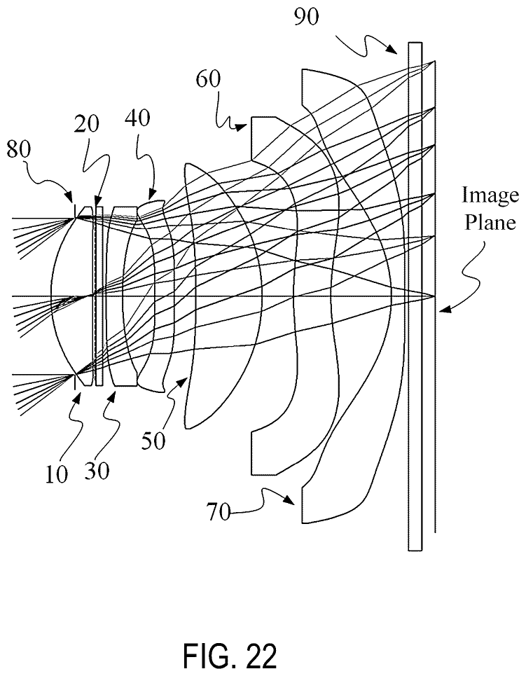

In one embodiment, embodiment 24 provides an optical system, and the optical system is shown in FIG. 22. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 24-1. The curvature, thickness, refractive index, and other parameter item of each lens in the optical system are shown in Table 24-2. The aspherical coefficients of each surface of each lens in the optical system are shown in Table 24-3-1 and Table 24-3-2, and the aspheric coefficients are shown in formula (9).

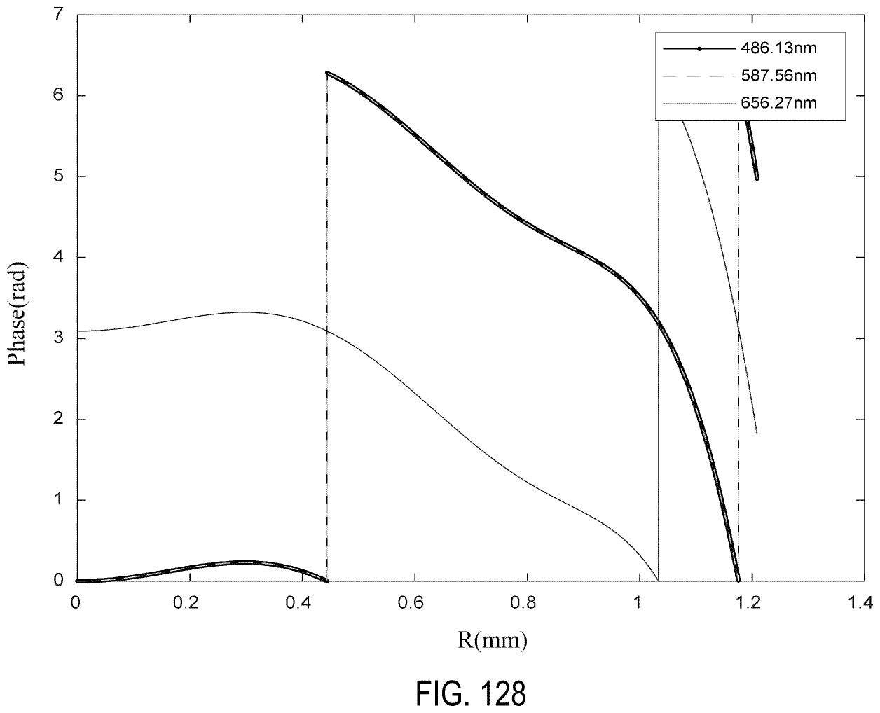

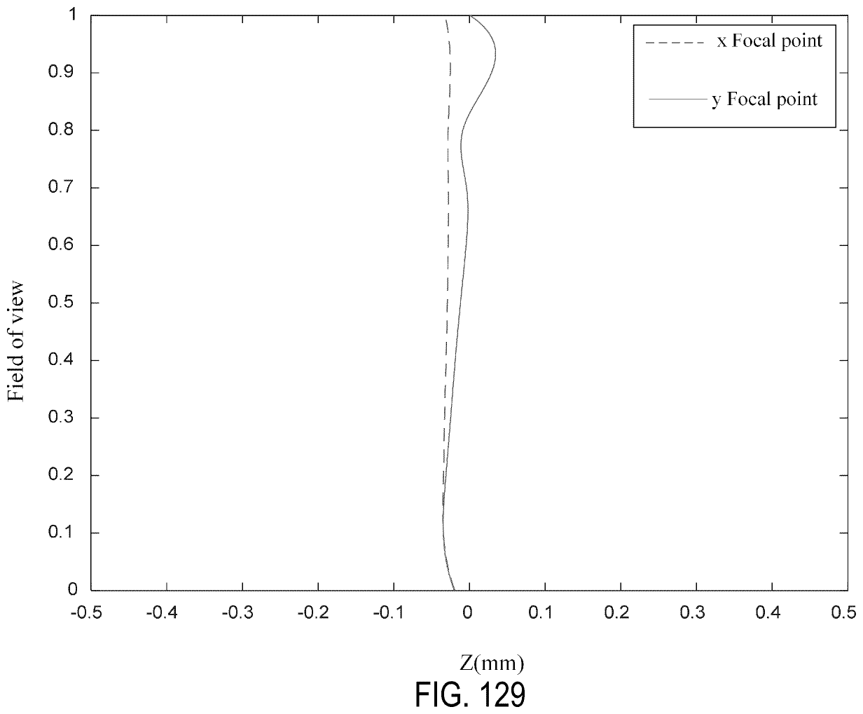

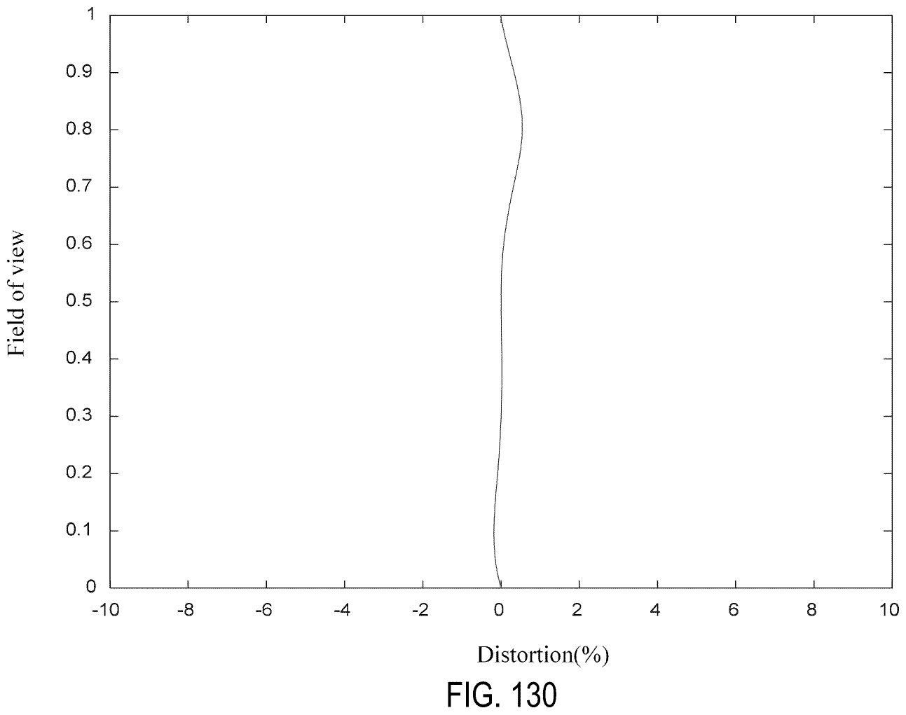

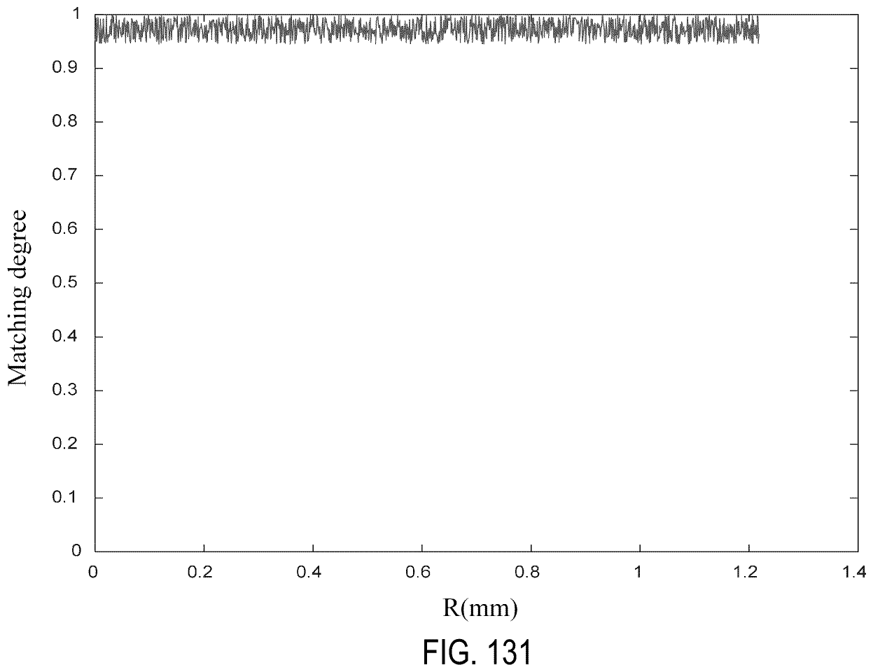

FIG. 128 shows a phase modulation diagram of the metalens in the optical system provided by embodiment 24 at the wavelengths of 486.13 nm, 587.56 nm, and 656.27 nm. It can be seen in FIG. 128 that the phases cover 0-2π of the metalens at different wavelengths. FIG. 129 shows an astigmatism diagram of the optical system. According to FIG. 129, the astigmatism of the optical system at the different fields of view from 0 to 1 is less than 0.5 mm. FIG. 130 shows a distortion diagram of the optical system. According to FIG. 130, the distortion of the optical system at the different fields of view from 0 to 1 is less than 5%. FIG. 131 shows the matching degree of the wide spectrum of the metalens in the optical system in embodiment 24. According to FIG. 131, the real phase of embodiment 24 and the theoretical phase is greater than 90%. The optical system in embodiment 24 has a high MTF and has good control of astigmatism and distortion, therefore the optical system has good imaging quality.

TABLE 24-1

| Parameter item | Parameter value |
|---|---|
| Working wavelength(WL) | VIS(400-700 nm) |
| Effective focal length(EFL) | 4.63 mm |
| Field of view(ω) | 74° |
| F number | 2.0 |
| Image height(ImgH) | 3.4896 mm |
| Total track length(TTL) | 5.7 mm |

TABLE 24-2

| Numbered | | Radius | Thickness | |
|---|---|---|---|---|
| surface | Surface type | (mm) | (mm) | Material |
| ST0 | Spherical surface | Infinite | −0.3562 | |
| L₁ₒ | Aspheric surface | 1.9393 | 0.618441 | 545000.559000 |
| L₁ᵢ | Aspheric surface | −93.868 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 17.80122 | 0.201511 | 636000.239000 |
| L₃ᵢ | Aspheric surface | 3.575219 | 0.516574 | |
| L₄ₒ | Aspheric surface | −2.10E+02 | 0.304824 | 651000.215000 |
| L₄ᵢ | Aspheric surface | 1.17E+01 | 0.142499 | |
| L₅ₒ | Aspheric surface | −3.05E+02 | 0.972538 | 544000.559000 |
| L₅ᵢ | Aspheric surface | −2.52E+00 | 0.31026 | |
| L₆ₒ | Aspheric surface | 181.3502 | 0.465735 | 651000.215000 |
| L₆ᵢ | Aspheric surface | 50.54948 | 1.153986 | |
| L₇ₒ | Aspheric surface | −2.3045 | 0.363634 | 544000.559000 |
| L₇ᵢ | Aspheric surface | 9.137641 | 0.05 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 24-3-1

| Numbered | | | | | | |
|---|---|---|---|---|---|---|
| surface | L₁ₒ | L₁ᵢ | L₃ₒ | L₃ᵢ | L₄ₒ | L₄ᵢ |
| K | −0.02167 | −378335 | 184.6623 | 3.768341 | −1E+12 | 27.37765 |
| A | −0.00619 | −0.01439 | −0.02657 | −0.02982 | −0.16079 | −0.134631 |
| B | 0.028574 | 0.053644 | 0.091541 | 0.080758 | 0.045331 | 0.016784 |
| C | −0.04432 | −0.06791 | −0.09039 | −0.0742 | −0.04596 | −0.007125 |
| D | 0.032252 | 0.039953 | 0.040957 | 0.035382 | 0.011269 | 0.0040701 |
| E | −0.00783 | −0.00921 | −0.00376 | −0.00634 | 0.003772 | 1.55E−04 |
| F | −0.0017 | −0.00111 | −0.00173 | 0.001719 | −0.00125 | 0.0007626 |
| G | 0.000258 | 6.90E−05 | 9.44E−05 | 0.000169 | 0.001665 | −3.66E−05 |

TABLE 24-3-2

| Numbered | | | | | | |
|---|---|---|---|---|---|---|
| surface | L₅ₒ | L₅ᵢ | L₆ₒ | L₆ᵢ | L₇ₒ | L₇ᵢ |
| K | −2650020 | 0.336709 | −89171.6 | −2.73E+03 | −0.08427 | 5.646904 |
| A | 0.013546 | 0.013534 | −0.05412 | −0.04038 | −0.00686 | −0.02453 |
| B | −0.0304 | 0.001535 | −0.00279 | −0.00275 | 0.007144 | 0.004313 |
| C | 0.022614 | 0.001435 | −0.00164 | 1.31E−03 | −0.00036 | −4.11E−04 |
| D | −0.00649 | −0.00105 | 8.28E−06 | −2.09E−04 | −8.85E−05 | 6.49E−06 |
| E | 0.000633 | 9.42E−05 | 2.92E−05 | −1.73E−05 | 1.41E−05 | −3.08E−08 |
| F | −1.09E−06 | −3.64E−07 | −3.05E−05 | 2.73E−06 | 2.57E−06 | 1.66E−07 |
| G | 6.38E−06 | −3.12E−07 | −1.89E−05 | 5.80E−08 | −5.10E−07 | −1.48E−08 |

### Embodiment 25

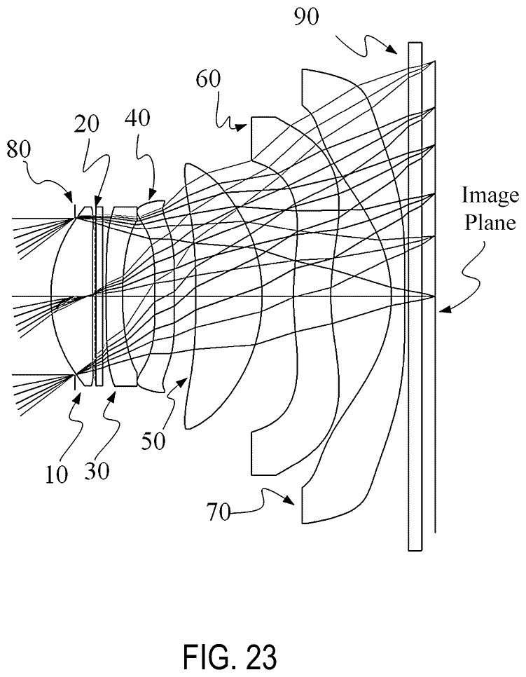

In one embodiment, embodiment 25 provides an optical system, and the optical system is shown in FIG. 23. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 25-1. The curvature, thickness, refractive index, and other parameter item of each lens in the optical system are shown in Table 25-2. The aspherical coefficients of each surface of each lens in the optical system are shown in Table 25-3-1 and Table 25-3-2, and the aspheric coefficients are shown in formula (9).

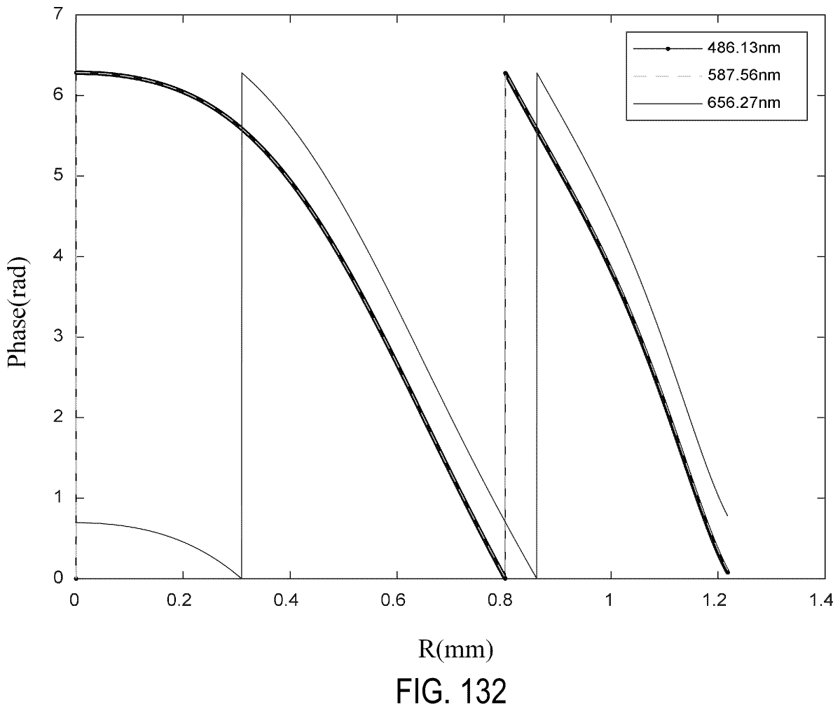

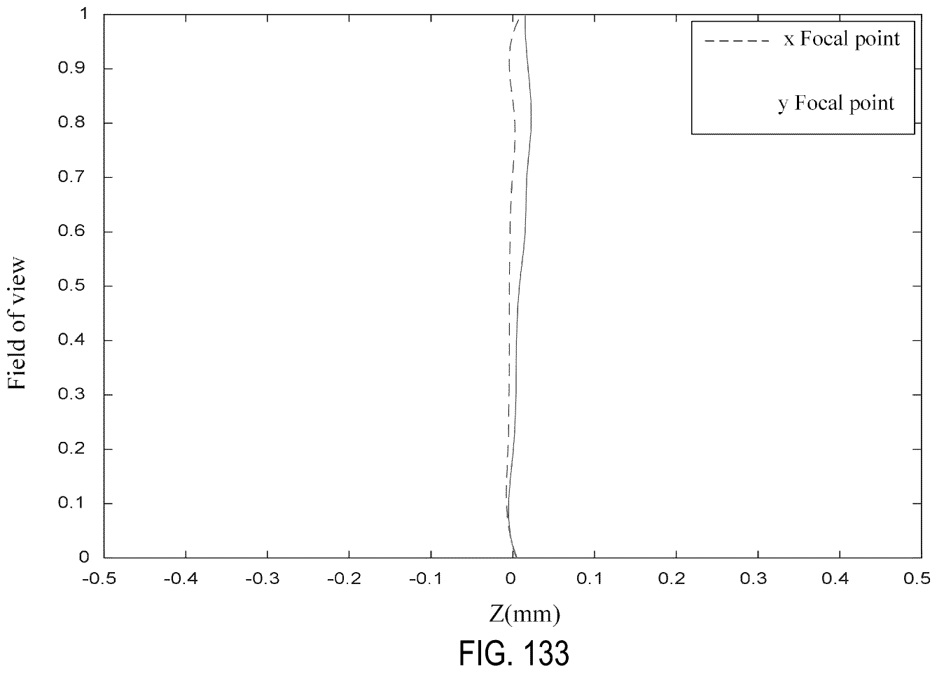

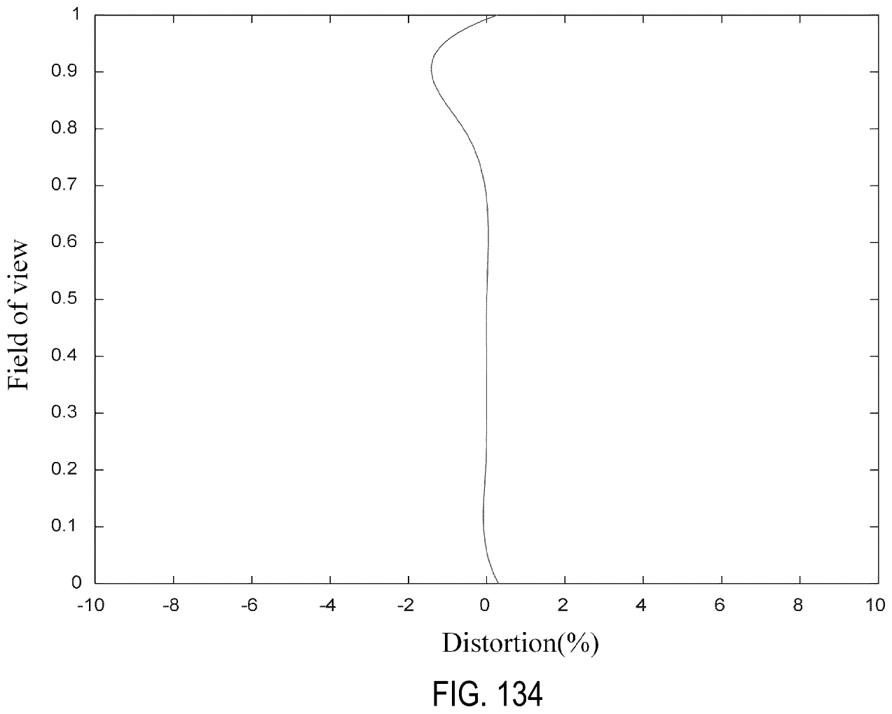

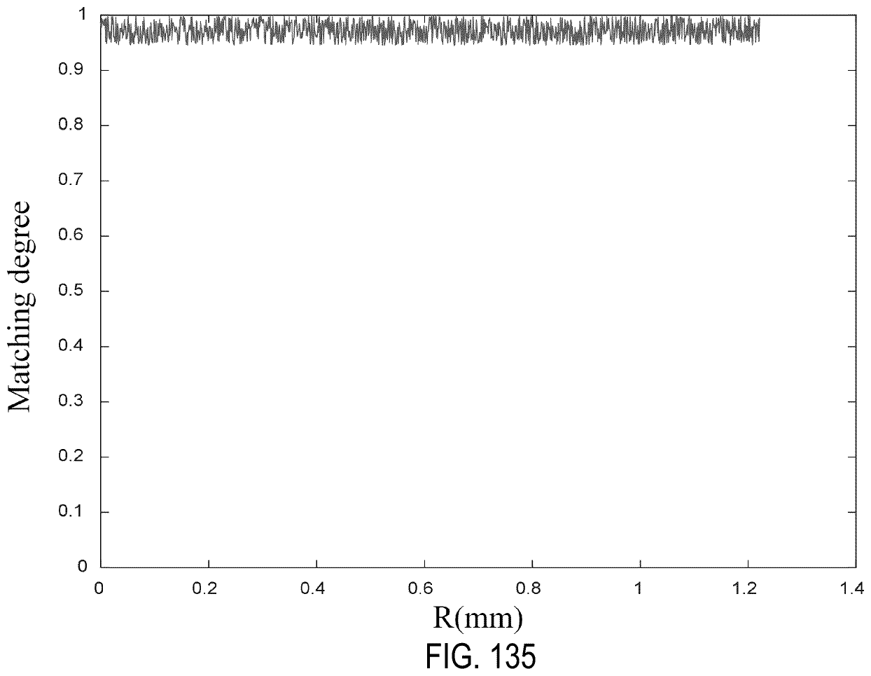

FIG. 132 shows a phase modulation diagram of the metalens in the optical system provided by embodiment 25 at the wavelengths of 486.13 nm, 587.56 nm, and 656.27 nm. It can be seen in FIG. 132 that the phases cover 0-2π of the metalens at different wavelengths. FIG. 133 shows an astigmatism diagram of the optical system. According to FIG. 133, the astigmatism of the optical system at the different fields of view from 0 to 1 is less than 0.5 mm. FIG. 134 shows a distortion diagram of the optical system. According to FIG. 134, the distortion of the optical system at the different fields of view from 0 to 1 is less than 5%. FIG. 135 shows the matching degree of the wide spectrum of the metalens in the optical system in embodiment 25. According to FIG. 135, the real phase of embodiment 25 and the theoretical phase is greater than 90%. The optical system in embodiment 25 has a high MTF and has good control of astigmatism and distortion, therefore the optical system has good imaging quality.

TABLE 25-1

| Parameter item | Parameter value |
|---|---|
| Working wavelength(WL) | VIS(400-700 nm) |
| Effective focal length(EFL) | 4.63 mm |
| Field of view(ω) | 74° |
| F number | 2.0 |
| Image height(ImgH) | 3.4896 mm |
| Total track length(TTL) | 5.7 mm |

TABLE 25-2

| Numbered | | Radius | Thickness | |
|---|---|---|---|---|
| surface | Surface type | (mm) | (mm) | Material |
| ST0 | Spherical surface | Infinite | −0.3562 | |
| L₁ₒ | Aspheric surface | 1.9374 | 0.641518 | 545000.559000 |
| L₁ᵢ | Aspheric surface | −3206.76 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 18.43677 | 0.287823 | 636000.239000 |
| L₃ᵢ | Aspheric surface | 3.626356 | 0.494009 | |
| L₄ₒ | Aspheric surface | −100.98 | 0.297439 | 651000.215000 |
| L₄ᵢ | Aspheric surface | 1.29E+01 | 0.149814 | |
| L₅ₒ | Aspheric surface | 138.9014 | 1.171634 | 544000.559000 |
| L₅ᵢ | Aspheric surface | −2.75367 | 0.238985 | |
| L₆ₒ | Aspheric surface | 6.32294 | 0.339172 | 651000.215000 |
| L₆ᵢ | Aspheric surface | 5.894012 | 1.180111 | |
| L₇ₒ | Aspheric surface | −2.7984 | 0.20002 | 544000.559000 |
| L₇ᵢ | Aspheric surface | 6.931936 | 0.099476 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 25-3-1

| Numbered | | | | | | |
|---|---|---|---|---|---|---|
| surface | L₁ₒ | L₁ᵢ | L₃ₒ | L₃ᵢ | L₄ₒ | L₄ᵢ |
| K | −0.0084 | −2.9E+12 | 206.2657 | 3.62631 | −1.03E+12 | 33.63033 |
| A | −0.00596 | −0.01271 | −0.03239 | −0.03139 | −0.158255 | −0.13472 |
| B | 0.028639 | 0.052507 | 0.091192 | 0.079681 | 0.0466435 | 0.019099 |
| C | −0.04384 | −0.06772 | −0.09121 | −0.07305 | −0.042418 | −0.00761 |
| D | 0.032138 | 0.040053 | 0.040558 | 0.035985 | 0.012565 | 0.003871 |
| E | −0.00777 | −0.0093 | −0.00395 | −0.0062 | 0.0028491 | 0.000231 |
| F | −0.00167 | −0.00126 | −0.00176 | 0.001728 | −1.78E−03 | 0.000796 |
| G | 0.000257 | 9.77E−05 | −5.02E−05 | 7.77E−05 | 0.0019324 | −1.41E−04 |

TABLE 25-3-2

| Numbered | | | | | | |
|---|---|---|---|---|---|---|
| surface | L₅ₒ | L₅ᵢ | L₆ₒ | L₆ᵢ | L₇ₒ | L₇ᵢ |
| K | −5.70E+15 | 0.08164 | −2.37E+01 | 0.709777 | −0.19647 | −20.5105 |
| A | 0.014738 | 0.017633 | −4.27E−02 | −0.04518 | 0.00196 | −0.01932 |
| B | −0.03049 | 0.003062 | −0.001075 | −0.00131 | 0.003164 | 0.004848 |
| C | 0.022692 | 0.001856 | −0.000467 | 0.001435 | 4.97E−05 | −0.00059 |
| D | −0.00646 | −0.00095 | 1.41E−04 | −0.00016 | −2.43E−05 | 1.50E−05 |
| E | 0.000633 | 1.08E−04 | 5.12E−05 | −1.18E−05 | 1.94E−06 | 1.01E−06 |
| F | 2.99E−06 | 8.10E−07 | −1.06E−05 | 2.44E−06 | −3.24E−07 | 1.67E−07 |
| G | 1.51E−06 | 3.83E−07 | −7.39E−06 | −3.51E−07 | 2.41E−08 | −1.57E−08 |

### Embodiment 26

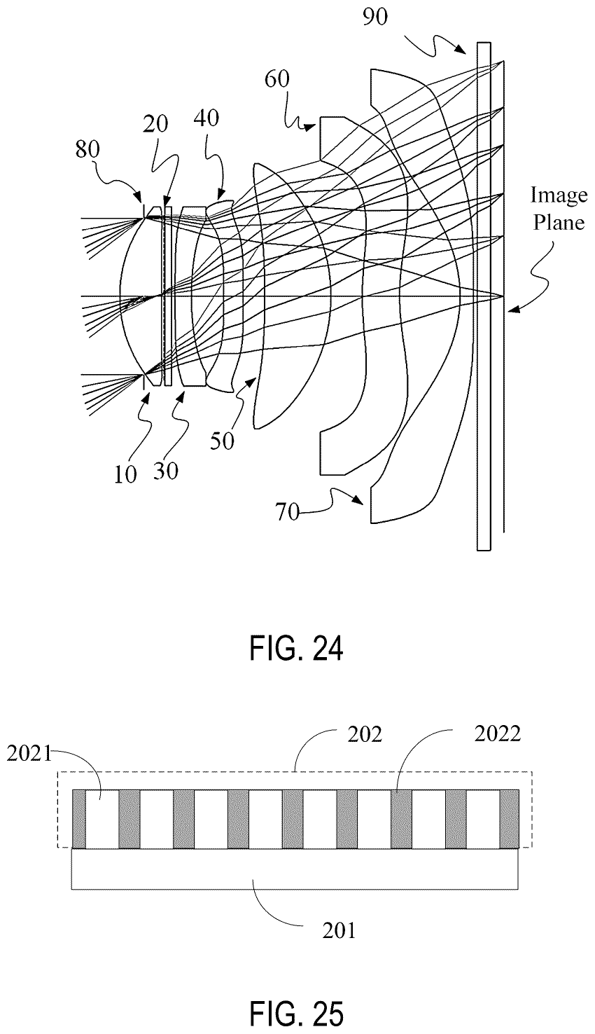

In one embodiment, embodiment 26 provides an optical system, and the optical system is shown in FIG. 24. The optical system in order from an object side to an image side, the seven optical elements include: an aperture slot 80, a first lens 10, a second lens 20, a third lens 30, a fourth lens 40, a fifth lens 50, a sixth lens 60, a seventh lens 70 and an infrared filter 90. The specific parameter item of the optical system are shown in Table 26-1. The curvature, thickness, refractive index, and other parameter item of each lens in the optical system are shown in Table 26-2. The aspherical coefficients of each surface of each lens in the optical system are shown in Table 26-3-1 and Table 26-3-2, and the aspheric coefficients are shown in formula (9).

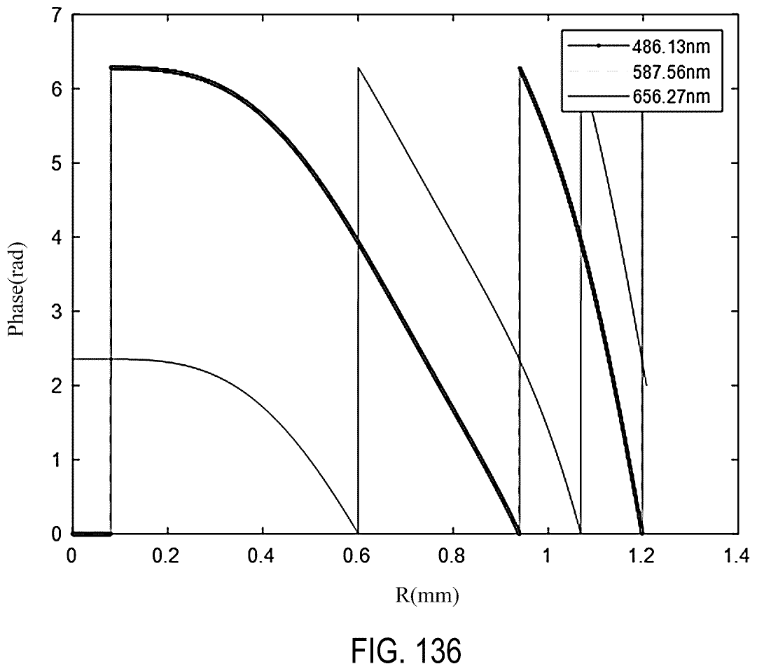

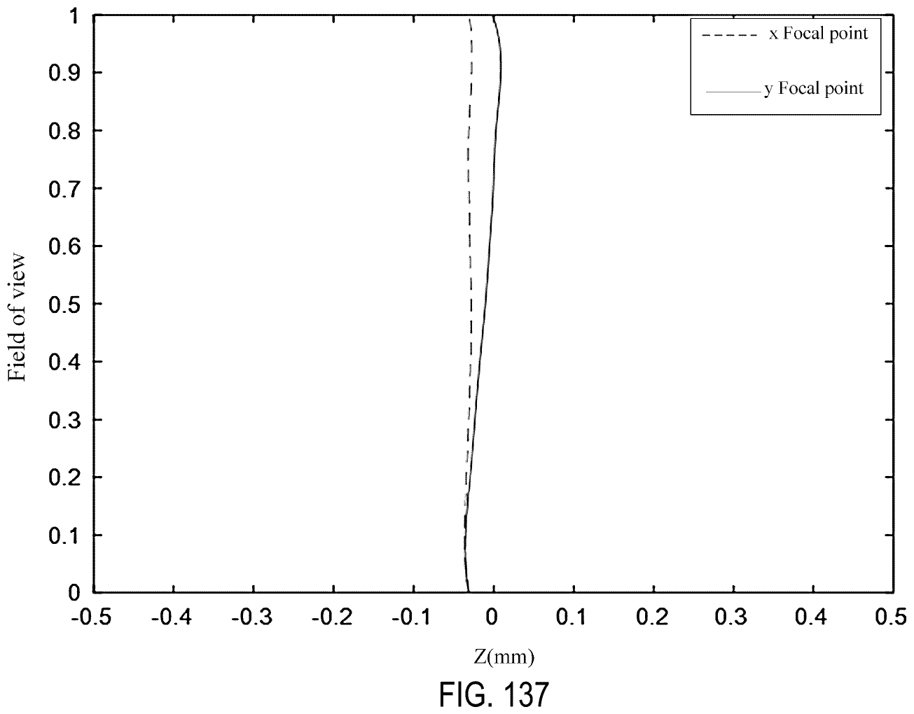

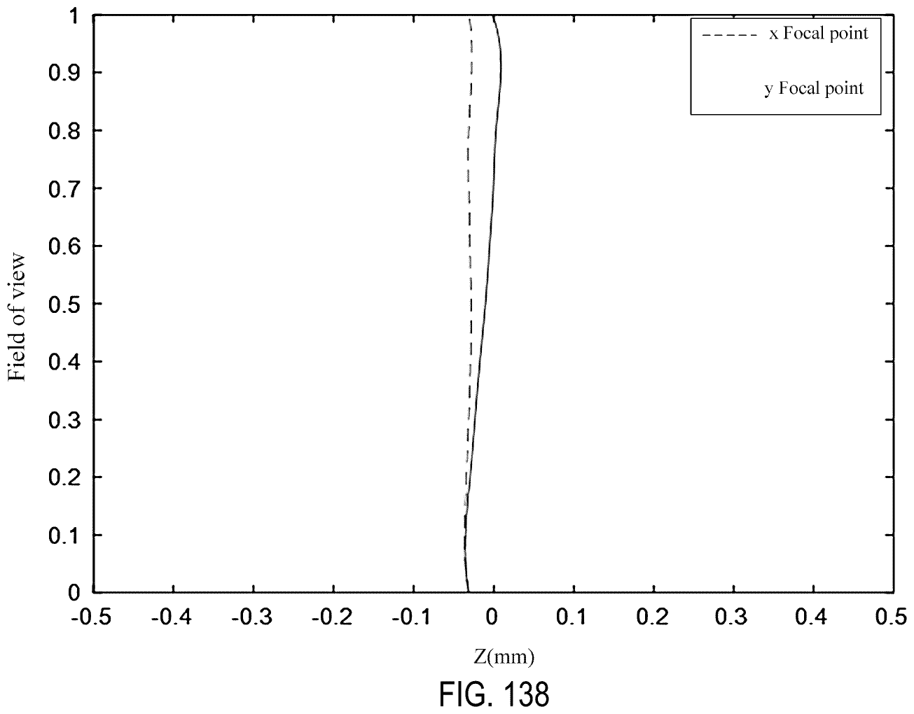

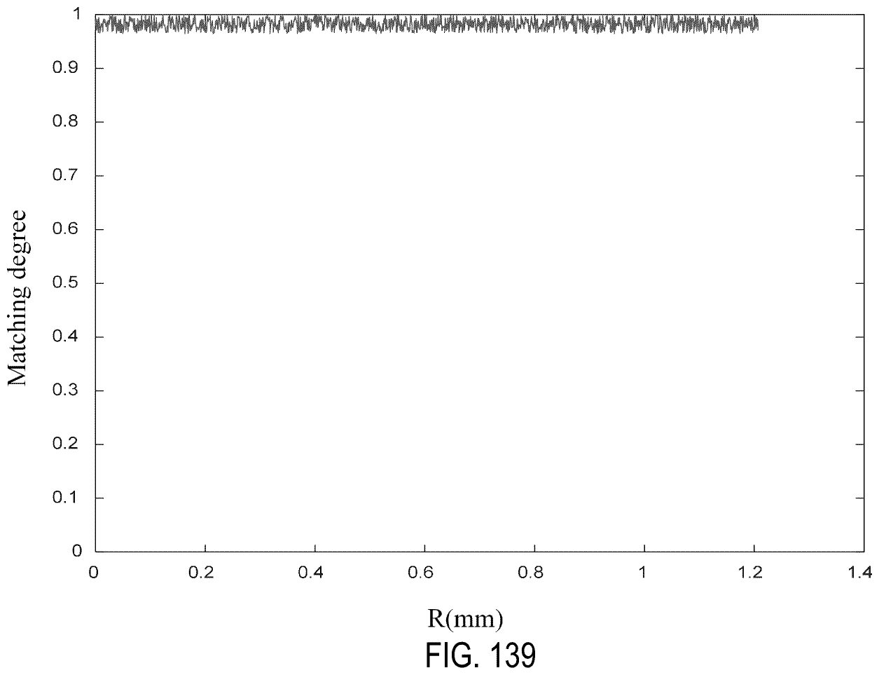

FIG. 136 shows a phase modulation diagram of the metalens in the optical system provided by embodiment 26 at the wavelengths of 486.13 nm, 587.56 nm, and 656.27 nm. It can be seen in FIG. 136 that the phases cover 0-2π of the metalens at different wavelengths. FIG. 137 shows an astigmatism diagram of the optical system. According to FIG. 137, the astigmatism of the optical system at the different fields of view from 0 to 1 is less than 0.5 mm. FIG. 138 shows a distortion diagram of the optical system. According to FIG. 138, the distortion of the optical system at the different fields of view from 0 to 1 is less than 5%. FIG. 139 shows the matching degree of the wide spectrum of the metalens in the optical system in embodiment 26. According to FIG. 139, the real phase of embodiment 26 and the theoretical phase is greater than 90%. The optical system in embodiment 26 has a high MTF and has good control of astigmatism and distortion, therefore the optical system has good imaging quality.

TABLE 26-1

| Parameter item | Parameter value |
|---|---|
| Working wavelength(WL) | VIS(400-700 nm) |
| Effective focal length(EFL) | 4.63 mm |
| Field of view(ω) | 74° |
| F number | 2.0 |
| Image height(ImgH) | 3.4896 mm |
| Total track length(TTL) | 5.7 mm |

TABLE 26-2

| Numbered | | Radius | Thickness | |
|---|---|---|---|---|
| surface | Surface type | (mm) | (mm) | Material |
| ST0 | Spherical surface | Infinite | −0.3562 | |
| L₁ₒ | Aspheric surface | 1.9412 | 0.613428 | 545000.559000 |
| L₁ᵢ | Aspheric surface | −93.806 | 0.05 | |
| L₂ₒ | Structural surface (metalens) | Infinite | 0.1 | 458000.676000 |
| L₂ᵢ | Spherical surface | Infinite | 0.05 | |
| L₃ₒ | Aspheric surface | 17.47699 | 0.2 | 636000.239000 |
| L₃ᵢ | Aspheric surface | 3.571593 | 0.517489 | |
| L₄ₒ | Aspheric surface | −1006.94 | 0.327337 | 651000.215000 |
| L₄ᵢ | Aspheric surface | 11.07857 | 0.178194 | |
| L₅ₒ | Aspheric surface | −56.2287 | 0.979203 | 544000.559000 |
| L₅ᵢ | Aspheric surface | −2.31911 | 0.194531 | |
| L₆ₒ | Aspheric surface | 3.079088 | 0.252154 | 651000.215000 |
| L₆ᵢ | Aspheric surface | 2.88771 | 1.081843 | |
| L₇ₒ | Aspheric surface | −2.00044 | 0.704956 | 544000.559000 |
| L₇ᵢ | Aspheric surface | 12.49799 | 0.050432 | |
| IR filterₒ | Spherical surface | Infinite | 0.2 | 516000.641000 |
| IR filterᵢ | Spherical surface | Infinite | 0.2 | |
| Image plane | Spherical surface | Infinite | 0 | |

TABLE 26-3-1

| Numbered | | | | | | |
|---|---|---|---|---|---|---|
| surface | L₁ₒ | L₁ᵢ | L₃ₒ | L₃ᵢ | L₄ₒ | L₄ᵢ |
| K | −0.02971 | −358443 | 177.2096 | 2.960624 | −1E+12 | 32.635378 |
| A | −0.00623 | −0.014 | −0.02535 | −0.02975 | −0.15891 | −0.131509 |
| B | 0.02798 | 0.05409 | 0.091851 | 0.081212 | 0.042419 | 0.0181955 |
| C | −0.04406 | −0.06768 | −0.09046 | −0.07486 | −0.04568 | −0.007316 |
| D | 0.032268 | 0.040017 | 0.041002 | 0.035195 | 0.012027 | 0.004041 |
| E | −0.00777 | −0.00922 | −0.0039 | −0.00638 | 0.003828 | 2.32E−04 |
| F | −0.00169 | −0.00117 | −1.68E−03 | 1.63E−03 | −1.35E−03 | 0.0007683 |
| G | 0.000251 | 5.62E−05 | 4.64E−05 | 6.41E−05 | 0.001662 | −6.35E−05 |

TABLE 26-3-2

| Numbered | | | | | | |
|---|---|---|---|---|---|---|
| surface | L₅ₒ | L₅ᵢ | L₆ₒ | L₆ᵢ | L₇ₒ | L₇ᵢ |
| K | −4777.4 | 0.268897 | −7.96082 | −6.59E+00 | −0.5779 | 3.204116 |
| A | 0.014755 | 0.0165 | −0.05631 | −0.057827 | −0.01455 | −0.03184 |
| B | −0.03113 | 0.002396 | −0.00653 | −0.004264 | 0.004743 | 4.79E−03 |
| C | 0.022502 | 0.001576 | −0.00028 | 1.35E−03 | −0.00033 | −3.69E−04 |
| D | −0.00648 | −0.00096 | 1.25E−04 | −1.51E−04 | 2.27E−07 | 8.52E−06 |
| E | 0.000641 | 1.13E−04 | −4.23E−05 | −1.35E−05 | 4.95E−05 | −9.92E−07 |
| F | −1.97E−06 | −2.75E−06 | −3.94E−05 | 1.09E−06 | 5.81E−06 | 1.35E−07 |
| G | 1.98E−06 | −3.67E−06 | −8.56E−06 | −5.41E−07 | −4.21E−06 | −1.16E−08 |

It should be noted that the metalens provided by the embodiment of the present application can be processed through a semiconductor process and has the advantages of light weight, thin thickness, simple structure and process, low cost and high consistency in mass production.

In conclusion, the optical system provided by the embodiment of the present application forms the seven-piece optical system by using at least one metalens and a plurality of aspheric refractive lenses, which satisfying that the F number is less than 2 and the total length of the system is less than 6 mm, and improves the miniaturization and lightweight of the optical system.

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. An optical system, the optical system comprising seven optical elements, wherein in order from an object side to an image side, the seven optical elements comprise: a first lens, a second lens, a third lens, a fourth lens, a fifth lens, a sixth lens and a seventh lens;
each of seven optical elements comprises an object-side surface facing towards the object plane and an image-side surface facing towards the image plane;
at least one optical element of the seven optical elements is a metalens, and other optical element are aspheric optical lenses;
from the image side to the object side, there is at least one aspheric surface in the first aspheric optical lens and the second aspheric optical lens, and the aspheric surface has one point of inflection;
each of seven optical elements comprises an object-side surface facing towards the object side and an image-side surface facing towards the image side;
the optical system satisfies the formulas as follows:
$$\frac{f}{E P D} \leq 2. ;$$
$$0.05 mm \leq {d}_{M L} \leq 2 mm ;$$
$$\vert {f}_{M L} \vert / f \geq 45 ;$$
Wherein, f is a focal length of the optical system; EPD is an entrance pupil diameter of the optical system; d_{ML} is a thickness of the metalens; f_{ML} is a focal length of the metalens.

2. The optical system according to claim 1, wherein the second lens is the metalens, and the other optical elements are aspheric optical lenses; and the first lens has a positive focal power;
the object-side surface of the first lens is a convex surface; the object-side of the third lens comprises a positive curvature radius; the fifth lens has a positive focal power the sixth lens comprises a positive curvature radius.

3. The optical system according to claim 1, wherein the first lens satisfies the following condition:
$$0.4 \leq \frac{{R}_{1 o}}{{f}_{1}} \leq 0.54$$
wherein R₁ₒ is a curvature radius of the object-side surface of the first lens; f₁ is a focal length of the first lens of a central wavelength at a working waveband.

4. The optical system according to claim 1, wherein the optical system satisfies the following condition:
$$( {V}_{1} + {V}_{4} ) / 2 - {V}_{3} > 20$$
wherein, V₁ is an Abbe number of the first lens; V₃ is an Abbe number of the third lens; V₄ is an Abbe number of the fourth lens.

5. The optical system according to claim 1, wherein the optical system satisfies the following condition:
$$1.5 < TTL / ImgH < 1.8$$
wherein TTL is total track length of the optical system; ImgH is a maximum imaging height of the optical system.

6. The optical system according to claim 1, wherein the optical system satisfies the following condition:
$$\vert {R}_{4 o} \vert > {R}_{4 i} ;$$
wherein R₄ₒ is a curvature radius of the object-side surface of the fourth lens; R₄ᵢ is a curvature radius of the image-side surface of the fourth lens.

7. The optical system according to claim 1, wherein a curvature radius of the image-side surface of the seventh lens is greater than 0.

8. The optical system according to claim 1, wherein the first lens satisfies the following condition:
$$0.71 \leq {f}_{1} / f \leq 0 \text{.98} ;$$
wherein f₁ is a focal length of the first lens of a central wavelength at a working waveband, f is a focal length of the optical system.

9. The optical system according to claim 1, wherein the metalens comprises a substrate and a nanostructured layer; and the nanostructured layer is set on at least one side of the substrate;
and the number of the nanostructured layer is greater than or equal to 1;
each layer of the nanostructured layers comprises a plurality of nanostructures, and the plurality of nanostructures are arranged in a period;
the plurality of nanostructures in any two adjacent nanostructured layers are coaxial.

10. The optical system according to claim 9, wherein the period of the nanostructures in any nanostructured layers is greater than or equal to 0.3λ_{c}, and is less than or equal to 2λ_{c};
wherein, λ_{c} is a central wavelength of the second lens at the working waveband.

11. The optical system according to claim 9, wherein a height of the nanostructures in any nanostructured layer is greater than or equal to 0.3λ_{c}, and is less than or equal to 5λ_{c};
wherein, λ_{c} is a central wavelength of the second lens at the working waveband.

12. The optical system according to claim 9, wherein the plurality of nanostructures are polarization-independent structures.

13. The optical system according to claim 12, wherein the polarization-independent structures comprise cylinder structures, hollow structures, cylindrical structures, round-hole structures, hollow-round-hole structures, square column structures, square hole structures, hollow square column structures and hollow square hole structures.

14. The optical system according to claim 1, wherein the second lens further comprises an antireflection film;
the antireflection film is set on at least one side of the substrate.

15. The optical system according to claim 1, wherein a wide spectrum phase of a unit cell in the nanostructured layer satisfies:
$$- \frac{69 rad}{μm} \leq \frac{d φ ( r = {r}_{0} , λ )}{d λ} \leq - 5 rad / μm ;$$
wherein, r is a radial coordinates of the metalens; r₀ is a distance between any position on the metalens and the center of the metalens; λ is a working wavelength of the metalens.

16. The optical system according to claim 9, wherein the metalens comprises at least two nanostructured layers; the nanostructures in any adjacent nanostructured layer are non-coaxial along the direction parallel with the substrate.

17. A manufacturing method for a metalens, wherein the method is used to manufacture the metalens of the optical system claimed as claim 2, and the manufacturing method comprises:
S1. setting a structural material layer on the substrate;
S2. coating photo-resist on the structural material layer, and exposuring the structural material layer and obtaining a reference structure;
S3. according to the reference structure, etching the structural material layer into the nanostructures arranged in period, so as to form the nanostructured layer;
S4. filling a filler material between the nanostructures;
S5. polishing a surface of the filler material, so as to make the surface of the filler material align with the surface of the nanostructures.

18. The manufacturing method for a metalens according to claim 17, wherein the manufacturing method further comprises:
S6. repeating S1 to S5, until completing all the nanostructured layers.

19. An imaging device, wherein the imaging device comprises the optical system claimed as claim 1 and an image sensor; the image sensor is set on the image plane of the optical system.

20. An electronic device, wherein the electronic device comprise the imaging device claimed as claim 19.
